(19) United States
(12) Patent Application Publication
(10) Pub. No.: US 2018/0027301 A1
(43) Pub. Date: Jan. 25, 2018

(54) METHODS FOR MEDIA PLAYBACK STATE INFORMATION EXCHANGE

(71) Applicant: Sharp Kabushiki Kaisha, Sakai City, Osaka (JP)

(72) Inventor: SACHIN G. DESHPANDE, Camas, WA (US)

(21) Appl. No.: 15/554,290

(22) PCT Filed: Apr. 20, 2016
(86) PCT No.: PCT/JP2016/002119

§ 371 Date: Aug. 29, 2017

Related U.S. Application Data
(60) Provisional application No. 62/150,706, filed on Apr. 21, 2015.

(51) Int. Cl. H04N 21/6587; H04N 21/643; H04N 21/41; H04N 21/6405; H04N 21/81; H04N 21/433

(52) U.S. Cl. CPC H04N 21/6587; H04N 21/8186; H04N 21/4333; H04N 21/4126; H04N 21/6405; H04N 21/64322; H04N 21/814

(57) ABSTRACT

A primary device that provides information, the primary device comprising: (a) said primary device configured to provide said information including at least one of: (i) a media playback state for a media identification associated with a media playback state information subscription including at least one of: (1) playing; (2) paused; (3) stopped; relative to normal speed including at least one of: (1) a positive speed value indicating forward playback, wherein said forward playback means a media timeline position increases as wall-clock time increases; and (2) a negative speed value indicating backward playback, wherein said backward playback means a media timeline position decreases as wall-clock time decreases.

### TECHNICAL FIELD

The present disclosure relates generally to companion devices also known as second screen devices and services.

### BACKGROUND ART

A video service is capable of sending audiovisual content to a receiving device. The receiving audiovisual device typically presents the content to the viewer, such as on a television device. In some cases, the viewer would like to use their mobile device, such as a mobile phone, to interact with the video content. However, how to most effectively interact with the audiovisual content on the receiving device using the mobile phone tends to be problematic due to synchronization issues. In one case the viewer may want to receive audiovisual content on a receiver such as a television device. At the same time the user may want to receive adjunct associated content on a second screen, e.g. a mobile device such as a smartphone or a tablet. The content received on the second screen device may be same as alternate content associated with the audiovisual content being received on the television. The user may typically like these two contents be presented on the primary and second screen device in a synchronized manner.

### SUMMARY OF INVENTION

### Technical Problem

The foregoing and other objectives, features, and advantages of the invention will be more readily understood upon consideration of the following detailed description of the invention, taken in conjunction with the accompanying drawings.

### Solution to Problem

According to the present invention, there is provided a primary device that provides information, the primary device comprising: (a) said primary device configured to provide said information including at least one of: (i) a media playback state for a media identification associated with a media playback state information subscription including at least one of: (1) playing; (2) paused; (3) stopped; (4) buffering; (5) unknown; and (ii) a media playback speed relative to normal speed including at least one of: (1) a positive speed value indicating forward playback, wherein said forward playback means a media timeline position increases as wall-clock time increases; and (2) a negative speed value indicating backward playback, wherein said backward playback means a media timeline position decreases as wall-clock time decreases.

According to the present invention, there is provided a companion device that receives information, the primary device comprising: (a) said companion device configured to receive said information including at least one of: (i) a media playback state for a media identification associated with a media playback state information subscription including at least one of: (1) playing; (2) paused; (3) stopped; (4) buffering; (5) unknown; and (ii) a media playback speed relative to normal speed including at least one of: (1) a positive speed value indicating forward playback, wherein said forward playback means a media timeline position increases as wall-clock time increases; and (2) a negative speed value indicating backward playback, wherein said backward playback means a media timeline position decreases as wall-clock time decreases.

According to the present invention, there is provided a method for a primary device to provide information, the method comprising:(a) providing said information including at least one of: (i) a media playback state for a media identification associated with a media playback state information subscription including at least one of: (1) playing; (2) paused; (3) stopped; (4) buffering; (5) unknown; and (ii) a media playback speed relative to normal speed including at least one of: (1) a positive speed value indicating forward playback, wherein said forward playback means a media timeline position increases as wall-clock time increases; and (2) a negative speed value indicating backward playback, wherein said backward playback means a media timeline position decreases as wall-clock time decreases.

### BRIEF DESCRIPTION OF DRAWINGS

FIG. 1 illustrates a video system.

FIG. 2 illustrates a primary device and a companion device system.

FIG. 3 illustrates another primary device and a companion device system.

FIG. 4 illustrates another primary device and a companion device system.

FIG. 5 illustrates another primary device and a companion device system.

FIG. 6 illustrates another primary device and a companion device system.

FIG. 7 illustrates another primary device and a companion device system.

FIG. 8 illustrates another primary device and a companion device system.

FIG. 9 illustrates an emergency alert system.

FIG. 10 illustrates another primary device and a companion device system.

FIG. 10A illustrates another primary device and a companion device system.

FIG. 11 illustrates another primary device and a companion device system.

FIG. 12 illustrates another primary device and a companion device system.

FIG. 12A illustrates another primary device and a companion device system.

FIG. 12B illustrates another primary device and a companion device system.

FIG. 12C illustrates a non-linear timeline change based event notification.

FIG. 12D illustrates another non-linear timeline change based event notification.

FIG. 12E illustrates a media playback state changed based event notification.

FIG. 12F illustrates another media playback state change based event notification.

FIG. 13 illustrates another primary device and a companion device system.

FIG. 14 illustrates another primary device and a companion device system.

FIG. 15 illustrates a primary device and a companion device, each with an application.

FIG. 16 illustrates primary device and companion device messages.

FIG. 17 illustrates another primary device and companion devices.

FIG. 18 illustrates another primary device and a companion device.

FIG. 19 illustrates a subscribe to media playback state information.

FIG. 20 illustrates a response to subscription.

FIG. 21 illustrates a renew subscription.

FIG. 22 illustrates a cancel media playback state information subscription.

FIG. 23 illustrates a response to subscription.

FIG. 24 illustrates providing a media playback state information message and media streams.

FIG. 24A illustrates providing a media playback state information message and media streams.

FIG. 24B illustrates providing a media playback state information message and media streams.

FIG. 25, illustrates a response to media playback state information messages.

FIG. 25A illustrates a set of playback state transitions when media playback state notification message is sent from PD to CD.

FIG. 25B illustrates a set of playback state transitions when media playback state notification message is sent from PD to CD.

FIG. 25C illustrates a set of playback state transitions when media playback state notification message is sent from PD to CD.

FIG. 26 illustrates a UPnP architecture for media playback state information messages.

FIG. 27 illustrates a Representational State Transfer (REST) architecture for message exchanges.

FIG. 28 illustrates a Representational State Transfer (REST) architecture for media playback state information messages.

FIG. 29 illustrates Elements of the media playback state information message.

FIG. 30 illustrates Elements of the media playback state information message.

FIG. 31 illustrates Description of media playback state information.

FIG. 32 illustrates a playback state information notification message communication.

FIG. 33 illustrates a playback state information notification message communication.

FIG. 34 illustrates a request response based playback state information notification message communication.

### DESCRIPTION OF EMBODIMENTS

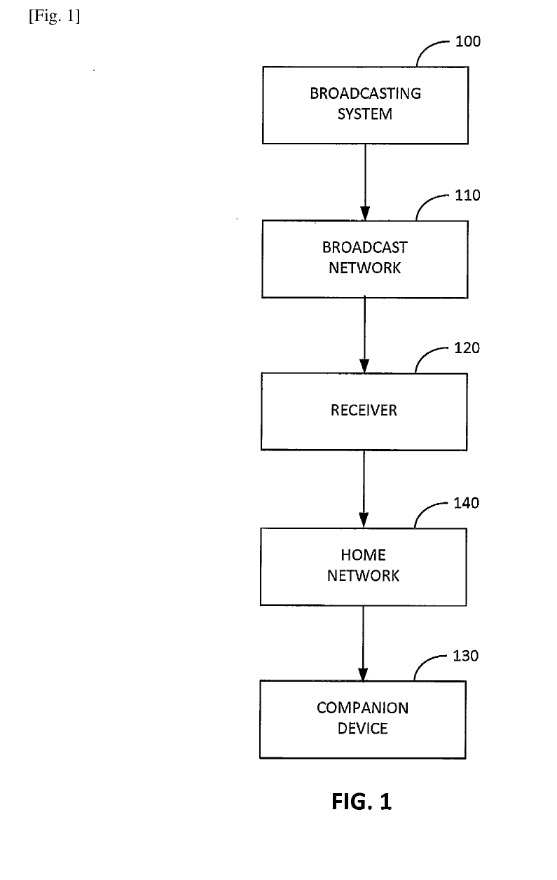

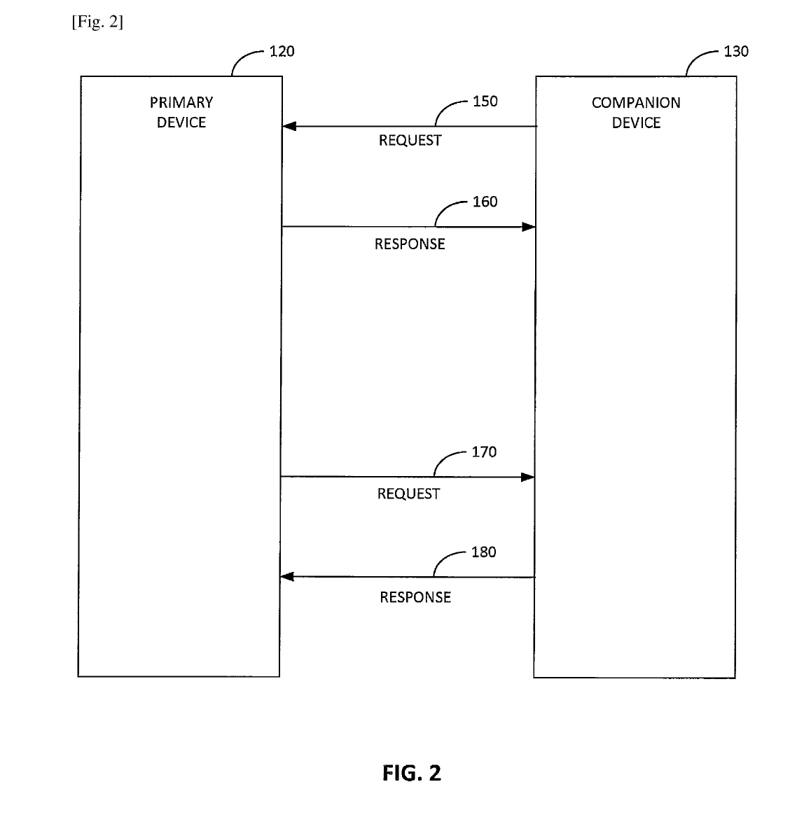

Referring to FIG. 1, a logical architecture of an audiovisual system is illustrated. The system includes a broadcasting system 100 that provides a source of audiovisual (video and/or audio and/or closed caption) content. The audiovisual content may be provided in any suitable manner and using suitable standards, such as for example, MPEG-2, MPEG-4 or ATSC. By way of example, the broadcasting system may be provided from a broadcasting antenna, a cable, a network based audiovisual source, a compact disk, a hard drive, a digital video disc, and/or an Internet based audiovisual source. The broadcasting system 100 may provide the content through any suitable broadcast network 110. A receiver 120 receives the audiovisual content together with any other data provided with the audiovisual content, such as digital data, data services, or otherwise. The receiver 120, generally referred to as a primary device, is preferably configured to receive the type of content being provided there to. The receiver may be, for example, a television, a laptop, a tablet, a phone, or any other device suitable to present the audiovisual content to a viewer. The receiver may be typically in a user's home. The receiver may likewise communicate with another display device 130, generally referred to as a companion device, through a home network 140. In another embodiment the companion device may communicate directly with an outside server to receive audiovisual and/or adjunct content. The home network is preferably a wireless or wired type network, such as for example, WiFi, Ethernet, 3GPP, Bluetooth, infra-red, HTTP. In some cases the home network may be a local area network. In some cases the primary and companion devices may be inside a user's home. In other cases, the home network may be an office environment. The companion device may include, for example, a mobile phone, a mobile tablet, a laptop, a computer, or other display device. In addition, the receiver may simultaneously communicate with a plurality of companion devices 130. Additionally one companion device may communicate simultaneously with multiple primary devices 120. In some embodiments the primary device may be called a first screen device. In some embodiments the companion device may be called a second screen device. The terms primary device and first screen device and receiver may be used interchangeably. The terms second companion device and second screen device may be used interchangeably. Referring to FIG. 2, it is often desirable that the primary device 120 is capable of providing information to the companion device 130. The term primary device and PD may be used interchangeably. The term companion device and CD may be used interchangeably. Companion device may also be called second screen or second screen device or similar such name. In addition, the companion device 130 may provide information to the primary device 120. Often, the companion device 130 makes a request 150 to the primary device 120, which in response thereto provides a response 160 to the companion device 130. In other cases, the primary device 120 makes a request 170 to the companion device 130, which in response thereto provides a response 180 to the primary device 120. This permits the primary device 120 to display content thereon, and the companion device 130 may likewise interact with the primary device 120. For example, it may be desirable that whatever is being presented on the primary device 120 is simultaneously being presented on the companion device 130, which may include for example, audio and/or video content. For example, it may be desirable to present a primary view of the video content on the primary device 120 and simultaneously present an alternative view of the same or similar scene of the video content on the companion device 130. For example, it may be desirable to present audiovisual content on the primary device 120 and simultaneously interact with an associated application that is started (or automatically started) on the companion device 130. In this case typically the content being presented on the primary device and the companion device should be synchronized. The synchronization refers to displaying the data corresponding to the same or approximately same time instance on the primary and the companion device.

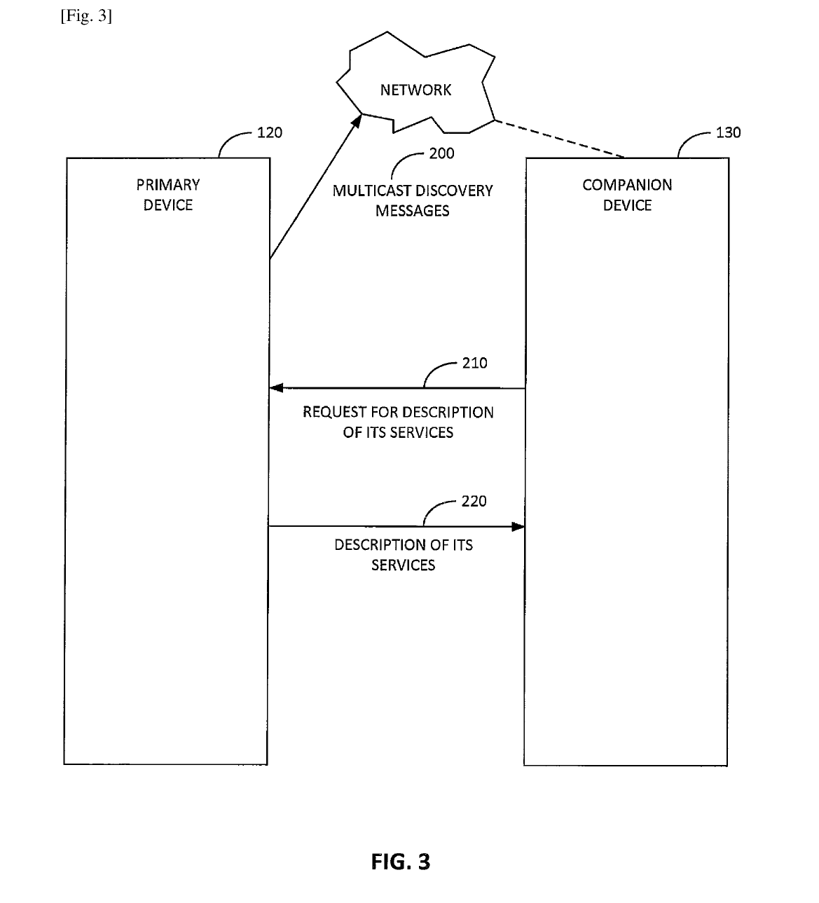

Referring to FIG. 3, by way of example, the user may have an ATSC compliant companion device 130 with an ATSC compliant application running thereon when an ATSC primary device 120 (e.g., a television) joins the network. This may occur, for example, when the receiver is turned on or its network interface is enabled. The ATSC primary device 120 may be capable of providing services for the companion device 130. The ATSC primary device 120 may multicast its discovery messages 200 to advertise its ATSC second screen support services. The ATSC compliant companion device 130 receives the multicast discovery messages and sends the ATSC primary device 120 a request for descriptions of its services 210. The ATSC primary device 120 responds to this request with a description of its services 220. The ATSC compliant companion device 130 uses the information provided in the descriptions to access the appropriate services and provide an interactive experience synchronized with the programming on the primary device 120.

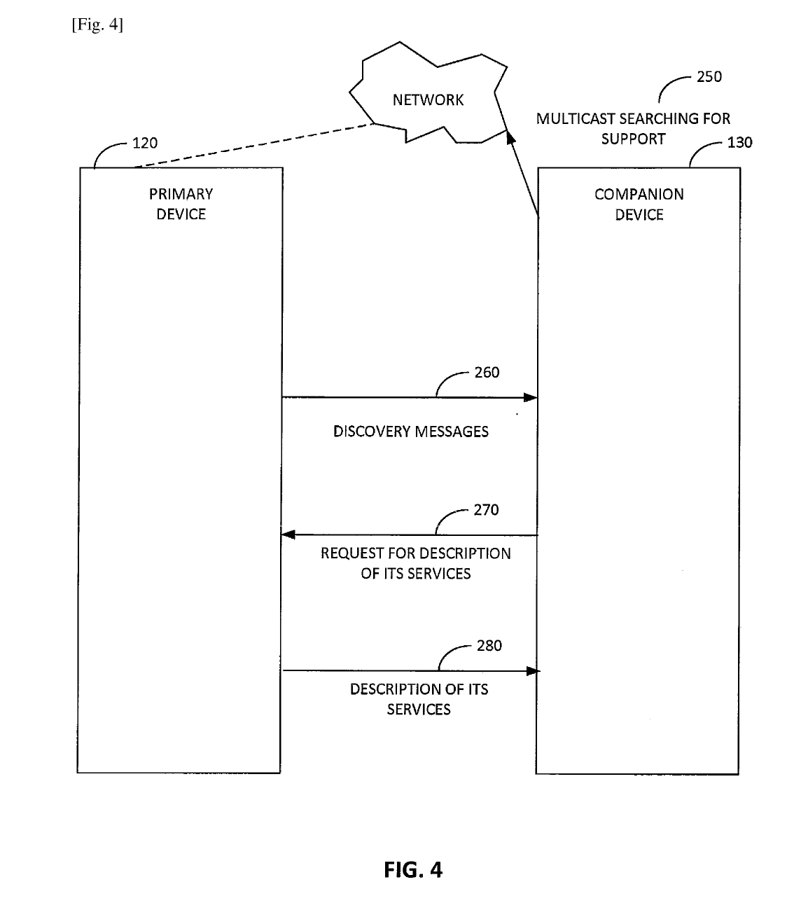

Referring to FIG. 4, by way of example, the user may not have an ATSC compliant companion device 130 with an ATSC compliant application running thereon when the ATSC primary device 120 (e.g., television) joins the network. The audiovisual content being viewed on the ATSC compliant primary device 120 may enter a program segment that offers companion device 130 support. This may occur, for example, when the receiver is turned on or its network interface is enabled, or when a channel change goes from a channel that does not offer the companion device 130 with another that does offer support for the companion device 130, or when the channel being viewed goes from a program segment that does not offer support for the companion device 130 to a segment that does offer support for the companion device 130. This viewing change causes the ATSC primary device 120 to inform the viewer in some manner that companion device 130 support is available. For example, a small icon may be presented in the corner of the primary device 120. If the viewer decides to take advantage of the second screen support and activate an ATSC compliant application on the companion device 130, then the companion device 130 may multicast a message 250 searching for devices that offer ATSC companion device 130 support or service. The ATSC primary device 120 may respond to this message with its discovery messages 260. When the companion device 130 receives the discovery messages, it sends the ATSC primary device 120 receiver a request for descriptions of its services 270. The ATSC primary device 120 responds with description of its services 280. The companion device 130 uses the information given in the descriptions to access the appropriate services and provide an interactive experience synchronized with the audiovisual content.

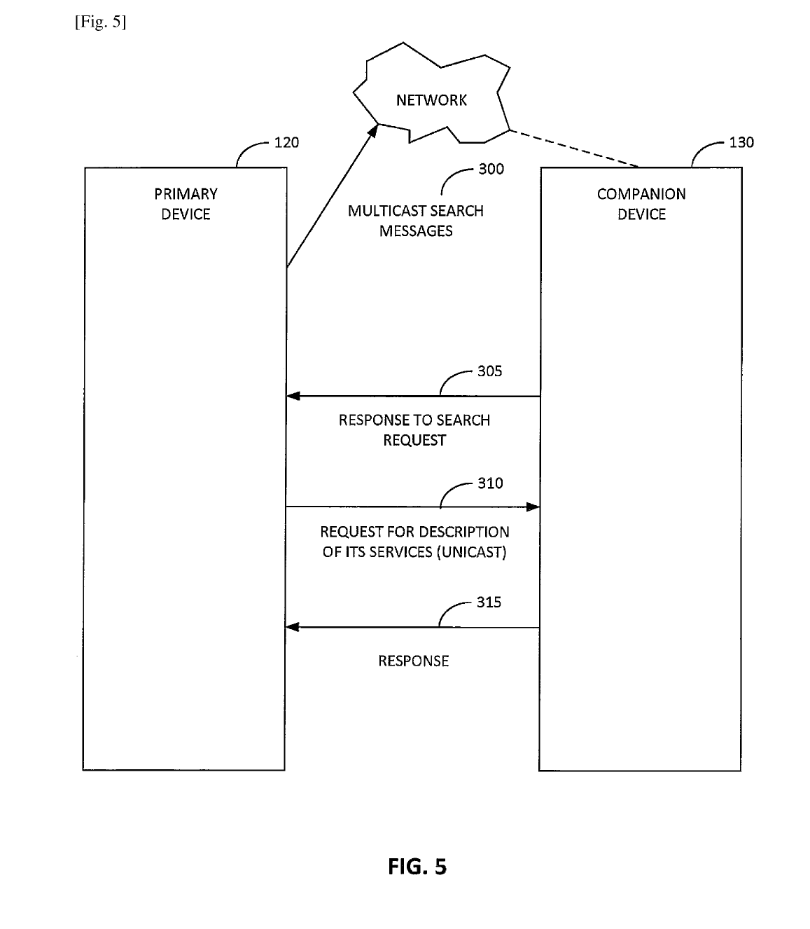

Referring to FIG. 5, by way of example, the viewer has an ATSC compliant companion device application running when the ATSC primary device joins the network (e.g., when the primary device is turned on or the network interface is enabled). The primary device 120 desires to discover one or more companion devices 130 on the network. The primary device 120 joins the network and multicasts it search messages 300 seeking companion devices 130. The companion device 130 running an ATSC application receives the multicast search message and in response sends the primary device 120 a response indicating its presence 305. On receiving this response the primary device 120 may send a request 310 for the description of services that companion device offers to primary device. The message 310 may be sent via a unicast technique, rather than a multicast technique. On receiving the message 310 the companion device responds with a description of its services by sending a message 315 to the primary device. The primary device 120 receives the message 315 and uses the information given in the service descriptions to access the appropriate services and to understand the capabilities of the companion device 130.

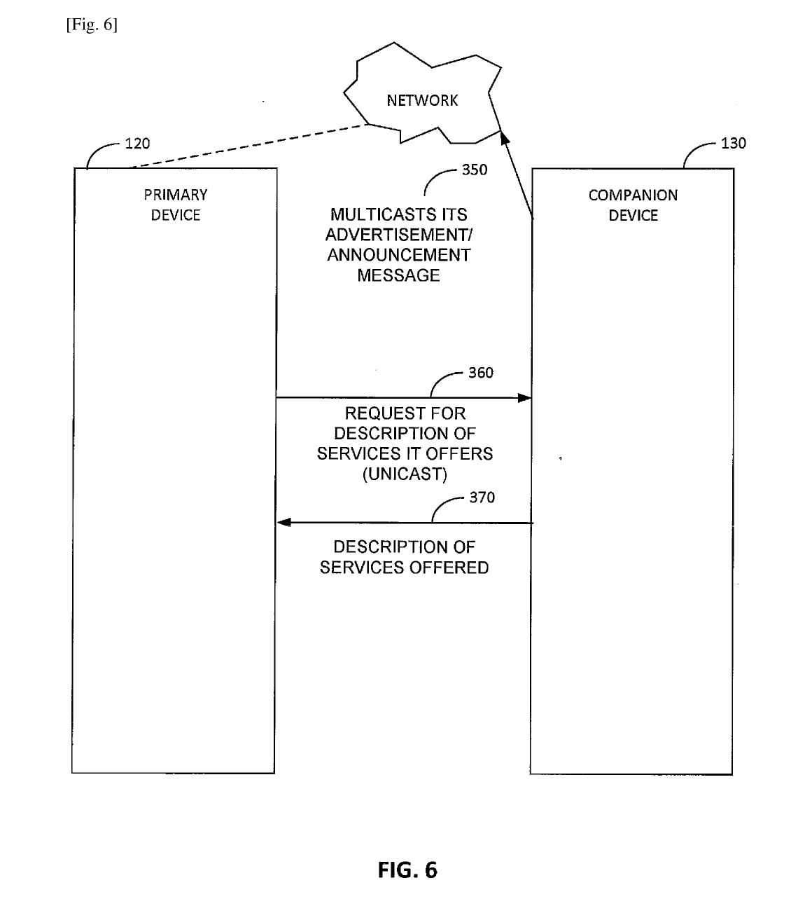

Referring to FIG. 6, by way of example, a new ATSC companion device 130 joins the network or an ATSC application is started on a companion device 130. The primary device 120 is already on the network. The companion device 130 multicasts its advertisement/announcement message 350 that announces the companion device 130 and its available services. The primary device 120 receives the multicast advertisement message from the companion device 130 via network and sends the companion device 130 a request for descriptions of the services it offers 360. The message may be sent via unicast, rather than multicast. The companion device receives the message and responds with a description of the services it offers 370 to the primary device 120. The primary device 120 uses the information given in the service descriptions to access the appropriate services and to understand the capabilities of the companion device.

As illustrated in FIGS. 3-6, the household may have more than one companion device on the home network and the household may have more than one primary device on the network. In this case each ATSC companion device would receive lookup messages from multiple different primary devices via network. Also multiple primary devices will receive announcement messages from multiple companion devices via network.

As noted above, in some environments, there may be more than one primary device 120, especially when using the home network. In this case, the companion device 130 may receive discovery messages from the multiple primary devices 120 via network. If that happens the companion device 130 may ask the user which of the primary devices 120 to interact with.

A typical application on the companion device 130 may operate as follows. A control point or service on the companion device 130 subscribes to a packaged apps service on the primary device 120. A packaged app may be an application on the device offering service. A viewer starts the packaged app on the primary device 120 The packaged app makes the name of application on the companion device 130 and the URL of the application on the companion device 130 available to the packaged app service. The control point on the companion device 130 receives the companion application name and URL. The control point sets a marker on the companion device 130 indicating that viewer action is needed. The viewer reviews the companion application name and selects it. The control point launches the indicated application on the companion device 130 as indicated by ATSC Candidate Standard: Interactive Services Standard (A/105:2014), Apr. 24, 2014 (513-2-389r7), incorporated by reference herein in its entirety.

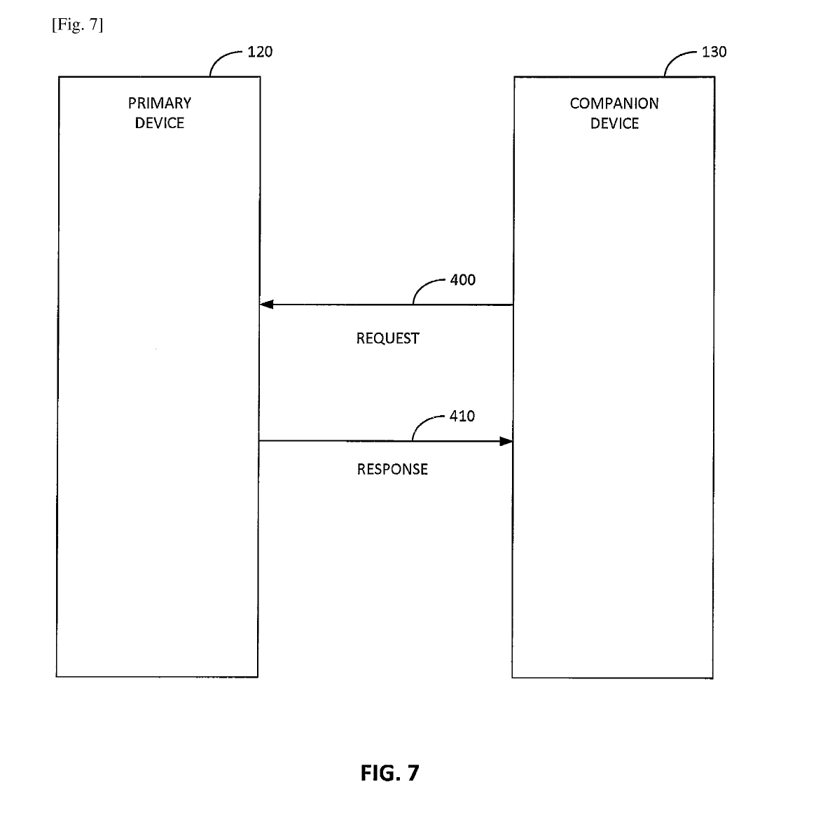

Referring to FIG. 7, it is desirable for the companion device 130 to request information from the primary device 120 about the current audiovisual content being presented on the primary device. While the companion device 130 may make a request to subscribe to the receive the information about content being presented the primary device 120 which provides a response with an ID for the content, and then make a request for the content based upon the ID, this is a cumbersome process. In addition, in the event that the content being displayed on the primary device 120 changes, then the ID provided by the companion device 130 that was previously received will refer to different content than that currently being presented on the primary device causing a disrupted experience for the viewer using the companion device 130. To alleviate the concern about receiving a response that does not correspond to the currently displayed audiovisual content, the companion device 130 preferably makes a single request 400 to the primary device 120 for information about the currently running service, program and/or show, and/or segment without having to provide an identification of the currently running service, show, and/or segment. The primary device 120, in response to receiving the request 400, provides a response 410 with the desirable information. The desirable information may include, for example, an electronic service guide type information about the content currently being presented on the primary device For example the companion device 130 may make a request to the primary device 120 to receive current service information. This may be invoked at any time when needed by the application. The input parameters for this request may include one or more of the following:
Companion Device ID
Companion Device Application ID
Companion Device Application Version
Current information requested may include one or more of following:
   Request for current show information (e.g., electronic service guide information for the current show being presented on the primary device);
   Request for currently available components for the current show being presented on the primary device (e.g., video, audio, closed captioning, main camera view, alternative camera view, etc. for the content being presented on the primary device);
   Request for currently available files and/or non-real-time content for the current show being presented on the primary device;
      Optionally the request may include a filtering criterion which may be used to limit the amount of information being requested in response thereto.

An example of the filtering criterion may be e.g., standard definition video only, high definition video or ultra high definition video, black/white video, color video, 5.1 channel audio, or stereo audio etc.

For example the primary device 120 may send a response to the companion device 130 after receiving the above request. This may preferably be sent upon receiving a service information request. The response parameters 410 may include one or more of the following:
Primary device ID
Requested information about the current show may include one or more of following:
   Current show information (e.g., electronic service guide);
   Information about ccurrently available components for the current show (e.g., video, audio, closed captioning, main camera view, alternative camera view);
   Currently available files and/or non-real-time content for the current show.

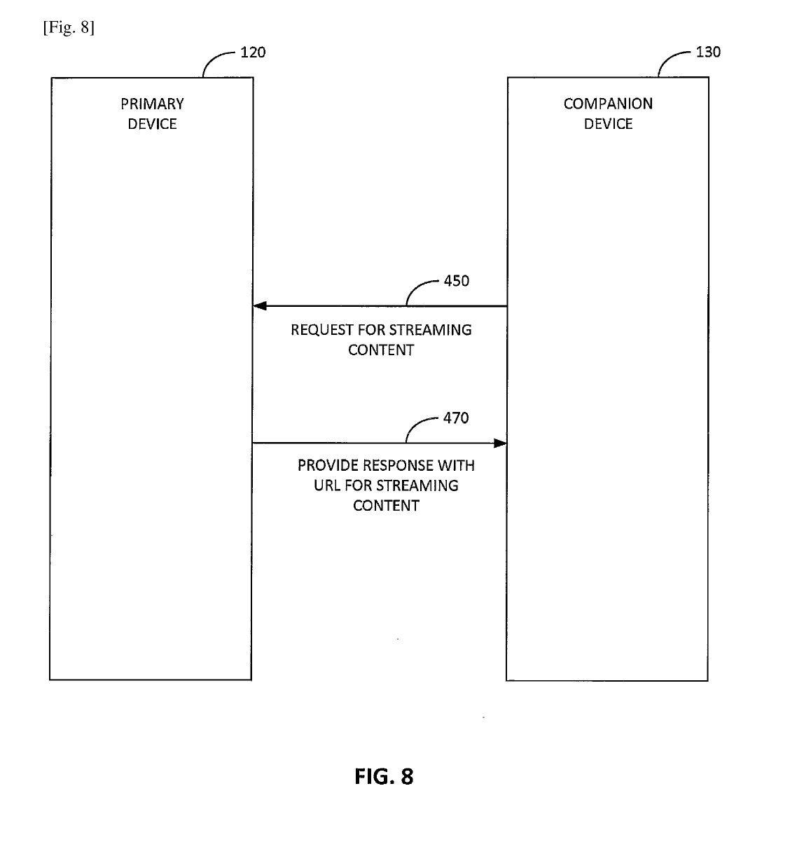

Referring to FIG. 8, when the companion device 130 is accessing audiovisual information from the primary device 120 and when the companion device 130 is accessing audiovisual information from another source, such as the Internet or a network location, it is desirable that both sources of such audiovisual information are addressed and obtained in a similar manner. The request for streaming content information 450 from the companion device may result in a description of the streaming content 470, that includes a location identification for the audiovisual content whether the location of the audiovisual information is from the primary device 120 or from another location, such as the Internet or a network.

For example the companion device 130 may make a request to the primary device 120 to receive service information. This may be invoked at any time when needed by the application or otherwise to continuously receive the streaming information. The input parameters may include one or more of the following:
Companion Device ID
Companion Device Application ID
Companion Device Application Version
Current information requested may include one or more of following:
   Request for current show information (e.g., electronic service guide information for the current show being presented on the primary device);
   Request for currently available components for the current show being presented on the primary device (e.g., video, audio, closed captioning, main camera view, alternative camera view, etc. for the content being presented on the primary device);
   Request for currently available files and/or non-real-time content for the current show being presented on the primary device;

Optionally the request may include a filtering criterion which may be used to limit the amount of information being requested in response thereto.

An example of the filtering criterion may be e.g., standard definition video only, high definition video or ultra high definition video, black/white video, color video, 5.1 channel audio, or stereo audio etc.

For example the primary device 120 may send a response to the companion device 130 after receiving the above request. This may preferably be sent upon receiving a service information request. The response parameters may include one or more of the following:
Primary device ID
Requested information about the current show may include one or more of following:
   Current show information (e.g., electronic service guide)
   Information about currently available components for the current show with URLs (which include information about protocol, IP address, port, etc.) for accessing the streaming data for each component (e.g., video, audio, closed captioning, main camera view, alternative camera view)
   Currently available files and/or non-real-time content for the current show

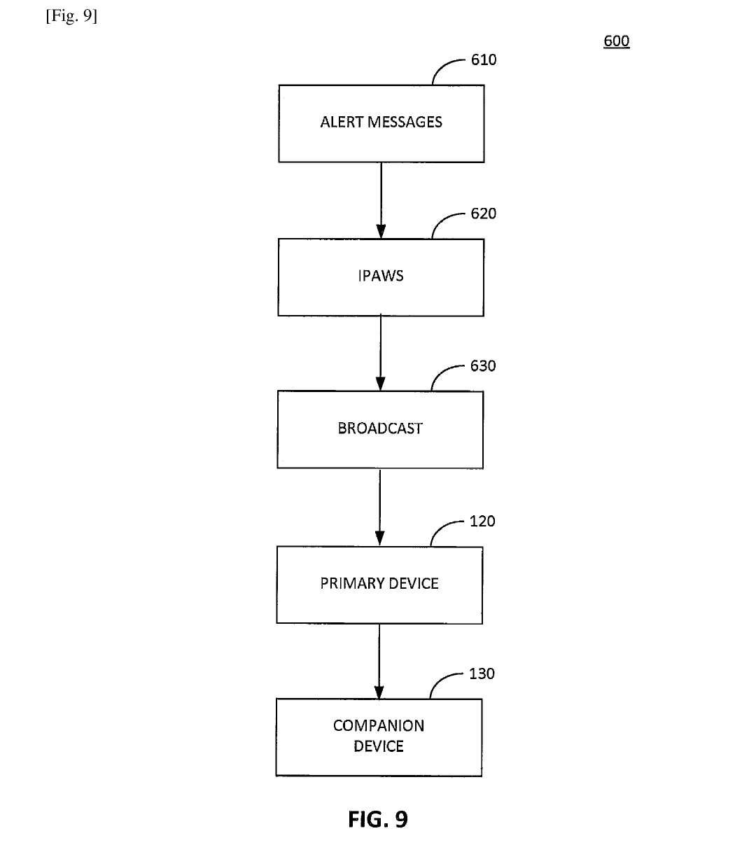

Referring to FIG. 9, an emergency alert system 600 may include alert message files 610 formatted in a common alerting protocol and further constrained by a profile of an integrated public alert and warning system (IPAWS) 620. These formatted and constrained alert message files may be issued by a suitable party, such as a federal or state agency. The alert message is broadcast by a broadcaster 630. The primary device 120 may receive these alert messages and selectively provide them to one or more of the companion devices 130.

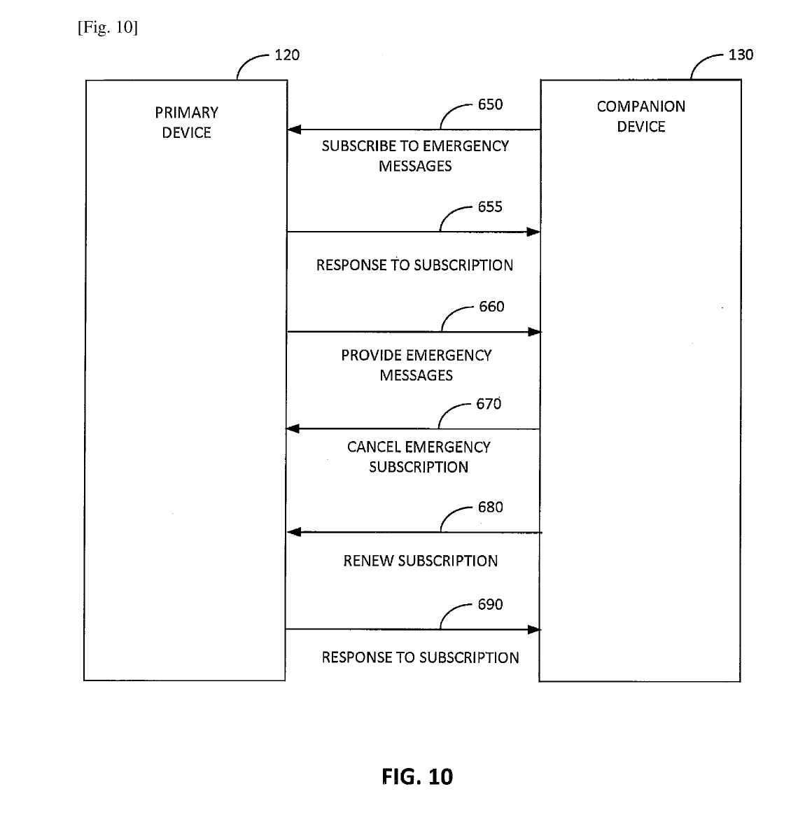

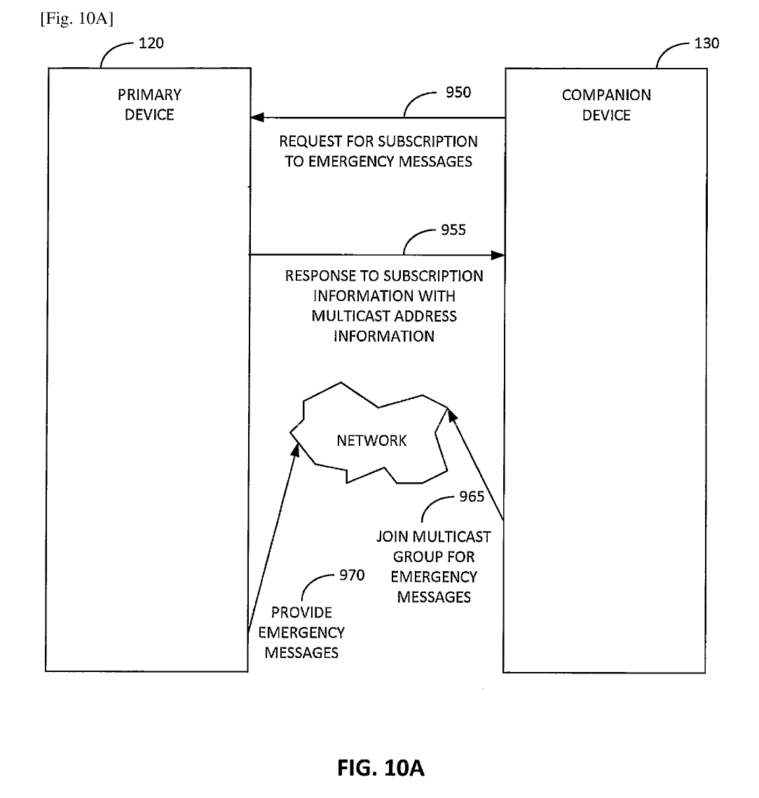

Referring to FIG. 10, the companion device 130 subscribes to emergency messages 650 from the primary device 120. The subscription request preferably includes a callback URL. The primary device accepts the subscription and send a subscription accepted response to the companion device 655 including a subscription ID. When an emergency message is received by the primary device 120, an emergency message is provided 660 to the companion device 130 that has subscribed to the emergency messages using the callback URL previously provided with the subscription. The message 660 may be provided as a notification message.

The companion device 130 may make the subscription to emergency messages when the companion device 130 joins the network or when an emergency message application is started on the companion device 130. The input parameters may include one or more of the following:
Companion Device ID
Companion Device Application ID
Companion Device Application Version
Subscription callback URL information
Optional: emergency message filtering criteria (e.g., geographic location filtering to provide emergency messages corresponding to only the specified location).

For example the primary device 120 may provide the emergency message subscription response to the companion device 130. This may be sent preferably upon receiving the subscription information. The subscription response may include one or more of the following:
Primary device ID
Subscription ID
Subscription duration (e.g., so that the emergency messages are not provided indefinitely, but rather for a reasonable duration that may be appropriate, such as 12 hours)

The companion device 130 may send a message to the primary device 120 to cancel the emergency message subscription 670. Based upon the subscription duration, the companion device 130 may send a message to the primary device 120 to subscribe to emergency messages 650 (or otherwise renew a subscription 680). The parameters provided for the renewal of a subscription may include one or more of the following:
Companion Device ID
Companion Device Application ID
Companion Device Application Version
Subscription ID

In this case, the primary device already has the callback URL and geographic filtering information, and the renewed subscription is based upon the subscription ID.

When the primary device 120 receives a subscription renewal or a subscription stop request it may provide a response 690 to the companion device 130, if desired. The response may include one or more of the following:
Principal Device ID
Subscription ID,
Subscription Duration for subscription renewal request
Success/Failure for subscription stop request

Referring to FIG. 10A, the companion device 130 requests information about subscription for emergency messages 950 from the primary device 120. The primary device accepts the request and sends a subscription information response to the companion device 955 including a multicast address information where the emergency alert messages are sent. The multicast address information may include one or more of the following information:
Multicast group address
Multicast port
Protocol information
Additional multicast related information for emergency messages

The companion device 130 may join 965 the multicast group for emergency alert messages using the multicast address information. The input parameters when joining the multicast group may include zero or more of the following:
Companion Device ID
Companion Device Application ID
Companion Device Application Version
Optional: emergency message filtering criteria (e.g., geographic location filtering to provide emergency messages corresponding to only the specified location).

When an emergency message is received by the primary device 120, the emergency message is notified 970 on the multicast group for emergency alert messages.

The emergency alert message 970 may include one or more of the following:
Primary Device ID
Basic/initial contents of emergency alert message
Pointer (e.g. location information/URL) for additional information about the emergency alert message

The companion device 130 that has joined the multicast group for emergency alert messages may receive the emergency alert messages from the multicast group. The message 970may be provided as a notification message.

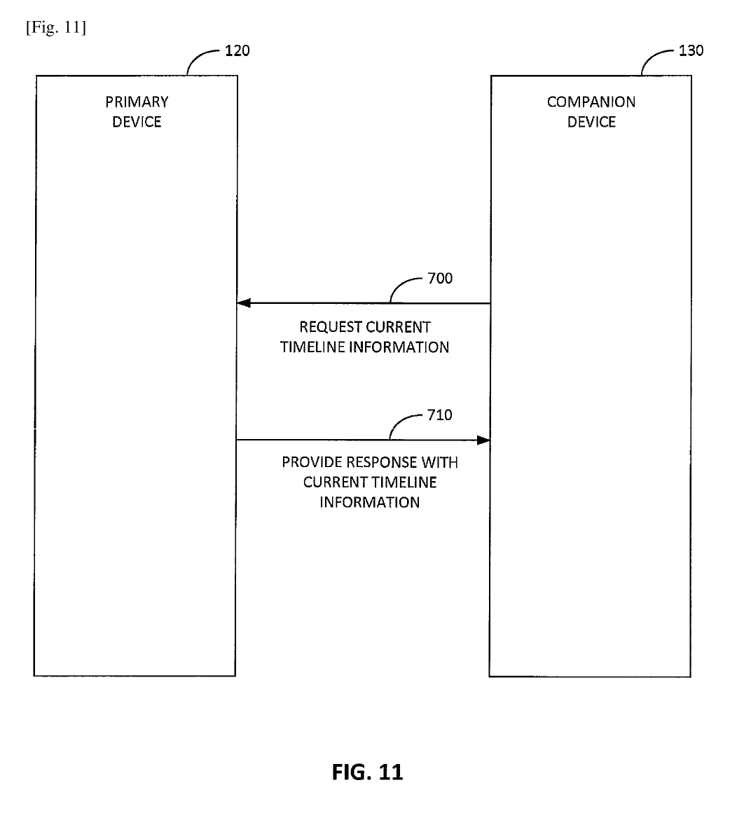

Referring to FIG. 11, in some embodiments it is desirable to include a single transaction request response technique to receive timeline location information by the companion device 120 from the primary device 120. This facilitates the synchronization of the audiovisual content being displayed on the primary device 120 and the companion device 130.

For example the companion device 130 may make a request to the primary device 120 to receive the current timeline information 700. This may be invoked at any time when needed by the application. The input parameters may include one or more of the following:
Companion Device ID
Companion Device Application ID
Companion Device Application Version
The URL and/or the ID for which the current timeline information is requested or current show being viewed.

For example the primary device 120 may make a response to the companion device 130 with the current timeline information. This may be preferably sent upon receiving the request for the current timeline information. The response parameters may include one or more of the following:
Primary device ID
Current timeline location information for the requested URL and/or program ID.

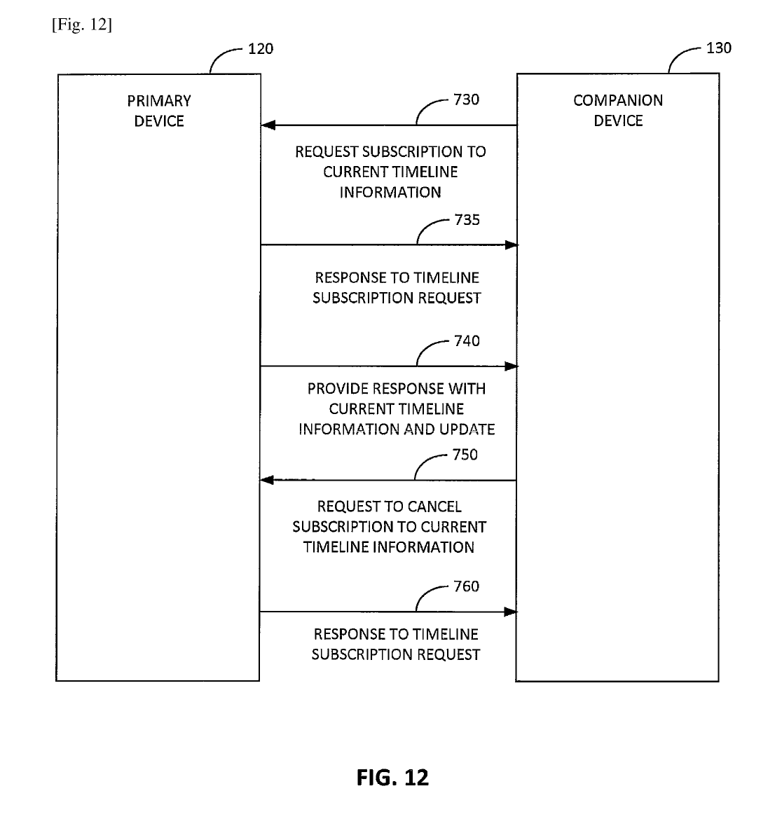

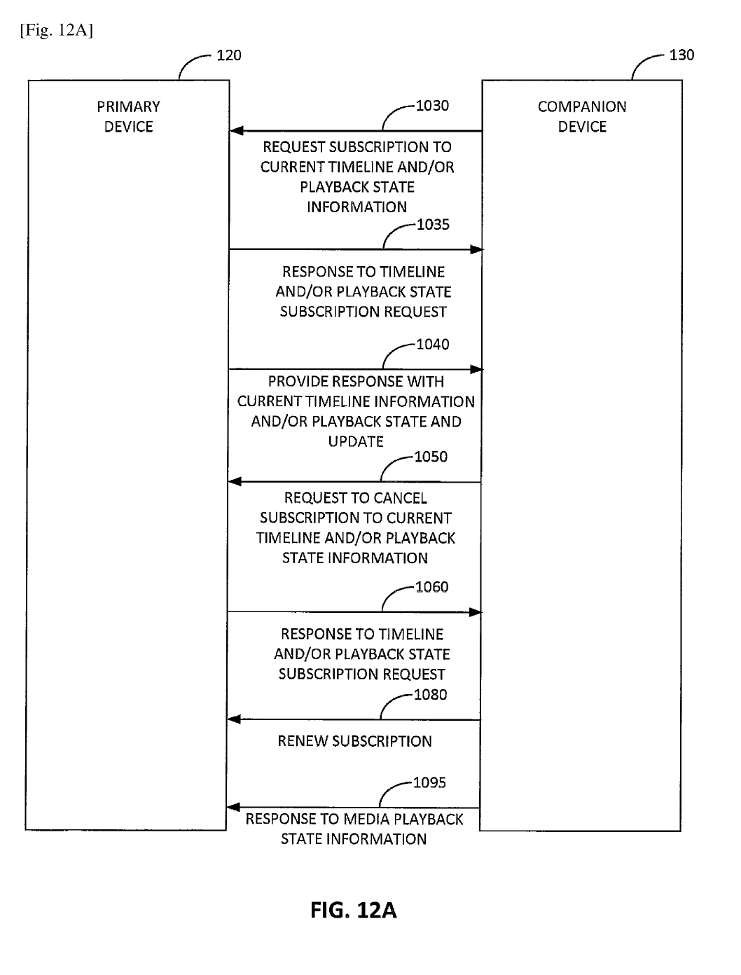

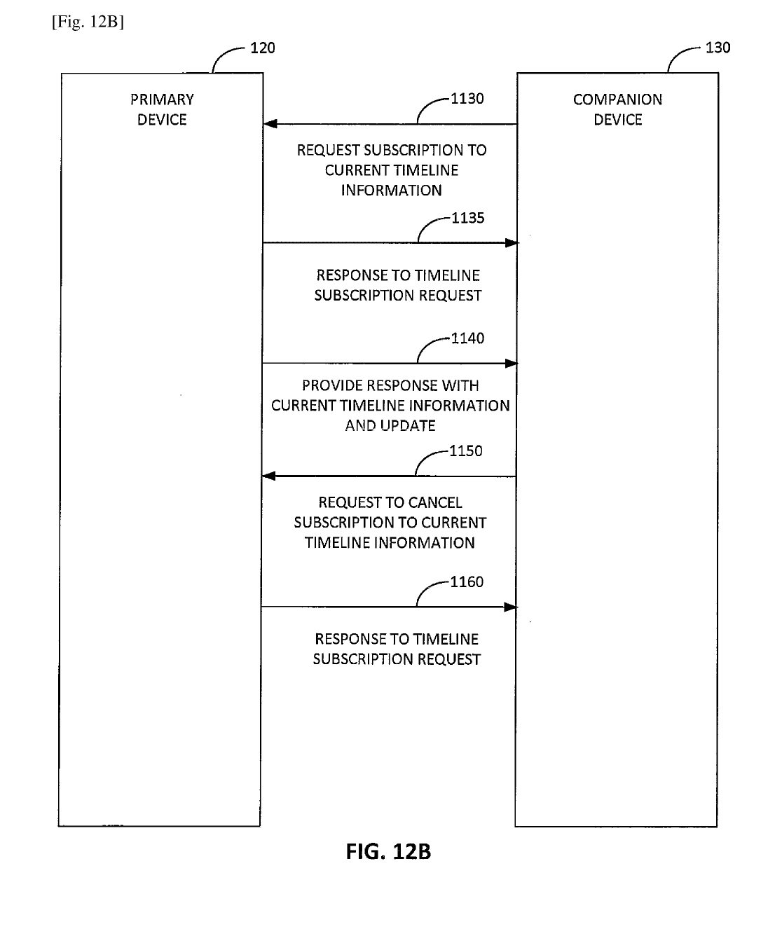

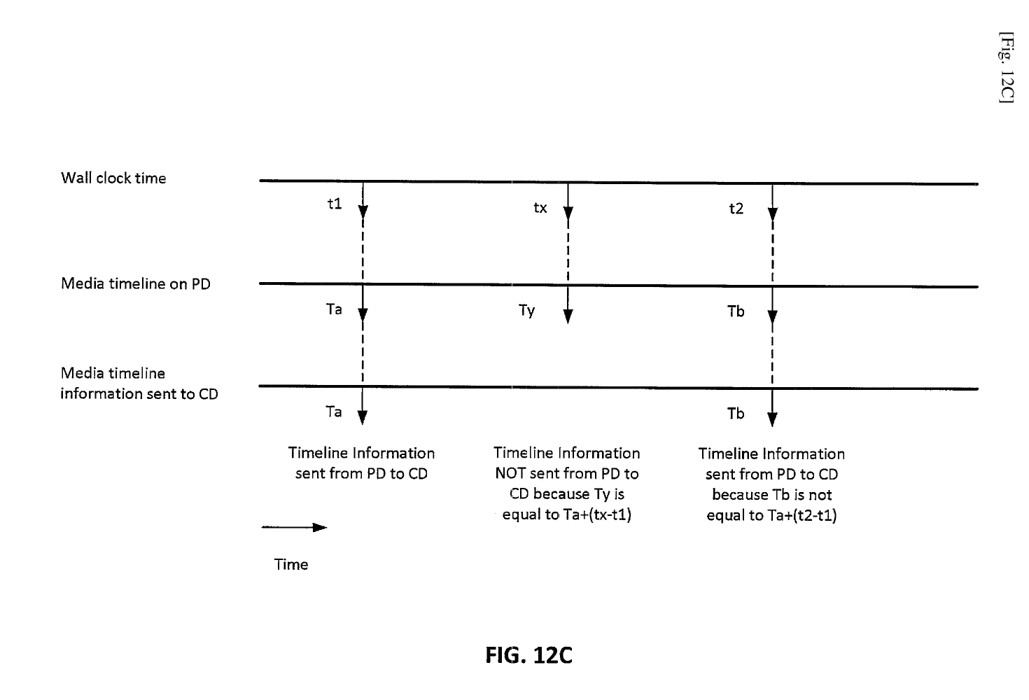

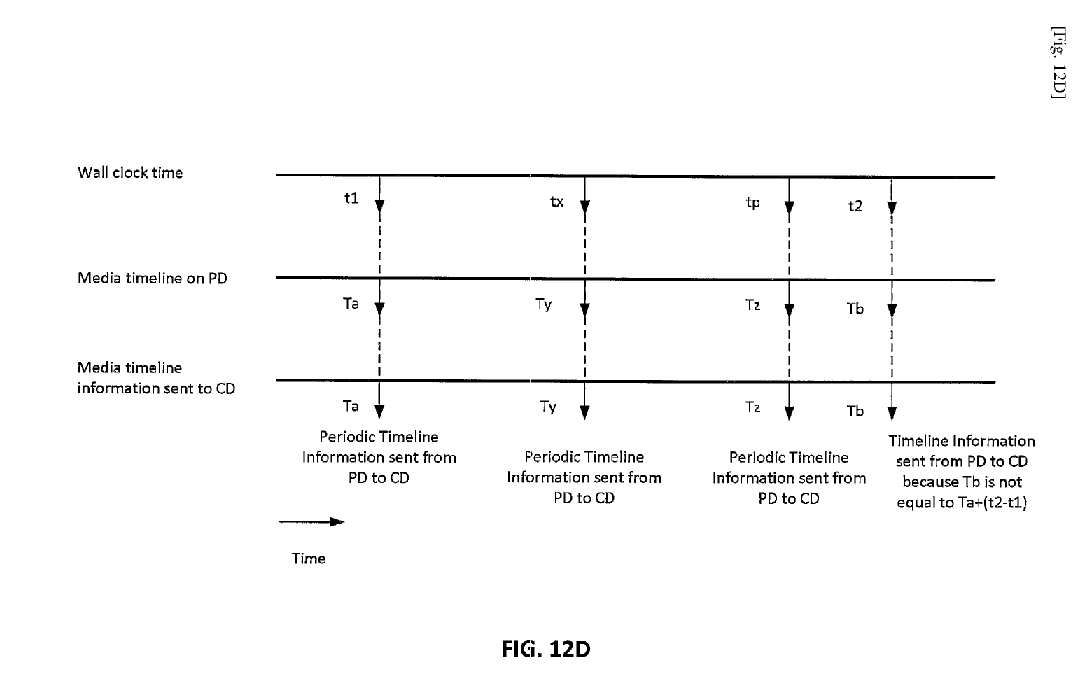

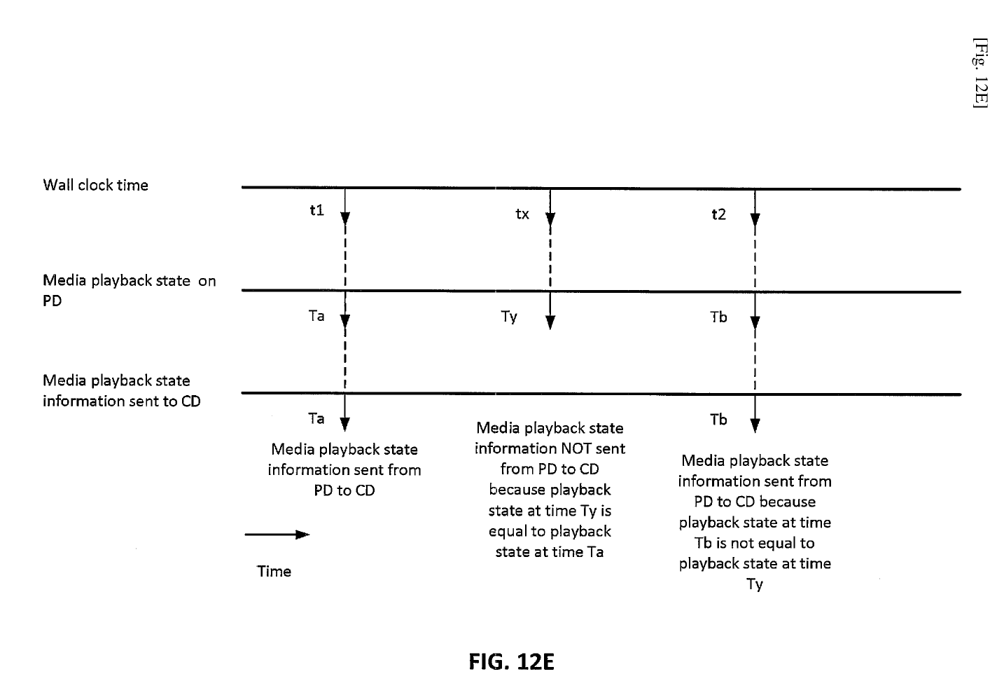

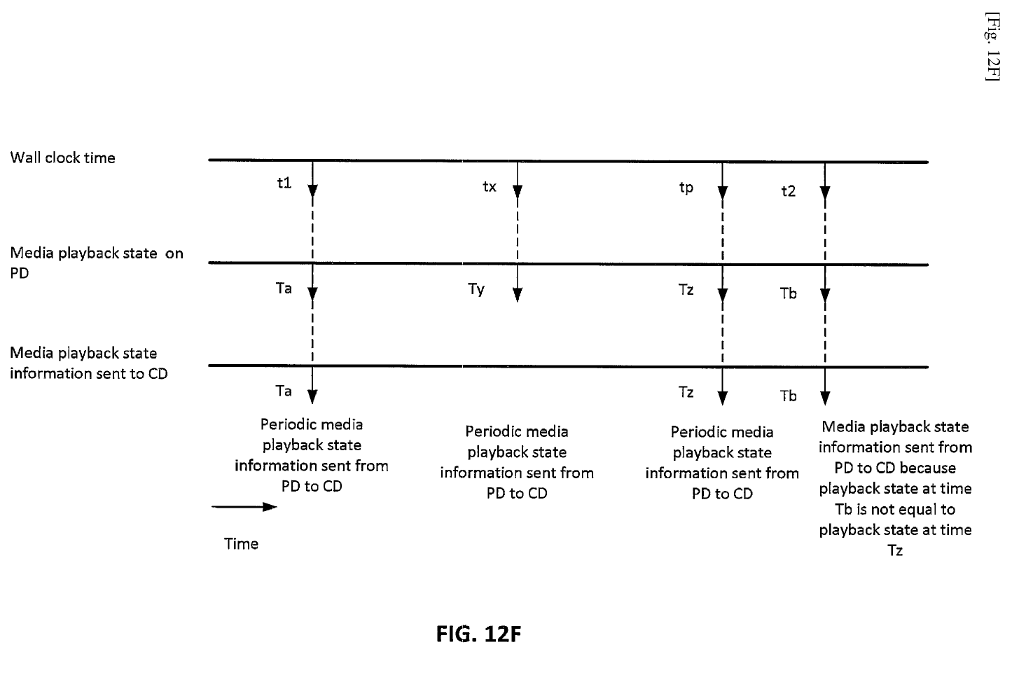

Referring to FIG. 12, in some embodiments it is desirable to include a subscription request response technique to receive timeline information by the companion device 120 from the primary device 120. This facilitates the synchronization of the audiovisual content being displayed on the primary device 120 and the companion device 130.

For example the companion device 130 may make a request to the primary device 120 to subscribe to the current timeline information 730. This may be invoked at any time when needed by the application. The input parameters may include one or more of the following:
Companion Device ID
Companion Device Application ID
Companion Device Application Version
The URL and/or the ID for which the current timeline information is requested or current show being viewed
Timeline subscription callback URL information

The primary device 120 may send a response to the companion device 130 in response to receiving the timeline subscription response 735. The response parameters may include one or more of the following:
Primary device ID
Timeline subscription ID.

The timeline subscription ID may be used to uniquely identify this particular timeline subscription. Thus assigning a timeline subscription ID for each timeline subscription is preferred. This can allow a companion device to request multiple timeline information from primary device at the same time. It can also allow different companion devices to request information about different timelines from different primary devices.

For example the primary device 120 may make a notification to the companion device 130 with the current timeline information that is updated on a regular basis 740. This may be invoked at any time to convey the current timeline information. The response parameters may include one or more of the following:
Primary device ID
Current timeline location information for the requested URL and/or program ID.
URL and/or program ID

The companion device 130 may cease receiving the subscription timeline information after a predetermined period of time and/or sending a request to cancel the subscription 750 to the primary device 120. The request 750 may include the subscription ID to uniquely identify the timeline subscription being cancelled. The primary device may send a response 760 upon receiving a request to cancel the subscription indicating success or failure.

A Similar request response 750 and 760 may be exchanged between the primary device and the companion device to renew the timeline subscription. In this case the request may include the timeline subscription Id to uniquely identify the timeline subscription being renewed.

Referring to FIG. 12A, in some embodiments it is desirable to include a subscription request response technique to receive timeline and/or media playback state information by the companion device 120 from the primary device 120. This facilitates the synchronization of the audiovisual content being displayed on the primary device 120 and the companion device 130.

For example the companion device 130 may make a request to the primary device 120 to subscribe to the current timeline and/or current media playback information 1030 on primary device 120. This may be invoked at any time when needed by the application. The input parameters may include one or more of the following:
Companion Device ID
Companion Device Application ID
Companion Device Application Version
The URL and/or the ID for which the current timeline and/or current media playback information is requested or for the current show being viewed
Timeline and playback state subscription callback URL information
Optional: filter (send only media timeline information/send only media playback state information/send both media timeline and media playback state information)
Optional: Desired frequency at which to receive the notification about media timeline and/or media playback state information

The primary device 120 may send a response to the companion device 130 in response to receiving the timeline and/or media playback state subscription response 1035. The response parameters may include one or more of the following:
Primary device ID
Timeline and/or playback state subscription ID
Subscription duration

The Timeline and/or playback state subscription ID may be used to uniquely identify this particular subscription. Thus assigning a timeline and/or playback state subscription ID for each timeline and/or playback state subscription is preferred. This can allow a companion device to request multiple timeline and playback state information from primary device at the same time. It can also allow different companion devices to request information about different timelines and playback states from different primary devices.

For example the primary device 120 may make a notification to the companion device 130 with the current timeline and/or media playback state information that is updated on a regular basis 1040. This may be invoked at any time to convey the current timeline and/or media playback state information. The response parameters may include one or more of the following:
Primary device ID
Subscription ID
Current timeline location information for the requested Subscription ID.
Current media playback state information for the Subscription ID.
   This media playback state may include, for example, playing, paused, stopped, fast forward, speed of fast forward, fast backward, speed of fast backward, and buffering.

The companion device 130 may cease receiving the subscription timeline and/or media playback state information after a predetermined period of time and/or by sending a request to cancel the subscription 1050 to the primary device 120. The primary device may send a response 1060 upon receiving a request to cancel the subscription indicating success or failure.

A similar request response 1050 and 1060 may be exchanged between the primary device and the companion device to renew the timeline and/or media playback state subscription. In this case the request may include the timeline and/or media playback state subscription ID to uniquely identify the timeline and/or media playback state subscription being renewed. A renew subscription 1080 from the companion device 130 to the primary device 120 is preferably sent any time at or before the current subscription times out to renew the current subscription or otherwise after the current subscription times out to renew the previous subscription. A response to media playback state information 1095 from the companion device 130 to the primary device 120 is preferably sent in response to receiving the media playback state information 1040.

Referring to FIG. 12B, in some embodiments it is desirable to include a subscription request response technique to receive timeline information by the companion device 120 from the primary device 120. This facilitates the synchronization of the audiovisual content being displayed on the primary device 120 and the companion device 130.

For example the companion device 130 may make a request to the primary device 120 to subscribe to the current timeline information 1130. This may be invoked at any time when needed by the application. The input parameters may include one or more of the following:
Companion Device ID
Companion Device Application ID
Companion Device Application Version
The URL and/or the ID for which the current timeline information is requested or for the current show being viewed
Timeline subscription callback URL information

The primary device 120 may send a response to the companion device 130 in response to receiving the timeline subscription response 1135. The response parameters may include one or more of the following:
Primary device ID
Timeline subscription ID.

The timeline subscription ID may be used to uniquely identify this particular timeline subscription. Thus assigning a timeline subscription ID for each timeline subscription is preferred. This can allow a companion device to request multiple timeline information from primary device at the same time. It can also allow different companion devices to request information about different timelines from different primary devices.

For example the primary device 120 may make a notification to the companion device 130 with the current timeline information that is updated on a regular basis 1140. Thus the current timeline information may be sent periodically. Additionally the timeline information may be sent from primary device 120 to companion device 130 whenever the timeline on the primary device changes nonlinearly. This non-linear timeline change based notification is described later with respect to FIG. 12C and FIG. 12D. This may be invoked at any time to convey the current timeline information. The response parameters may include one or more of the following:
Primary device ID
Current timeline location information for the requested URL and/or program ID.
URL and/or program ID

The companion device 130 may cease receiving the subscription timeline information after a predetermined period of time and/or by sending a request to cancel the subscription 1150 to the primary device 120. The request 1150 may include the subscription ID to uniquely identify the timeline subscription being cancelled. The primary device may send a response 1160 upon receiving a request to cancel the subscription indicating success or failure.

A similar request response 1150 and 1160 may be exchanged between the primary device and the companion device to renew the timeline subscription. In this case the request may include the timeline subscription ID to uniquely identify the timeline subscription being renewed.

The non-linear timeline change based notification is described with respect to FIG. 12C and FIG. 12D. A non-linear timeline change may be detected when during certain wall-clock time period the media timeline changes by a duration different than the wall-clock time duration. As an example if timeline information was communicated by PD to CD at wall-clock time t1, when the media timeline communicated was Ta. Then at a subsequent wall-clock time t2 (with t2>=t1) if the media timeline information Tb is such that Tb is not equal to (or approximately) equal to Ta+(t2−t1) or is not equal to Ta−(t2−t1) or is not equal to Ta+x*(t2−t1) where x is a real number then the media timeline information Tb may be communicated from PD to CD at wall-clock time t2. These scenarios are illustrated further in FIG. 12C and FIG. 12D.

In FIG. 12C PD after sending the media timeline information Ta to CD for the first time, does not send media timeline information to CD unless non-linear timeline change happens. Thus at wall-clock time tx, when the media timeline information on PD is equal to Ty, since Ty is equal to Ta+(tx−t1), the media timeline information Ty is not sent from PD to CD. This is because in this case a clock running on CD could automatically derive the value Tb. At wall-clock time t2, when the media timeline information on PD is equal to Tb, since Tb is not equal to Ta+(t2−t1), the media timeline information Tb is sent from PD to CD.

In FIG. 12D in addition to sending the non-linear timeline change event information from PD to CD; timeline information is also sent periodically from PD to CD. Thus periodically at wall-clock time t1, tx, tp respectively the media timeline information Ta, Ty, Tz respectively is sent from PD to CD. At wall-clock time t2, when the media timeline information on PD is equal to Tb, since Tb is not equal to Ta+(t2−t1), the media timeline information Tb is sent from PD to CD. It should be also noted that Tb is not equal to Tz+(t2−tp) and Tb is also not equal to Ty+(t2−tx).

In one particular embodiment of the non-linear timeline change event, the timeline information is communicated from PD to CD when a program/show completes playback on PD and a new program/show playback starts. Another example is when a service or channel change occurs on PD.

The media playback state change based notification is described with respect to FIG. 12E and FIG. 12F. A media playback state change change may be detected by keeping track of a previous media playback state and keeping track of when a current media playback state is different than the previous media playback state. When the media playback state changes it can be notified from primary device (PD) to companion device (CD). As an example if media playback state information was communicated by PD to CD at wall-clock time t1, and media timeline time on PD equal to Ta. Then at a subsequent wall-clock time t2 (with t2>=t1) and media timeline time on PD equal to Tb if the media playback state at Tb is different than the media playback state at Ty (or at Ta) then the media playback state information at time Tb may be communicated from PD to CD at wall-clock time t2. These scenarios are illustrated further in FIG. 12E and FIG. 12F.

In FIG. 12E, PD after sending the media playback state information at time Ta to CD for the first time, PD does not send media playback state information to CD unless the media playback state on the PD changes. Thus at wall-clock time tx, and media timeline time on PD equal to Ty, when the media playback state information on PD at time Ty is equal to media playback state information on PD at time Ta, the media playback state information is not sent from PD to CD. This is because in this case the CD already currently knows the media playback state information on PD since it has not changed. At wall-clock time t2, when the media timeline information on PD, and media timeline time on PD equal to Tb, since the media playback state on PD at Tb is not equal to media playback state on PD at Ta, the media playback state information at Tb is sent from PD to CD.

In FIG. 12F, in addition to sending the media playback state information change event information from PD to CD; media playback state information information is also sent periodically from PD to CD. Thus periodically at wall-clock time t1, tx, tp respectively which corresponds to media playback timeline on PD equal to Ta, Ty, Tz, the media playback state information is sent from PD to CD. At wall-clock time t2, when the media timeline information on PD is equal to Tb, since at Tb media playback state information is not equal to the media playback state information at time Tz the media timeline information is sent from PD to CD.

In one particular embodiment of the media playback state change event, the media playback state information is also communicated from PD to CD when a program/show completes playback on PD and a new program/show playback starts. Another example is when a service or channel change occurs on PD.

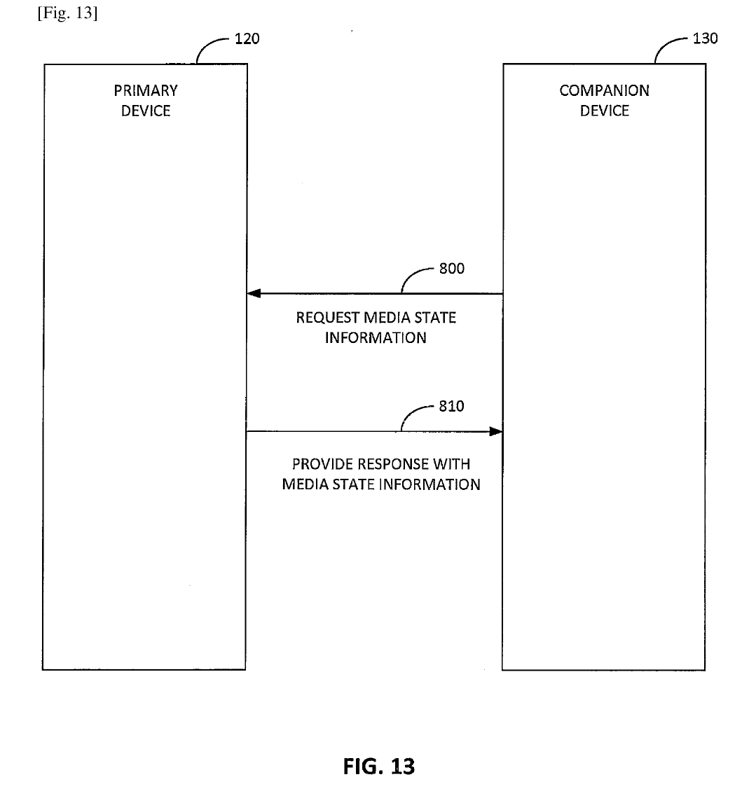

Referring to FIG. 13, in some embodiments it is desirable to convey the media playback state of the media (service/program/show/segment) being played back on the primary device 120 to the companion device 130. This information is especially useful for the companion device 130 if it desires to stay in synchronization with the primary device 120. This facilitates the synchronization of the audiovisual content being displayed on the primary device 120 and the companion device 130.

For example the companion device 130 may make a request to the primary device 120 to receive the media state information 800. This may be invoked at any time when needed by the application. The input parameters may include one or more of the following:
Companion Device ID
Companion Device Application ID
Companion Device Application Version
The URL and/or the ID for which the media playback state is requested.

For example the primary device 120 may make a response to the companion device 130 with the media state information 810. This may be preferably sent upon receiving the request for the media state information. The response parameters may include one or more of the following:
Primary device ID
Current media playback state information for the requested URL/ID.

This current media playback state may include, for example, playing, paused, stopped, fast forward, speed of fast forward, fast backward, speed of fast backward, and buffering.

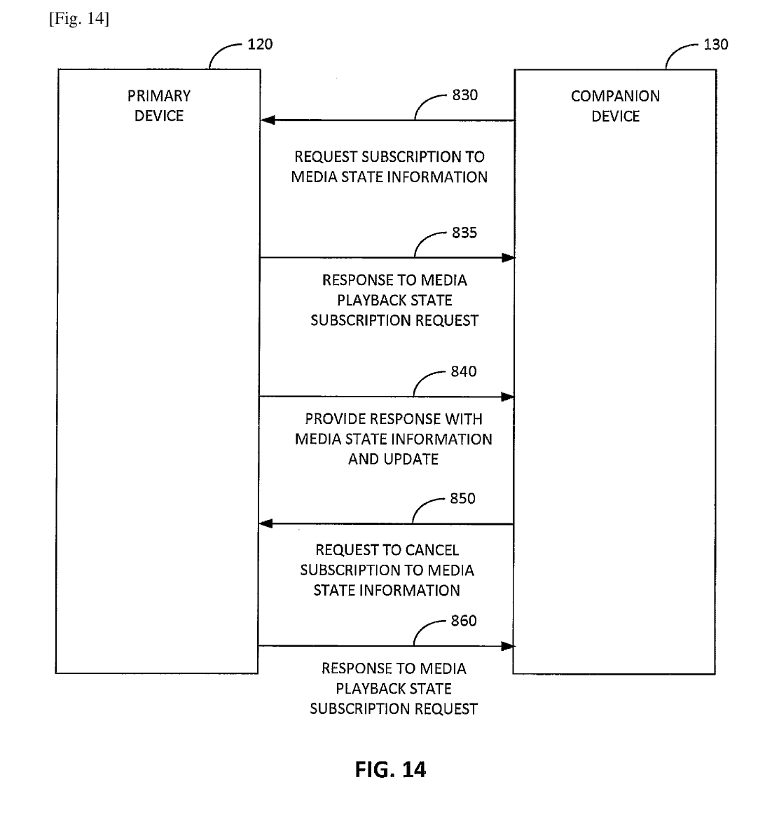

Referring to FIG. 14, in some embodiments it is desirable to include a subscription request response technique to receive the media state information by the companion device 120 from the primary device 120. This facilitates the synchronization of the audiovisual content being displayed on the primary device 120 and the companion device 130.

For example the companion device 130 may make a request to the primary device 120 to subscribe to the media playback state information 830. This may be invoked at any time when needed by the application. The input parameters may include one or more of the following:
Companion Device ID
Companion Device Application ID
Companion Device Application Version
The URL and/or the ID for which the media playback state is requested
Media state subscription callback URL information

The primary device 120 may send a response to the companion device 130 in response to receiving the media playback state subscription response. The response parameters may include one or more of the following:
Primary device ID
Media playback state subscription ID.

The media playback state subscription ID may be used to uniquely identify this particular media playback state subscription. Thus assigning a media playback state subscription ID for each media playback state subscription is preferred. This can allow a companion device to request multiple media playback state information from the primary device at the same time. It can also allow different companion devices to request information about different media playback states from different primary devices.

For example the primary device 120 may send a notification to the companion device 130 with the current media playback state information that is updated on a regular basis 840. This may be invoked at any time to convey the media playback state information. In one embodiment the notification may be sent every time the media playback state changes. For example if the viewer pauses the presentation on the primary device. Then a media playback state notification indicating the “Paused” state will be sent from the primary device to the secondary device. Then later when the viewer resumes play on the primary device a media playback state notification indicating the “Playing” state will be sent from the primary device to the secondary device. This can allow the companion device to playback media synchronized with the primary device. For example in one embodiment companion device may automatically change its own media playback state when it receives a notification message indicating the change in the media playback state of the primary device. Thus the response parameters may include one or more of the following:
Primary device ID
Media state subscription ID information for the requested URL and/or program ID
Current media playback state information for the subscription ID.

This may include, for example, playing, paused, stopped, fast forward, speed of fast forward, fast backward, speed of fast backward, and buffering.

The companion device 130 may cease receiving the media state subscription information after a predetermined period of time and/or sending a request to cancel the subscription 850 to the primary device 120. The primary device may send a response 860 upon receiving a request to cancel the subscription indicating success or failure.

A similar request response as 850 and 860 may be exchanged between the primary device and the companion device to renew the media playback state subscription. In this case the request preferably includes the media playback state subscription ID to uniquely identify the media playback state subscription being renewed.

In some embodiments, there may be multiple audiovisual content being displayed each having their own timeline, which is managed by the companion device. In this manner, the companion device can simultaneously display more than one audiovisual content and/or switch between different audiovisual content, while being in synchronization with the corresponding primary device. In addition, by subscribing to the media playback state information, the primary device 120 may notify the media playback state to the companion device 130 when events occur, such as for example, stopping the audiovisual content, pausing the audiovisual content, fast forwarding the audiovisual content, rewinding the audiovisual content, skipping forward and/or backward in the audiovisual content, or otherwise.

As previously described for example in relation with FIG. 5 and FIG. 6, the companion device 130 may be made discoverable from the primary device 120.

For example the companion device 130 may advertise or announce a message to help its discovery by the primary device 120. This may be invoked at any time when needed by the application, such as starting the application and/or joining the network using a multicast message, or when the primary device sends a multicast search request for device/service types of the companion device (for example a unicast message from companion device). The input parameters may include one or more of the following:
Companion Device ID
Companion Device Application ID
Companion Device Application Version
Human readable name of companion device
Companion device services (service types) supported

For example the primary device 120 may send a multicast message to the network to discover the companion device 130. Thus the primary device may send a multicast search message looking for device type/service type of companion device(s). The search message parameters may include one or more of the following:
Primary device ID
Primary Device type
Primary Device version
Human readable name of primary device
Companion device type and/or companion device service type being looked up

It is to be understood that the system may be reconfigured, as desired. It is to be understood that the system may include additional elements and/or fewer elements, as desired. It is to be understood that some of the message sequence may be altered such that a message 1 shown to be sent before message 2 may instead be sent after message 2.

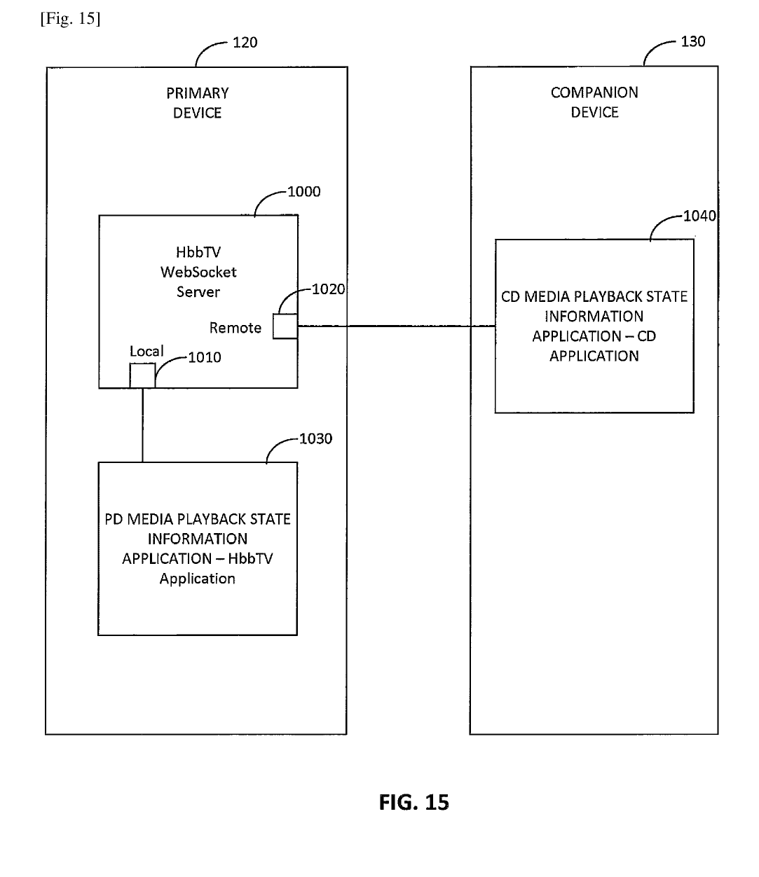

Referring to FIG. 15, an exemplary primary device 120 is illustrated together with an exemplary companion device 130. The primary device 120 may include a HbbTV WebSocket server 1000 that includes a remote service end-point 1020 and a local service end-point 1010. HbbTV is a standard for the delivery of broadcast TV and broadband TV principally to the home, through a single user interface which is suitable for operating over different broadcasting technologies, such as for example, satellite, cable, terrestrial, and/or IP based networks. HbbTV is defined by one or more of the following, HbbTV 2.0 Working Draft HbbTV-working-draft_{—}ts_102796v010301p_draft_23-non-etsi-branding.pdf, ETSI TS 102 796 v1.1.1 in June 2010, and ETSI TS 102 796 v1.2.1 November 2012, all of which are incorporated by reference herein in their entirety. The HbbTV WebSocket server 1000 may include the local service end-point 1010 that provides interconnection to a PD media playback state information application 1030 that is HbbTV compliant. In this manner, the system is suitable for readily including more than one PD media playback state information application 1030, through the use of multiple local host 1010 connections, while maintaining the same HbbTV WebSocket Server 1000. The companion device 130 may include a CD media playback state information application 1040. The CD media playback state information application 1040 may interconnect with the HbbTV WebSocket Server 1000 through the use of the remote service end-point 1020. In this manner, the system is suitable for readily including more than one CD media playback state information application 1040 and/or is suitable for readily including more than one CD media playback state information application 1040, each with a different companion device 130.

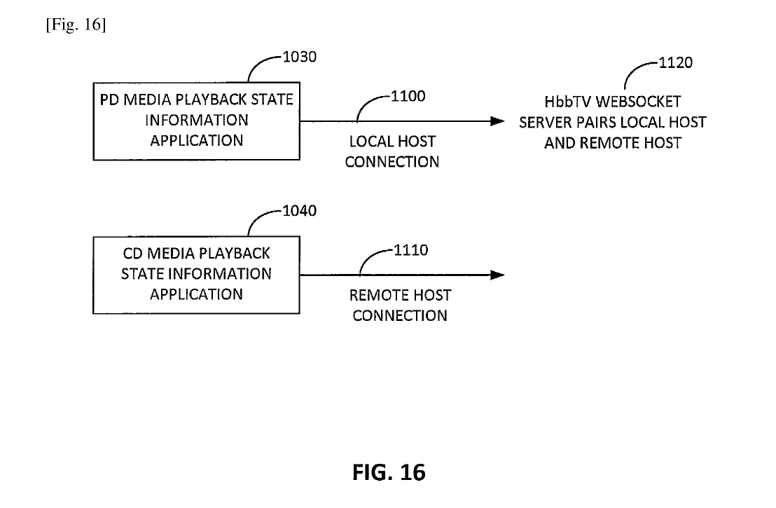

The communication between the primary device 120 and the companion device 130 may establish the media playback state information. Referring also to FIG. 16, the PD media playback state information application 1030, acting as a client, makes a connection 1100 to the local service end-point 1010 of the HbbTV WebSocket Server 1000 on primary device 120 using a base url resource (e.g., /hbbtv/) and with appendpoint (e.g., “org.atsc.pdcdmpl”). In this manner, the PD media playback state information application identifies both the resource requested and the type of service with a two part identifier, namely, “/hbbtv” and “org.atsc.pdcdmpl”. Other identification mechanisms may likewise be used, if desired. Also the exact string used for each of the two part identifiers may be different than those described above. The CD media playback state information application 1040 acting as a client makes a connection 1110 to the remote service end-point 1020 of the HbbTV WebSocket Server 1000 on primary device 120 with a base url resource (e.g., /hbbtv/) and with the same app end-point (e.g., “org.atsc.pdcdmpl”). In this manner, the CD media playback state information application identifies both the resource requested and the type of service with a two part identifier. Other identification mechanisms may likewise be used, if desired. The HbbTV WebSocket server 1000, upon receiving a connection from the remove service 1020 and a connection from the local service 1010, both of which having a matching base url resource with the same app end-point, are paired 1120 by the HbbTV WebSocket server 1000 as they are both waiting on connections. After pairing, the PD media playback state information application 1030 and the CD media playback state information application 1040, may communicate with each other, either directly or through the HbbTV WebSocket server 1000, using an media playback state information protocol.

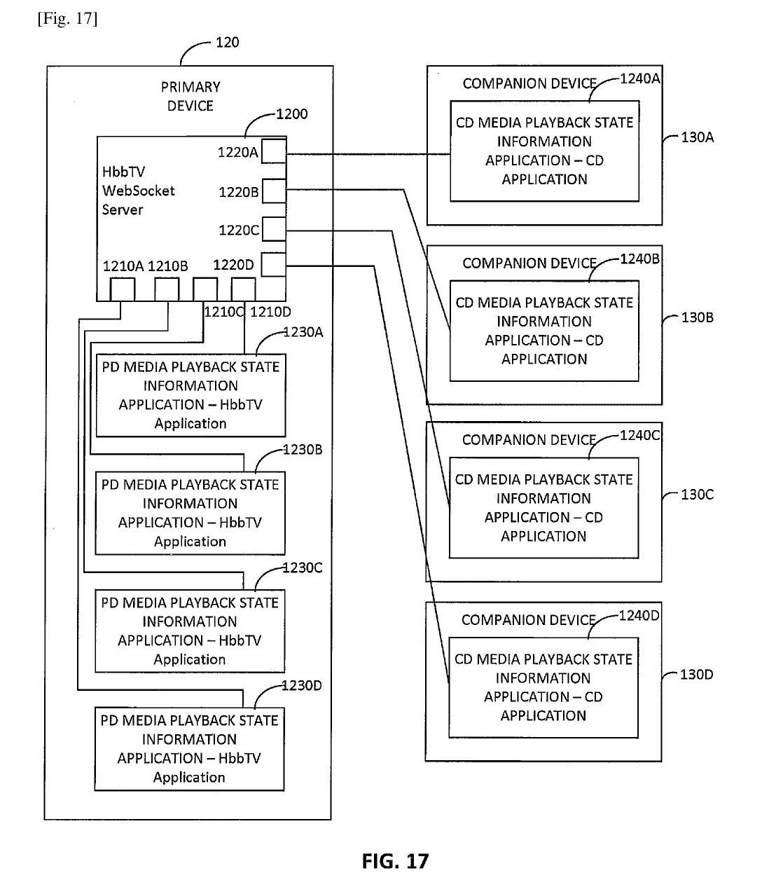

Referring to FIG. 17, in another embodiment the primary device 120 includes a HbbTV WebSocket server 1200 together with a plurality of local service end-points 1210A-1210D. A plurality of PD media playback state information applications 1230A-1230D may be included within the same primary device 120 which communicate with the HbbTV WebSocket server 1200 through a respective local service end-points 1210A-1210D. Each of the respective PD media playback state information applications 1230A-1230D may be different instantiations of the same application or may be different applications suitable to communicate different media playback state information messages from the same and/or different sources. The HbbTV WebSocket server 1200 may include a plurality of remote service end-points 1220A-1220D. A plurality of companion devices 130A-130D may each include a corresponding CD media playback state information application 1240A-1240D. In this manner, each of the PD media playback state information applications 1230A-1230D may communicate with a respective one or more of the CD media playback state information application 1240A-1240D. In some cases, two or more PD media playback state information applications 1230A-1230D may communicate with the same CD media playback state information application 1240A-1240D. This provides flexibility in the configuration of the PD media playback state information applications 1230A-1230D communicating with the CD media playback state information applications 1240A-1240D.

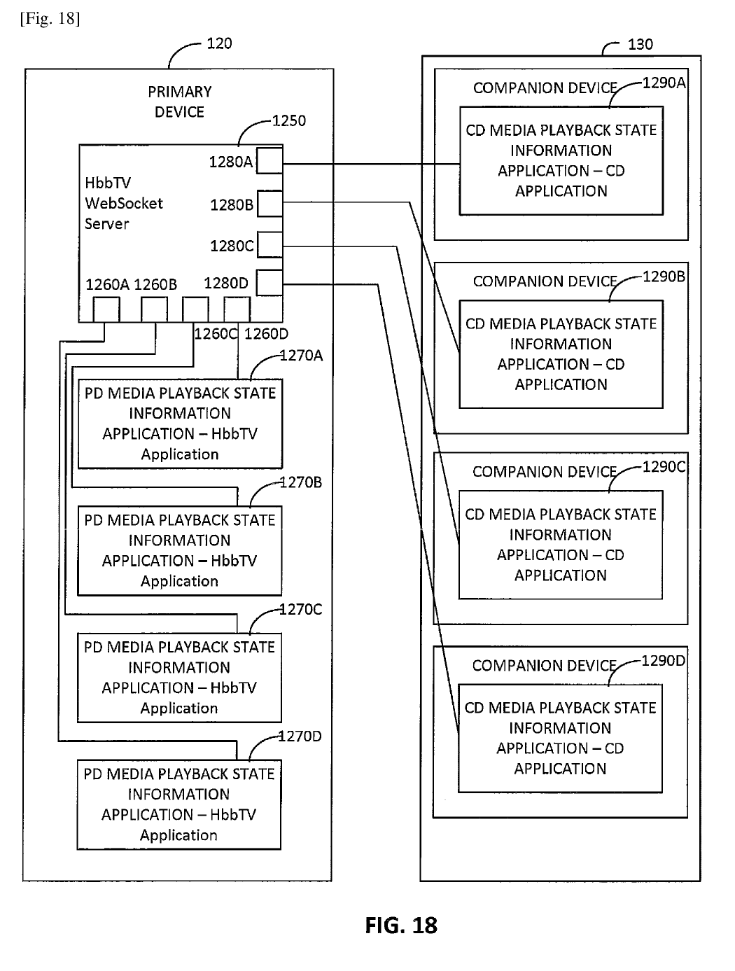

Referring to FIG. 18, another embodiment the primary device 120 includes a HbbTV WebSocket server 1250 together with a plurality of local service end-points 1260A-1260D. A plurality of PD media playback state information applications 1270A-1270D may be included within the same primary device 120 which communicate with the HbbTV WebSocket server 1250 through a respective local service end-points 1260A-1260D. Each of the respective PD media playback state information applications 1260A-1260D may be different instantiations of the same application or may be different applications suitable to communicate different media playback state information from the same and/or different sources. The HbbTV WebSocket server 1250 may include a plurality of remote service end-points 1280A-1280D. A companion device 130 may include a plurality of CD media playback state information application 1290A-1290D. In this manner, each of the PD media playback state information applications 1270A-1270D may communicate with a respective one or more of the CD media playback state information applications 1290A-1290D. In some cases, two or more PD media playback state information applications 1270A-1270D may communicate with the same CD media playback state information application 1290A-1290D. This provides flexibility in the configuration of the PD media playback state information application 1270A-1270D communicating with the CD media playback state information application 1290A-1290D.

In other embodiments, the HbbTV WebSocket server may be any other type of server that is capable of communicating with one or more primary device media playback state information applications. The communication between the server and the primary device media playback state information applications may likewise be provided using any suitable technique. The communication between the server and the companion device 130 and/or one or more companion device media playback state information applications may be provided using any suitable technique.

The primary device 120 or the companion device 130 may initiate the closure of the connection with the other by sending WebSocket protocol Close frame. WebSocket protocol is described in RFC 6455 http://www.ietf.org/rfc/rfc6455.tx and close frame is described in RFC 6455 WebSocket protocol, both of which are incorporated by reference. Alternatively, the primary device 120 or the companion device 130 may close the connection with the other without sending WebSocket protocol's Close frame. In this case HbbTV WebSocket server 1000 on the primary device may initiate the process of disconnection by sending WebSocket protocol's Close frame to the PD media playback state information application 1030 and/or the CD media playback state information application 1040 and/or companion device 130.

In some embodiments, it is desirable to include additional security in the communication between the primary device 120 and the companion device 130. To improve security, the primary device 120 and the companion device 130 may communicate using port 443 for WebSocket connections tunneled over transport layer security. For example, this may be achieved by using a wss-URI scheme for WebSocket URIs as defined in section 3 of IETF RFC 6455 (2011) incorporated by reference herein in its entirety. The HbbTV WebSocket server may use a client authentication mechanism available to a generic HTTP server. For example, this may be one or more of (1) cookies, (2) HTTP authentication, and/or (3) TLS authentication.

In one embodiment, the client authentication may be done for both the PD media playback state information application 1030 running on the primary device 120 and CD media playback state information application 1040 running on the companion device 130.

In one embodiment, a protocol may be defined for the primary device 120 and the companion device 130 media playback state information communication using Sec-WebSocket-Protocol header of WebSocket Protocol. In this case, the HbbTV mechanism may be modified by requiring that the terminal (e.g. PD and/or CD) support Sec-WebSocket-Protocol header as defined in clause 11.3.4 of WebSocket protocol RFC 6455, incorporated by reference herein it its entirety. In this case, an application protocol (or subprotocol) between the primary device 120 and the companion device 130 for media playback state information communication when using WebSocket may be indicated with a string. For example, the string ‘PDCDMPL” may be used for the subprotocol signaled via Sec-WebSocket-Protocol, such as Sec-WebSocket-Protocol: PDCDMPL. In this case, when the primary device 120 and the companion device 130 both include the same designated subprotocol then they can effectively communicate and exchange media playback state information.

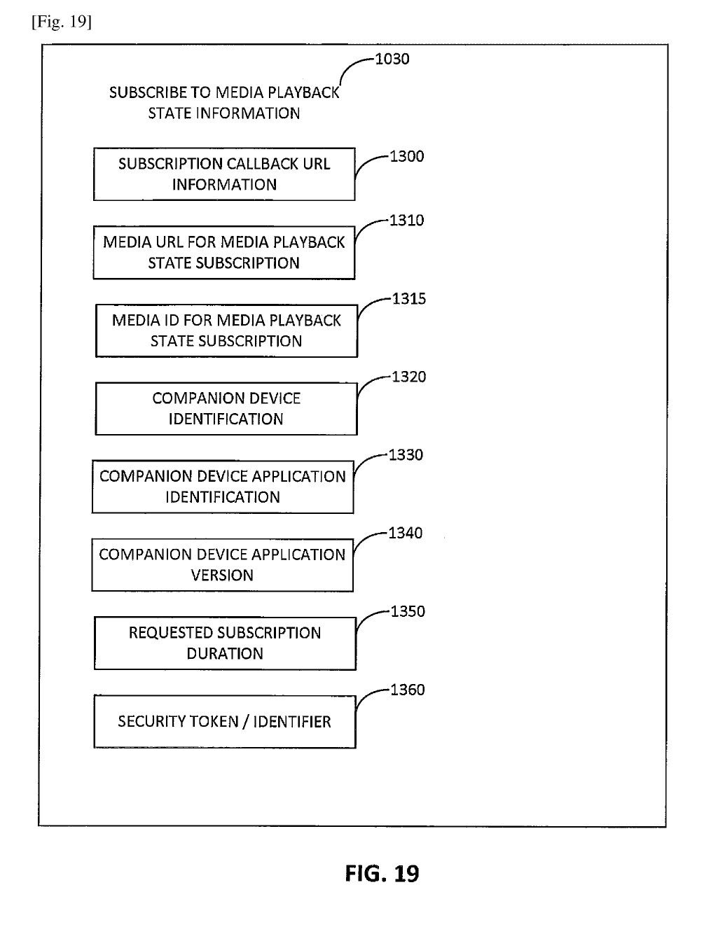

Referring to FIG. 19, the subscribe to media playback state information 1030 from the companion device 130 to the primary device 120 may make the request for subscription to media playback state information when the companion device 130 joins the network or when a media playback state information application is started on the companion device 130 or at any other time desired by the companion device. The input parameters may include subscription callback URL information 1300 that identifies how the primary device 120 can send a media playback state information to the companion device 130. The input parameters may include a Media URL for media playback state subscription 1310 that identifies media for which media playback state information subscription is requested by the companion device 130. The input parameters may include a Media ID for media playback state subscription 1315 that identifies media for which media playback state information subscription is requested by the companion device 130. The Media ID identifier 1315 may uniquely identify the media on primary device for which media playback state information subscription is requested. In some embodiments both Media URL 1310 and Media ID 1315 may be used. In another embodiment only one of them may be used. In yet another embodiment a combination of hem may be used. A special value may be used for Media URL 1310 to indicate requesting information about the current media being played back on primary device. For example value of “null” may indicate that the information about the media currently being played back on primary device is requested. A special value may be used for Media ID 1315 to indicate requesting information about the current media being played back on primary device. For example value of “CURRENT” may indicate that the information about the media currently being played back on primary device is requested. The input parameters may include companion device identification 1320 which identifies the companion device. For example, the companion device identification preferably uses a string identification (e.g., preferably a unique string identification). The input parameters may include companion device application identification 1330. For example, the companion device application identification identifies the particular application, among a plurality of such applications if present, on the companion device used for exchanging media playback state information. The input parameters may include companion device application version 1340. For example, the companion device application version more specifically identifies the attributes and/or capabilities of the particular application. The input parameters may include a requested subscription duration 1350. For example, the companion device may request the subscription to last for 3000 seconds, 4000 seconds, or another suitable duration. In this manner the duration for such media playback state information will not be indefinite and controllable, at least to the extent the requested duration is honored by the primary device, by the companion device. In some embodiment a special value may be assigned to indicate a request for “infinite” duration subscription. For example a value of “−1” as requested subscription duration may indicate desire to receive media playback state information forever/for infinite time/always. A security token/identifier 1360 may be included in input parameters. The security token may have been obtained by the companion device by some external means and may help to identify the companion device. For example it may establish authentication of security device as a trusted device. Additional or fewer input parameters may be used, as desired.

In one embodiment various elements that may be carried in subscription to media playback state information from companion device to primary device and their description may be as shown in the Table: “Elements of the subscription to media playback state information” below.

TABLE
Elements of the subscription media playback state information

| Element Name | Description |
|---|---|
| MediaURL | URL for the media for which media playback state |
| | information subscription is requested. A special value |
| | may be used for MediaURL to indicate requesting |
| | information about the current media being played back |
| | on PD. For example value of “null” may indicate that the |
| | information about the media currently being played back |
| | on PD is requested. |
| MediaID | Identifier for the media for which media playback state |
| | information subscription is requested. The identifier may |
| | uniquely identify the media on primary device for which |
| | media playback state information subscription is |
| | requested. |
| | A special value may be used for MediaID to indicate |
| | requesting information about the current media being |
| | played back on PD. For example value of “CURRENT” |
| | may indicate that the information about the media |
| | currently being played back on PD is requested. |
| MPSubscriptionCallbackURL | URL location to receive media playback state information |
| | message |
| MPSubscriptionDuration | Requested duration in number of milliseconds until the |
| | media playback state information subscription expires. A |
| | special value of −1 indicates “Infinite” duration. |
| CDDevID | Device identifier for the companion device. |
| CDAppID | Application identifier for companion device. |
| CDAppVersion | Version for companion device. |

In one embodiment, the subscription to media playback state information 650 may be achieved using a JavaScript Object Notation (JSON) to carry the subscription request from the companion device 130 to the primary device 120 to potentially receive media playback state information.

In one embodiment the JSON schema for the companion device subscribe to media playback state information 650 may be as follows:

{

“id”: “http://atsc.org/version/3.0/cd/mp_sub_req_cd2pd#”,
“$schema”: “http://json-schema.org/draft-04/schema#”,
“title”: “ATSC Media Playback State Subscription Request from CD to PD”,
“description”: “Media Playback State Subscription Request from CD to PD Schema

as defined in ATSC 3.0 (c) 2014 atsc.org - All rights reserved.”,

“type”: “object”,
“properties”: {
“required”: [“MplaybackSubscriptionRequestfromCDtoPD”],
“MplaybackSubscriptionRequestfromCDtoPD”: {

“type”: “object”,
“properties”: {

“MediaURL”: {

“type”: “string”,
“format”: “uri”

},
“MediaID”: {

“type”: “string”

},
“MPSubscriptionCallbackURL”: {

“type”: “string”,
“format”: “uri”

},
“MPSubscriptionDuration”: {

“type”: “number”

},
“CDInfo”: {

“type”: “object”,
“properties”: {

“CDDevID”: {

“type”: “string”

},
“CDAppID”: {

“type”: “string”

},
“CDAppVersion”:{

“type”: “number”

}

}

}

}
“required”:

[“MediaURL”,“MPSubscriptionCallbackURL”,“MPSubscriptionDuration”],

“additionalProperties”: false },
“maxProperties”: 1

}

}

An exemplary format for the above JSON payload may be as follows:

{

“MPlaybackSubscriptionRequestfromCDtoPD”: {
“MediaURL”: “http://192.168.0.200/PL01”,
“MediaID”: “http://192.168.0.200/PLID01”,

“MPSubscriptionCallbackURL”: “http://192.168.0.100/CD/CB01”,
“MPSubscriptionDuration”: 3600,

“CDInfo”: {

“CDDevID”: “CDDevId01”,
“CDAppID”: “ID01”,
“CDAppVersion”: 0.9

}

}

}

In another embodiment, a XML format may be used to carry the media playback state subscription request message from the companion device to the primary device to receive media playback state. The XML schema for the media playback state subscription request message from the companion device to primary device to receive media playback state information may be as follows:

<xs:schema xmlns:xs=“http://www.w3.org/2001/XMLSchema” >

<xs:element name=“MPlaybackSubscriptionRequestfromCDtoPD”

type=“MPlaybackSubscriptionRequestType” />

<xs:complexType name=“MPlaybackSubscriptionRequestType”>

<xs:all>

<xs:element name=“MediaURL” type=“xs:anyURI” minOccurs=“1”/>
<xs:element name=“MediaID” type=“xs:string” minOccurs=“0”

maxOccurs=“1”/>

<xs:element name=“MPSubscriptionCallbackURL” type=“xs:anyURI”

minOccurs=“1”/>

<xs:element name=“MPSubscriptionDuration” type=“xs:float”

minOccurs=“1”/>

<xs:element name=“CDInfo” type=“CDInfoType” minOccurs=“0”

minOccurs=“1”/>

</xs:all>

</xs:complexType>
<xs:complexType name=“CDInfoType”>

<xs:all>

<xs:element name=“CDDevID” type=“xs:string” minOccurs=“0”

maxOccurs=“1”/>

<xs:element name=“CDAppID” type=“xs:string” minOccurs=“0”

maxOccurs=“1”/>

<xs:element name=“CDAppVersion” type=“xs:float” minOccurs=“0”

maxOccurs=“1”/>

</xs:all>

</xs:complexType>

</xs:schema>

In one embodiment, a Representational State Transfer (REST) mechanism may be used for the companion device subscription request to the primary device to receive media playback state information.

In one embodiment, this may be done by sending a request to a defined end-point on the primary device from the companion device.

In one embodiment, a HTTP GET request may be sent from the companion device to the primary device as follows:

http://192.168.0.200/PD/MPL/mpsubReq_CD2PD?MPMediaURL=

http%3A%2F%2F192.168.0.100%2FPL01&MPSubscriptionCallbackURL=http%3A%2F%2F
192.168.0.100%2FCD%2FCB01&MPSubscriptionDuration=3600

which can also be represented as

GET /PD/MPL/mpsubReq_CD2PD?MPMediaURL=

http%3A%2F%2F192.168.0.100%2FPL01&MPSubscriptionCallbackURL=http%3A%2F%2F
192.168.0.100%2FCD%2FCB01&MPSubscriptionDuration=3600

host: http://192.168.0.200

In the aforementioned http://request 192.168.0.200 references the primary device by its Internet Protocol (IP) address, MPL references the end point, subReq_CD2PD references the type of sub-request, MPMediaURL=http%3A%2F%2F192.168.0.100%2FPL01 refers to the media URL for which media playback state information is requested, MPSubscription-CallbackURL=http%3A%2F%2F192.168.0.100%2FCD%2FCB01 references query parameters, and MPSubscriptionDuration=3600 references the subscription duration. Also 192.168.0.100 references companion device by its Internet Protocol (IP) address. Other request structures may be used, as desired.

In the aforementioned GET request, the PD references the primary device, MPL references the end point, subReq_CD2PD references the type of sub-request, MP-MediaURL=http%3A%2F%2F192.168.0.100%2FPL01 refers to the media URL for which media playback state information is requested, MPSubscription-CallbackURL=http%3A%2F%2F192.168.0.100%2FCD%2FCB01 references query parameters, MPSubscriptionDuration=3600 references the subscription duration, and HTTP/1.1 host: http://192.168.0.200 references the primary device by its Internet Protocol (IP) address.

As illustrated, the value of MPSubscriptionCallbackURL may be a url encoded when putting it in the HTTP GET query parameters.

In another embodiment, a HTTP POST request may be sent from the companion device to the primary device as follows:

POST /PD/MPL/mpsubReq_CD2PD HTTP/1.1
host: http://192.168.0.200
content-type:application/x-www-form-urlencoded;charset=utf-8
content-length: <content length of request>
MPMediaURL=http%3A%2F%2F192.168.0.100%2FPL01&
MPSubscriptionCallbackURL=
http%3A%2F%2F192.168.0.100%2FCD%2FCB01&
MPSubscriptionDuration=3600

The MPMediaURL, MPSubscriptionCallbackURL, and MPSubscription duration may be url encoded when putting it in the HTTP POST query parameters.

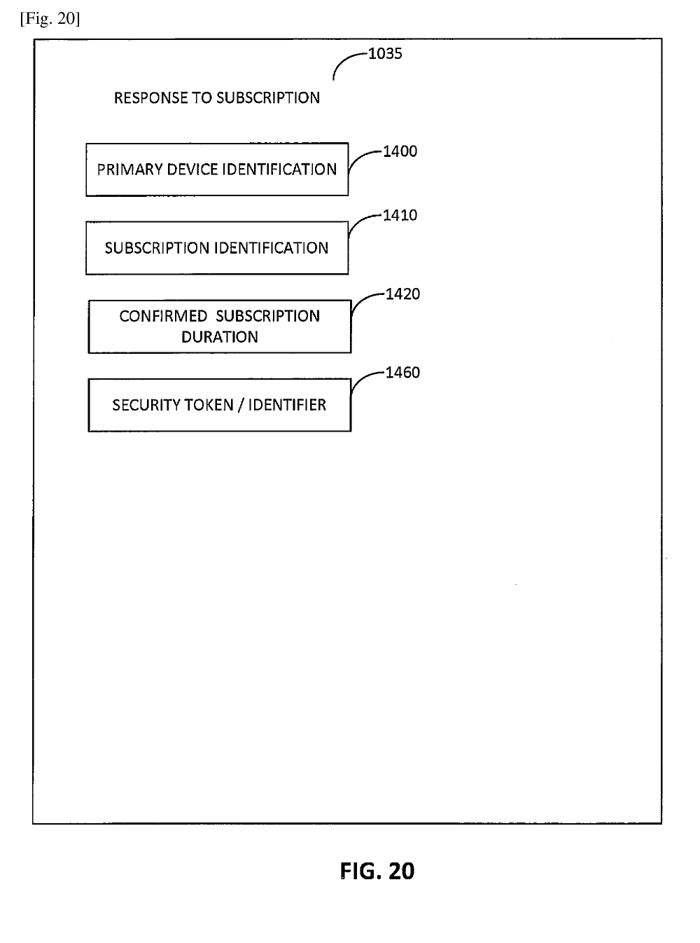

Referring to FIG. 20, the response to subscription 1035 from the primary device 120 to the companion device 130 is preferably sent upon receiving the subscription information. The response may be based upon the subscription callback URL information 1300 to provide the message. In addition, the response may be based upon the particular companion device information 1320, the companion device application identification 1330, the companion device application version 1340, security token/identifier 1360, and/or requested subscription duration 1350. The output parameters may include a primary device identification 1400 which identifies the primary device. For example, the primary device identification preferably uses a string identification. In this manner, the companion device may distinguish between a plurality of different primary devices to which it is, or may be, connected to. In some cases the primary device ID may include a user friendly name such as “John's Television”. In some case this friendly name may be a separate parameter “Primary device name” different than the primary device identification 1400. The output parameters may include a subscription identification 1410 which identifies a particular subscription to services between the particular primary device and the particular companion device. For example, the subscription identification may be a unique identification to that particular session so that subsequent messages and communications may be tailored for the particular companion device. Moreover, the subscription identification 1410 may be used to distinguish among a plurality of PD media playback state information applications and/or among a plurality of CD media playback state information applications. The subscription identification 1410 may be used to uniquely identify this subscription from companion device to the primary device for subsequent message exchanges between those two devices. The output parameters may include a confirmed subscription duration 1420 (e.g., MP Subscription Timeout Duration) indicating the duration of the subscription. For example, the subscription duration may confirm the duration requested in the subscribe to media playback state information 1030 e.g. in parameter requested subscription duration 1350. For example, the subscription duration may confirm a different duration to that requested in the subscribe to media playback state information 1030. The different duration 1420 may be smaller than or equal to the requested duration 1350. For example, the subscription duration may confirm a duration of 0 seconds, which indicates that the requested subscription is unavailable to the particular companion device, to that requested in the subscribe to media playback state information 1030. In this manner, the subscription will have a limited time duration and thus not be indefinite in duration which provides an improved user experience. A security token/identifier 1460 may be included in output parameters. For example it may establish authentication of security device as a trusted device. The security token 1460 may be same as security token 1360. In other embodiments the security token 1460 may be different than the security token 1360.

In one embodiment various elements that may be carried in response to subscription request from primary device to companion device and their description may be as shown in the Table: “Response to subscription request” below.

TABLE
Response to subscription request

| Element Name | Description |
|---|---|
| MediaURL | URL for the media for which media playback state |
| | information subscription response is sent. A |
| | special value may be used for MediaURL to |
| | indicate requesting information about the current |
| | media being played back on PD. For example |
| | value of “null” may indicate that the information |
| | about the media currently being played back on |
| | PD is requested. |
| MediaID | Identifier for the media for which media playback |
| | state information subscription response is sent. |
| | The identifier may uniquely identify the media on |
| | primary device for which media playback state |
| | information subscription response is sent and |
| | associate it with the subscription ID sent |
| | (MPSubscriptionID element). |
| | A special value may be used for MediaID to |
| | indicate requesting information about the current |
| | media being played back on PD. For example |
| | value of “CURRENT” may indicate that the |
| | information about the media currently being |
| | played back on PD is requested. |
| MPSubscriptionID | The subscription identifier for this media playback |
| | state information subscription. MPSubscriptionID |
| | may be used to uniquely identify this subscription |
| | from companion device to the primary device. |
| MPSubscriptionTimeoutDuration | Actual duration in number of milliseconds until the |
| | media playback state information subscription |
| | expires. A special value of −1 indicates “Infinite” |
| | duration. |
| PDDevID | Device identifier for the primary device. |
| PDVersion | Version for primary device. |

In one embodiment, JavaScript Object Notation (JSON) may be used to carry the subscription response for media playback state information subscription from the primary device to the companion device. For example, the JSON schema for the primary device subscription response to companion device may be as follows:

```
        {
            “id”:
            “http://atsc.org/version/3.0/cd/mp_sub_resp_pd2cd#”,
            “$schema”: “http://json-schema.org/draft-04/schema#”,
            “title”: “ATSC Media Playback State Subscription
            Response from PD to CD”,
            “description”: “Media Playback State Subscription
Response from PD to CD Schema as defined in ATSC 3.0 (c) 2014
atsc.org - All rights reserved.”,
            “type”: “object”,
            “properties”: {
            “required”:
            [“MPlaybackSubscriptionResponsefromPDtoCD”],
            “MPlaybackSubscriptionResponsefromPDtoCD”: {
              “type”: “object”,
              “properties”: {
                “MPSubscriptionID”: {
                  “type”: “string”
                },
                “MPSubscriptionTimeoutDuration”: {
                  “type”: “number”
                },
                “PDInfo”: {
                  “type”: “object”,
                  “properties”: {
                    “PDDevID”: {
                      “type”: “string”
                    },
                    “PDVersion”:{
                      “type”: “number”
                    }
                  }
                }
              },
              “required”: [“MPSubscriptionID”,
              “MPSubscriptionTimeoutDuration”],
              “additionalProperties”: false },
              “maxProperties”: 1
          }
        }
```

In one embodiment, the format of this JSON payload may be as follows:

```
{
  “MPlaybackSubscriptionResponsefromPDtoCD”: {
            “MPSubscriptionID”: “MPL08754”,
            “MPSubscriptionTimeoutDuration”: 3600,
    “PDInfo”: {
            “PDDevID”: “PDDevId01”,
                            “PDVersion”: 1.0
          }
  }
}
```

In one embodiment, the XML format may be used to carry the media playback state information subscription response from the primary device to the companion device. For example, the XML schema for the primary device media playback state information subscription response to the companion device may be as follows:

```
      <xs:schema xmlns:xs=“http://www.w3.org/2001/XMLSchema” >
        <xs:element name=“MPlaybackSubscriptionResponsefromCDtoPD”
type=“MPlaybackSubscriptionResponseType” />
        <xs:complexType name=“MPlaybackSubscriptionResponseType”>
          <xs:all>
            <xs:element name=“MPSubscriptionID” type=“xs:anyURI” minOccurs=“1”/>
            <xs:element name=“MPSubscriptionTimeoutDuration” type=“xs:float”
minOccurs=“1”/>
            <xs:element name=“PDInfo” type=“PDInfoType” min0ccurs=“0”
maxOccurs=“1”/>
          </xs:all>
        </xs:complexType>
        <xs:complexType name=“PDInfoType”>
          <xs:all>
            <xs:element name=“PDDevID” type=“xs:string” minOccurs=“0”
maxOccurs=“1”/>
            <xs:element name=“PDAppID” type=“xs:string” minOccurs=“0”
maxOccurs=“1”/>
            <xs:element name=“PDVersion” type=“xs:float” minOccurs=“0”
maxOccurs=“1”/>
          </xs:all>
        </xs:complexType>
      </xs:schema>
```

In one embodiment, the Representational State Transfer (REST) mechanism may be used for the primary device media playback state information subscription response to the companion device. This may be done in response to HTTP GET or HTTP POST REST request from the companion device to the primary device for media playback state information subscription.

In one embodiment, this may be done by sending a HTTP response to the companion device. For example, a HTTP response may be sent from the primary device to the companion device as follows:

```
HTTP/1.1 200 OK
content-type:application/json
content-length: <content length of response>
{
          “MPSubscriptionID”: “MPL08754”,
          “MPSubscriptionTimeoutDuration”: 3600,
    “PDInfo”: {
          “PDDevID”: “PDDevId01”,
                        “PDVersion”: 1.0
        }
}
```

In this example, the HTTP response body may include JSON data which conforms to the JSON schema. In another embodiment instead of JSON, JSONP data (JSON with padding) may be used. In another case the HTTP response body may send the same data in another format such as XML or CSV, BNF, or ABNF, or ENBF etc. For example, if XML format is used in the HTTP response body then the content may conform to the XML schema for the response.

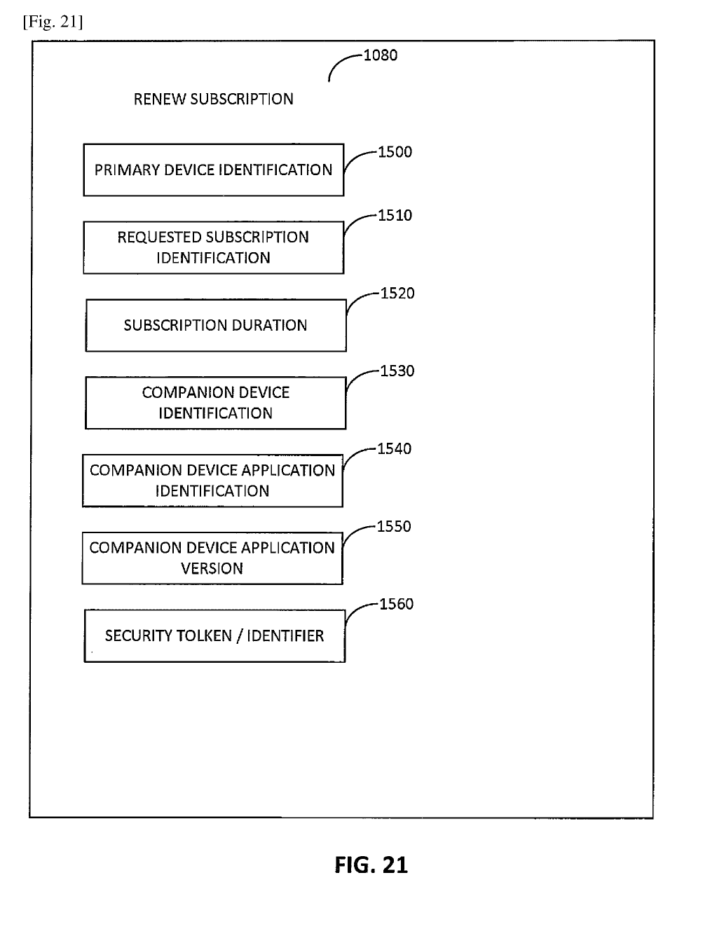

Referring to FIG. 21, the renew subscription 1080 from the companion device 130 to the primary device 120 is preferably sent any time at or before the current subscription times out to renew the current subscription or otherwise after the current subscription times out to renew the previous subscription. In some cases, the renew subscription 1080 from the companion device 130 to the primary device 120 is sent out for a particular subscription among a plurality of current subscriptions for the companion device, such that some of the current subscriptions of the companion device 130 may be permitted to be terminated while renewing one or more other subscriptions. In this manner, only a selected set of subscriptions are renewed while other subscriptions are not renewed, thus alleviating the need to expressly cancel the other subscriptions. In some cases, the renew subscription 1080 from the companion device 130 to the primary device 120 may be for all subscriptions of a plurality of current subscriptions of the companion device. In this manner, all of the current subscriptions may be effectively renewed with a reduced amount of data communications and without the need to expressly identify all the current subscriptions.

The renew subscription 1080 may be based upon the primary device identification 1500 which identifies the primary device. For example, the primary device identification preferably uses a string identification. In this manner, the companion device may distinguish between a plurality of different primary devices to which it is, or may be, connected to. The input parameters may include the subscription identification 1510 which identifies a particular subscription to services between the particular primary device and the particular companion device. For example, the subscription identification may be a unique identification to that particular session so that subsequent messages and communications may be tailored for the particular companion device. Moreover, the subscription identification 1510 may be used to distinguish among a plurality of PD media playback state information applications and/or among a plurality of CD media playback state information applications. In the case that the subscription identification 1510 for the renew subscription 680 is received by the primary device 120 prior to the termination of the current subscription, the existing subscription may be extended. In the case that the subscription identification 1510 for the renew subscription 680 is received by the primary device 120 after the termination of the current subscription, the primary device 120 may use its past history to determine the characteristics of the previous subscription, and provide a new subscription based upon the previous subscription. In some cases the subscription identification 1510 may be the same as subscription identification 1410. The input parameters may include a requested subscription duration 1520 indicating the duration of the renew subscription. For example, the companion device may request the renew subscription to last for 3000 seconds, 4000 seconds, or another suitable duration. In this manner the duration for such media playback state information will not be indefinite and controllable, at least to the extent the requested duration is honored by the primary device, by the companion device. The input parameters may include companion device identification 1530 which identifies the companion device. For example, the companion device identification preferably uses a string identification. The input parameters may include companion device application identification 1540. For example, the companion device application identification identifies the application, and among a plurality of such applications if present, on the companion device used for exchanging media playback state information. The input parameters may include companion device application version 1550. For example, the companion device application version identifies the attributes and/or capabilities of the particular application. In some embodiments, no callback information is necessary, since this information is already available to the primary device because it may be linked with the subscription information. A security token/identifier 1560 may be included in input parameters. The security token may have been obtained by the companion device by some external means and may help to identify the companion device. For example it may establish authentication of security device as a trusted device. The security token 1560 may be same as security token 1360. In other embodiments the security token 1560 may be different than the security token 1360.

In one embodiment various elements that may be carried in renew subscription from companion device to primary device and their description may be as shown in the Table: “Elements of the renew subscription” below.

TABLE
Elements of the renew subscription

| Element Name | Description |
|---|---|
| MPSubscriptionID | The subscription identifier for this media |
| | playback state information subscription. |
| | MPSubscriptionID may be used to uniquely |
| | identify this subscription from companion |
| | device to the primary device. |
| MPSubscriptionDuration | Requested duration in number of milliseconds |
| | until the media playback state information |
| | subscription expires. A special value of −1 |
| | indicates “Infinite” duration. |
| CDDevID | Device identifier for companion device. |
| CDAppID | Application identifier of the companion device. |
| CDAppVersion | Version of the companion device. |

Additionally one or more of the elements MediaURL, MediaID, MPSubscription-CallbackURL with semantics/description may be carried in the subscription renewal request from the companion device to the primary device to continue to receive media playback state information.

In one embodiment JavaScript Object Notation (JSON) may be used to carry the subscription renewal request message from the companion device to the primary device to continue receiving media playback state information. The JSON schema for the companion device subscription renew request to the primary device to continue and renew receiving media playback state information is defined as follows:

```
        {
            “id”: “http://atsc.org/version/3.0/cd/
            mp_sub_renew_req_cd2pd#”,
            “$schema”: “http://json-schema.org/draft-04/schema#”,
            “title”: “ATSC Media Playback State Subscription Renew
            Request from CD to PD”,
            “description”: “Media Playback State Subscription Renew
Request from CD to PD Schema as defined in ATSC 3.0 (c)
2014 atsc.org - All rights reserved.”,
            “type”: “object”,
            “properties”: {
            “required”:
            [“MPlaybackSubscriptionRenewRequestfromCDtoPD”],
            “MPlaybackSubscriptionRenewRequestfromCDtoPD”: {
              “type”: “object”,
              “properties”: {
                “MPSubscriptionID”: {
                  “type”: “string”
                },
                “MPSubscriptionDuration”: {
                  “type”: “number”
                },
                “CDInfo”: {
                  “type”: “object”,
                  “properties”: {
                    “CDDevID”: {
                      “type”: “string”
                    },
                    “CDAppID”: {
                      “type”: “string”
                    },
                    “CDAppVersion”:{
                      “type”: “number”
                    }
                  }
                }
              },
              “required”: [“MPSubscriptionID”,
              “MPSubscriptionDuration”],
              “additionalProperties”: false },
              “maxProperties”: 1
          }
        }
```

In one embodiment, the format of this JSON payload may be as follows:

```
{
  “MPlaybackSubscriptionRenewRequestfromCDtoPD”: {
          “MPSubscriptionID”: “MPL08754”,
          “MPSubscriptionDuration”: 7200,
    “CDInfo”: {
          “CDDevID”: “CDDevId01”,
                “CDAppID”: “ID01”,
                                    “CDAppVersion”: 0.9
        }
  }
}
```

In one embodiment, the XML format may be used to carry the subscription renewal request message from the companion device to the primary device to continue receiving media playback state information. The XML schema for the companion device subscription renew request to the primary device to continue to receive media playback state information may be as follows:

```
      <xs:schema xmlns:xs=“http://www.w3.org/2001/XMLSchema” >
        <xs:element name=“MPlaybackSubscriptionRenewRequestfronnCDtoPD”
type=“MPlaybackSubscriptionRenewRequestType” />
        <xs:connplexType name=“MPlaybackSubscriptionRenewRequestType”>
          <xs:all>
            <xs:element name=“MPSubscriptionID” type=“xs:string” nninOccurs=“1”/>
            <xs:element name=“MPSubscriptionDuration” type=“xs:float”
minOccurs=“1”/>
            <xs:element name=“CDInfo” type=“CDInfoType” minOccurs=“0”
maxOccurs=“1”/>
          </xs:all>
        </xs:complexType>
        <xs:complexType name=“CDInfoType”>
          <xs:all>
            <xs:element name=“CDDevID” type=“xs:string” minOccurs=“0”
maxOccurs=“1”/>
            <xs:element name=“CDAppID” type=“xs:string” minOccurs=“0”
maxOccurs=“1”/>
            <xs:element name=“CDAppVersion” type=“xs:float” minOccurs=“0”
maxOccurs=“1”/>
          </xs:all>
        </xs:complexType>
      </xs:schema>
```

In another embodiment, the JSON schema for the companion device subscription renew request to the primary device to continue to receive media playback state information may be defined as follows:

```
      {
          “id”: “http://atsc.org/version/3.0/cd/mp_sub_renew_req_cd2pd#”,
          “$schema”: “http://json-schema.org/draft-04/schema#”,
          “title”: “ATSC Media Playback State Subscription Renew Request from CD to
PD”,
          “description”: “Media Playback State Subscription Renew Request from CD to
PD Schema as defined in ATSC 3.0 (c) 2014 atsc.org - All rights reserved.”,
          “type”: “object”,
          “properties”: {
          “required”: [“MPlaybackSubscriptionRenewRequestfromCDtoPDVariant”],
          “MPlaybackSubscriptionRenewRequestfromCDtoPDVariant”: {
            “type”: “object”,
            “properties”: {
              “MPSubscriptionID”: {
                “type”: “string”
              },
              “MPSubscriptionCallbackURL”: {
                “type”: “string”,
                “format”: “uri”
              },
              “MediaURL”: {
                “type”: “string”,
                “format”: “uri”
              },
              “MediaID”: {
                “type”: “string”
              },
              “MPSubscriptionDuration”: {
                “type”: “number”
              },
              “CDInfo”: {
                “type”: “object”,
                “properties”: {
                  “CDDevID”: {
                    “type”: “string”
                  },
                  “CDAppID”: {
                    “type”: “string”
                  },
                  “CDAppVersion”:{
                    “type”: “number”
                  }
                }
              }
            },
            “required”: [“MPSubscriptionID”,“MPSubscriptionDuration”],
            “additionalProperties”: false },
            “maxProperties”: 1
        }
      }
```

In another embodiment, the format of this renewal request JSON payload may be as follows:

```
{
  “MPlaybackSubscriptionRenewRequestfromCDtoPDVariant”: {
          “MPSubscriptionID”: “MPL08754”,
    “MediaURL”: “http://192.168.0.200/PL01”,
    “MediaID”: “http://192.168.0.200/PLID01”,
          “MPSubscriptionCallbackURL”:
          “http://192.168.0.100/CD/CB01”,
          “MPSubscriptionDuration”: 7200,
    “CDInfo”: {
          “CDDevID”: “CDDevId01”,
                “CDAppID”: “ID01”,
                                    “CDAppVersion”: 0.9
        }
  }
}
```

In another embodiment, the XML schema for the companion device subscription renew request to the primary device to continue to receive media playback state information may be defined as follows:

```
      <xs:schema xmlns:xs=“http://www.w3.org/2001/XMLSchema” >
        <xs:element name=“MPlaybackSubscriptionRenewRequestfromCDtoPD”
type=“MPlaybackSubscriptionRenewRequestType” />
        <xs:complexType name=“MPlaybackSubscriptionRenewRequestType”>
          <xs:all>
            <xs:element name=“MPSubscriptionID” type=“xs:string” minOccurs=“1”/>
            <xs:element name=“MPSubscriptionCallbackURL” type=“xs:anyURI”
minOccurs=“1”/>
            <xs:element name=“MediaURL” type=“xs:anyURI” minOccurs=“1”/>
            <xs:element name=“MediaID” type=“xs:string” minOccurs=“0”
maxOccurs=“1”/>
            <xs:element name=“MPSubscriptionDuration” type=“xs:float”
minOccurs=“1”/>
            <xs:element name=“CDInfo” type=“CDInfoType” minOccurs=“0”
maxOccurs=“1”/>
          </xs:all>
        </xs:complexType>
        <xs:complexType name=“CDInfoType”>
          <xs:all>
            <xs:element name=“CDDevID” type=“xs:string” minOccurs=“0”
maxOccurs=“1”/>
            <xs:element name=“CDAppID” type=“xs:string” minOccurs=“0”
maxOccurs=“1”/>
            <xs:element name=“CDAppVersion” type=“xs:float” minOccurs=“0”
maxOccurs=“1”/>
          </xs:all>
        </xs:complexType>
      </xs:schema>
```

In one embodiment, the Representational State Transfer (REST) mechanism may be used for the companion device subscription renew request for media playback state information to the primary device to continue to receive media playback state information.

In one embodiment, this may be done by sending a request to a defined end-point on the primary device from the companion device.

In one embodiment, a HTTP GET request may be sent from the companion device to the primary device as follows:

http://192.168.0.200/PD/MPL/mpsub_renew_req_CD2PD?
MPSubscriptionID=MPL08754&MPSubscriptionDuration=7200

which can also be represented as

```
        GET
/PD/MPL/mpsub_renew_req_CD2PD?MPSubscriptionID=MPL08754&
MPSubscriptionDuration=7200
        HTTP/1.1
        host: http://192.168.0.200
```

In another embodiment, a HTTP POST request may be sent from the companion device to the primary device as follows:

POST /PD/MPL/mpsub_renew_req_CD2PD HTTP/1.1
host: http://192.168.0.200
content-type:application/x-www-form-urlencoded;charset=utf-8
content-length: <content length of request>
MPSubscriptionID=MPL08754&MPSubscriptionDuration=7200

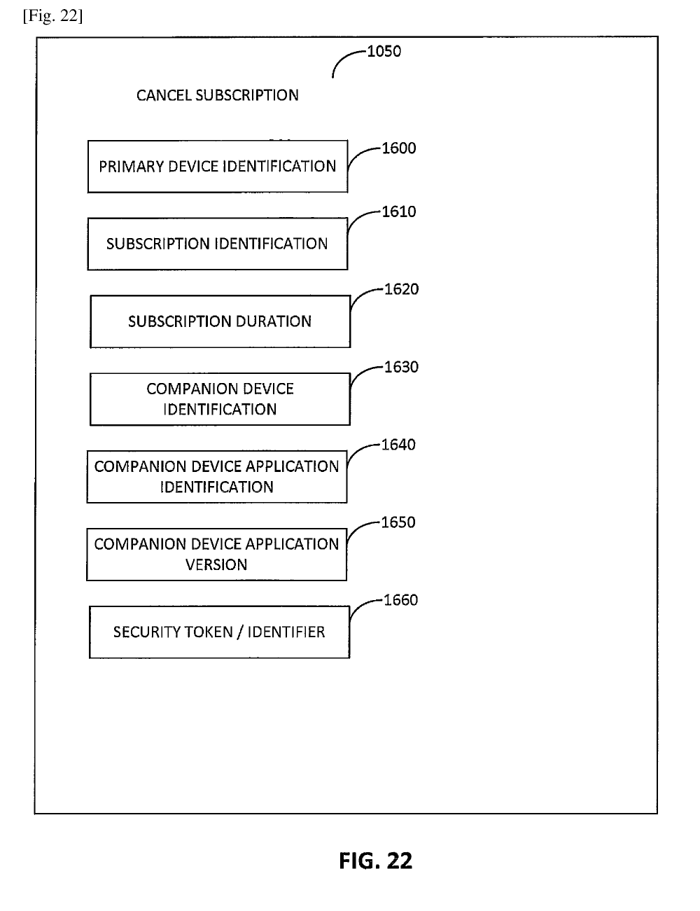

Referring to FIG. 22, the cancel media playback state information subscription request 1050 from the companion device 130 to the primary device 120 is preferably sent any time before the current subscription times out to renew the current subscription or otherwise after the current subscription times out to renew the previous subscription to confirm the subscription is canceled or at any time in general. In some cases, the cancel media playback state information subscription request 1050 from the companion device 130 to the primary device 120 is sent out for a particular subscription among a plurality of current subscriptions for the companion device, such that some of the current subscriptions of the companion device 130 may be permitted to be terminated while maintaining one or more other subscriptions. In this manner, only a selected set of subscriptions are maintained while other subscriptions are canceled, thus alleviating the need to expressly maintain the other subscriptions. This is preferable to alternatively canceling all the subscriptions and then subscribing to the desirable subscriptions, thereby effecting the canceling of the undesired subscription(s). In some cases, the cancel media playback state information subscription request 1050 from the companion device 130 to the primary device 120 may be for all subscriptions of a plurality of current subscriptions of the companion device. In this manner, all of the current subscriptions may be effectively canceled with a reduced amount of data communications and without the need to expressly identify all the current subscriptions.

The cancel media playback state information subscription request 1050 may be based upon the primary device identification 1600 which identifies the primary device. For example, the primary device identification preferably uses a string identification. In this manner, the companion device may distinguish between a plurality of different primary devices to which it is, or may be, connected to. The input parameters may include the subscription identification 1610 which identifies a particular subscription to services between the particular primary device and the particular companion device. For example, the subscription identification may be a unique identification to that particular session so that subsequent messages and communications may be tailored for the particular companion device, such as not sending additional media playback state information. Moreover, the subscription identification 1610 may be used to distinguish among a plurality of PD media playback state information applications and/or among a plurality of CD media playback state information applications. In the case that the subscription identification 1610 for the media playback state information 1050 is received by the primary device 120 prior to the termination of the current subscription, the existing subscription may be terminated. In the case that the subscription identification 1610 for the cancel media playback state information 1050 is received by the primary device 120 after the termination of the current subscription, the primary device 120 may use its past history to ensure that the subscription is terminated. The input parameters may include a subscription duration 1620 indicating the duration of the canceled subscription for purposes of confirmation, if desired. The input parameters may include companion device identification 1630 which identifies the companion device. For example, the companion device identification preferably uses a string identification. The input parameters may include companion device application identification 1640. For example, the companion device application identification identifies the application, and among a plurality of such applications if present, on the companion device used for exchanging media playback state information. The input parameters may include companion device application version 1650. For example, the companion device application version identifies the attributes and/or capabilities of the particular application. In some embodiments, no callback information is necessary, since this information is already available to the primary device because it may be liked with the subscription information. A security token/identifier 1660 may be included in input parameters. The security token may have been obtained by the companion device by some external means and may help to identify the companion device. For example it may establish authentication of security device as a trusted device. The security token 1660 may be same as security token 1360. In other embodiments the security token 1660 may be different than the security token 1360.

In one embodiment various elements that may be carried in cancel media playback state information from companion device to primary device and their description may be as shown in the Table: “Elements of cancel media playback state information subscription” below.

TABLE
Elements of cancel media playback state information subscription

| Element Name | Description |
|---|---|
| MPSubscriptionID | The subscription identifier for this media playback |
| | state information subscription. MPSubscriptionID |
| | may be used to uniquely identify this subscription |
| | from companion device to the primary device. |
| CDDevID | Device identifier for companion device. |
| CDAppID | Application identifier of the companion device. |
| CDAppVersion | Version of the companion device. |

Additionally one or more of the elements MediaURL, MediaID, MPSubscription-Duration, MPSubscriptionCallbackURL with semantics/description may be carried in the subscription renewal request from the companion device to the primary device to continue to receive media playback state information.

In one embodiment, JavaScript Object Notation (JSON) may be used to carry the subscription cancel request message from the companion device to the primary device to discontinue receiving media playback state information. The JSON schema for the companion device subscription cancel request to the primary device to discontinue to receive media playback state information may be defined as follows:

```
      {
          “id”: “http://atsc.org/version/3.0/cd/
          mp_sub_cancel_req_cd2pd#”,
          “$schema”: “http://json-schema.org/draft-04/schema#”,
          “title”: “ATSC Media Playback Subscription Cancel
          Request from CD to PD”,
          “description”: “Media Playback Subscription Cancel
Request from CD to PD Schema as defined in ATSC 3.0 (c)
2014 atsc.org - All rights reserved.”,
          “type”: “object”,
          “properties”: {
          “required”:
          [“MPlaybackSubscriptionCancelRequestfromCDtoPD”],
          “MPlaybackSubscriptionRenewRequestfromCDtoPD”: {
            “type”: “object”,
            “properties”: {
              “MPSubscriptionID”: {
                “type”: “string”
              },
              “CDInfo”: {
                “type”: “object”,
                “properties”: {
                  “CDDevID”: {
                    “type”: “string”
                  },
                  “CDAppID”: {
                    “type”: “string”
                  },
                  “CDAppVersion”:{
                    “type”: “number”
                  }
                }
              }
            },
            “required”: [“MPSubscriptionID”],
            “additionalProperties”: false },
            “maxProperties”: 1
        }
      }
```

In one embodiment, the format of this JSON payload may be as shown below:

```
{
  “MPlaybackSubscriptionCancelRequestfromCDtoPD”: {
          “MPSubscriptionID”: “MPL08754”,
    “CDInfo”: {
          “CDDevID”: “CDDevId01”,
                “CDAppID”: “ID01”,
                                    “CDAppVersion”: 0.9
        }
  }
}
```

In one embodiment, the XML format may be used to carry the subscription cancel request message from the companion device to the primary device to discontinue receiving media playback state information. The XML schema for the companion device subscription cancel request to the primary device to discontinue to receive media playback state information is defined as follows:

```
    <xs:schema xmlns:xs=“http://www.w3.org/2001/XMLSchema” >
      <xs:element name=“MPlaybackSubscriptionCancelRequestfromCDtoPD”
type=“MPlaybackSubscriptionCancelRequestType” />
      <xs:complexType name=“MPlaybackSubscriptionCancelRequestType”>
        <xs:all>
          <xs:element name=“MPSubscriptionID” type=“xs:string” minOccurs=“1”/>
          <xs:element name=“CDInfo” type=“CDInfoType” minOccurs=“0”
maxOccurs=“1”/>
        </xs:all>
      </xs:complexType>
      <xs:complexType name=“CDInfoType”>
        <xs:all>
          <xs:element name=“CDDevID” type=“xs:string” minOccurs=“0”
maxOccurs=“1”/>
          <xs:element name=“CDAppID” type=“xs:string” minOccurs=“0”
maxOccurs=“1”/>
          <xs:element name=“CDAppVersion” type=“xs:float” minOccurs=“0”
maxOccurs=“1”/>
        </xs:all>
      </xs:complexType>
    </xs:schema>
```

In another embodiment, the JSON schema for the companion device subscription cancel request to the primary device to discontinue to receive media playback state information may be defined as follows:

```
    {
        “id”: “http://atsc.org/version/3.0/cd/
        mp_sub_cancel_req_cd2pd#”,
        “$schema”: “http://json-schema.org/draft-04/schema#”,
        “title”: “ATSC Media Playback State Subscription Cancel
Request from CD to PD”,
        “description”: “Media Playback State Subscription Cancel
Request from CD to PD Schema as defined in ATSC 3.0 (c) 2014
atsc.org - All rights reserved.”,
        “type”: “object”,
        “properties”: {
        “required”:
        [“MPlaybackSubscriptionCancelRequestfromCDtoPD”],
        “MPlaybackSubscriptionRenewRequestfromCDtoPD”: {
          “type”: “object”,
          “properties”: {
            “MPSubscriptionID”: {
              “type”: “string”
            },
            “MPSubscriptionDuration”: {
              “type”: “number”
            },
            “CDInfo”: {
              “type”: “object”,
              “properties”: {
                “CDDevID”: {
                  “type”: “string”
                },
                “CDAppID”: {
                  “type”: “string”
                },
                “CDAppVersion”:{
                  “type”: “number”
                }
              }
            }
          },
          “required”: [“MPSubscriptionID”,“MPSubscriptionDuration”],
          “additionalProperties”: false },
          “maxProperties”: 1
      }
    }
```

In another embodiment, the format of this cancel request JSON payload may be as follows:

```
{
  “MPlaybackSubscriptionCancelRequestfromCDtoPDVariant”: {
            “MPSubscriptionID”: “MPL08754”,
            “MPSubscriptionDuration”: 0,
    “CDInfo”: {
            “CDDevID”: “CDDevId01”,
                “CDAppID”: “ID01”,
                                    “CDAppVersion”: 0.9
          }
  }
}
```

In another embodiment, the XML schema for the companion device subscription cancel request to the primary device to discontinue to receive media playback state information may be as follows:

```
    <xs:schema xmlns:xs=“http://www.w3.org/2001/XMLSchema” >
      <xs:element name=“MPlaybackSubscriptionCancelRequestfromCDtoPD”
type=“MPlaybackSubscriptionCancelRequestType” />
      <xs:complexType name=“MPlaybackSubscriptionCancelRequestType”>
        <xs:all>
          <xs:element name=“MPSubscriptionID” type=“xs:string” minOccurs=“1”/>
    <xs:element name=“MPSubscriptionDuration” type=“xs:float” minOccurs=“1”/>
          <xs:element name=“CDInfo” type=“CDInfoType” minOccurs=“0”
maxOccurs=“1”/>
        </xs:all>
      </xs:complexType>
      <xs:complexType name=“CDInfoType”>
        <xs:all>
          <xs:element name=“CDDevID” type=“xs:string” minOccurs=“0”
maxOccurs=“1”/>
          <xs:element name=“CDAppID” type=“xs:string” minOccurs=“0”
maxOccurs=“1”/>
          <xs:element name=“CDAppVersion” type=“xs:float” minOccurs=“0”
maxOccurs=“1”/>
        </xs:all>
      </xs:complexType>
    </xs:schema>
```

In yet another embodiment, the JSON schema for the companion device subscription cancel request to the primary device to discontinue to receive media playback state information may be defined as follows:

```
    {
        “id”: “http://atsc.org/version/3.0/cd/
        mp_sub_cancel_req_cd2pd#”,
        “$schema”: “http://json-schema.org/draft-04/schema#”,
        “title”: “ATSC Media Playback Subscription Cancel
        Request from CD to PD”,
        “description”: “Media Playback Subscription Cancel
Request from CD to PD Schema as defined in ATSC 3.0 (c) 2014
atsc.org - All rights reserved.”,
        “type”: “object”,
        “properties”: {
        “required”:
        [“MPlaybackSubscriptionCancelRequestfromCDtoPD”],
        “MPlaybackSubscriptionRenewRequestfromCDtoPD”: {
          “type”: “object”,
          “properties”: {
            “MPSubscriptionID”: {
              “type”: “string”
            }
            }
          },
          “required”: [“MPSubscriptionID”],
          “additionalProperties”: false },
          “maxProperties”: 1
      }
    }
```

In another embodiment, the format of this cancel request JSON payload may be as follows:

```
{
  “MPlaybackSubscriptionCancelRequestfromCDtoPD”: {
            “MPSubscriptionID”: “MPL08754”
  }
}
```

In another embodiment, the XML schema for the companion device subscription cancel request to the primary device to discontinue to receive media playback state information may be defined as follows:

```
    <xs:schema xmlns:xs=“http://www.w3.org/2001/XMLSchema” >
      <xs:element name=
“MPlaybackSubscriptionCancelRequestfromCDtoPD”
type=“MPlaybackSubscriptionCancelRequestType” />
      <xs:complexType name=
      “MPlaybackSubscriptionCancelRequestType”>
        <xs:all>
          <xs:element name=“MPSubscriptionID” type=“xs:string”
          minOccurs=“1”/>
    </xs:all>
      </xs:complexType>
    </xs:schema>
```

In one embodiment, the Representational State Transfer (REST) mechanism may be used for the companion device subscription cancel request to the primary device to discontinue to receive media playback state information. In one embodiment this may be done by sending a request to a defined end-point on the primary device from the companion device.

In one embodiment a HTTP GET request may be sent from the companion device to the primary device as follows:

http://192.168.0.200/PD/MPL/
mpsub_cancel_req_CD2PD?MPSubscriptionID=MPL08754

which can also be represented as

GET /PD/MPL/mpsub_renew_req_CD2PD?MPSubscriptionID=
MPL08754 HTTP/1.1
host: http://192.168.0.200

In another embodiment, a HTTP POST request may be sent from the companion device to the primary device as follows:

POST /PD/MPL/mpsub_cancel_req_CD2PD HTTP/1.1
host: http://192.168.0.200
content-type:application/x-www-form-urlencoded;charset=utf-8
content-length: <content length of request>
MPSubscriptionID=MPL08754

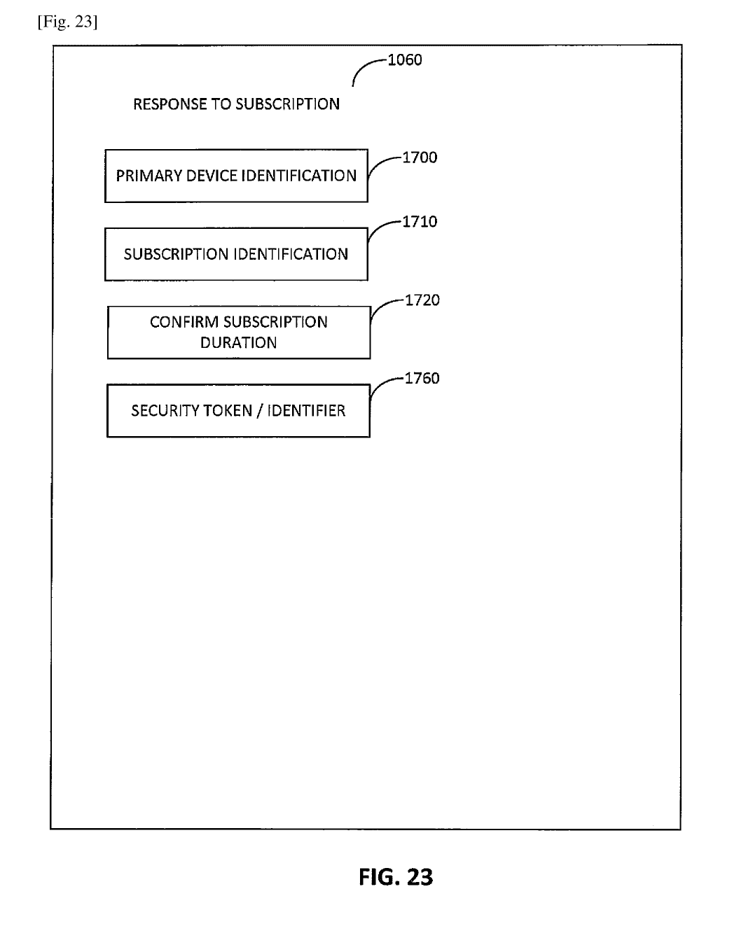

Referring to FIG. 23, the response to subscription 1060 from the companion device 130 to the primary device 120 is preferably sent in response to a request from the companion device 130 and/or companion device media playback state information application(s). In this manner, the confirmation may be directed to a particular companion device 130 and/or one or more particular media playback state information applications on the companion device. In some cases, the response to subscription 1060 from the companion device 130 to the primary device 120 may be for all subscriptions of a plurality of current subscriptions of the companion device. In this manner, all of the current subscriptions may be effectively confirmed with a reduced amount of data communications and without the need to expressly identify all the current subscriptions. The response to subscription 1060 may be sent from primary device to companion device in response to receiving subscription renewal request 680 from companion device. The response to subscription 1060 may be sent from primary device to companion device in response to receiving subscription cancel request 1050 from companion device.

The response to subscription 1060 may be based upon the primary device identification 1700 which identifies the primary device. For example, the primary device identification preferably uses a string identification. In this manner, the companion device may distinguish between a plurality of different primary devices to which it is, or may be, connected to. The output parameters may include the subscription identification 1710 which identifies a particular subscription to services between the particular primary device and the particular companion device. For example, the subscription identification may be a unique identification to that particular session so that subsequent messages and communications may be tailored for the particular companion device. Moreover, the subscription identification 1710 may be used to distinguish among a plurality of PD media playback state information applications and/or among a plurality of CD media playback state information applications. In the case that the subscription identification 1710 for the response to subscription 1050 is sent by the primary device 120 so that the renew subscription 1080 and/or cancel media playback state information subscription 1050 may be confirmed. The output parameters may include a confirm subscription duration 1720 indicating the duration of the subscription for purposes of confirmation, if desired. The confirm subscription duration 1720 may be the same as the requested duration or may be different from the requested duration. A security token/identifier 1760 may be included in output parameters. For example it may establish authentication of security device as a trusted device. The security token 1760 may be same as security token 1560 or 1660. In other embodiments the security token 1760 may be different than the security token 1560 or 1660.

In one embodiment various elements that may be carried in response to renew subscription request from primary device to companion device and their description may be as shown in the Table: “Elements of the response to renew subscription” below.

TABLE
Elements of the response to renew subscription

| Element Name | Description |
|---|---|
| MPSubscriptionID | The subscription identifier for this |
| | media playback state information |
| | subscription. MPSubscriptionID may |
| | be used to uniquely identify this |
| | subscription from companion |
| | device to the primary device. |
| MPSubscriptionTimeoutDuration | Actual duration in number of |
| | milliseconds (or seconds) until the |
| | subscription expires. A special value |
| | of −1 indicates “Infinite” duration. |
| PDDevID | Device identifier for primary device. |
| PDVersion | Version of the primary device. |

Additionally one or more of the elements MediaURL, MediaID, MPSubscriptionDuration, MPSubscriptionCallbackURL with semantics/description may be carried in the media playback state information subscription renewal response from the primary device to the companion device.

In one embodiment, JavaScript Object Notation (JSON) will be used to carry the response to subscription renewal request for media playback state information from the primary device to the companion device. The JSON schema for the primary device subscription renew response to the companion device may be defined as follows:

```
    {
        “id”: “http://atsc.org/version/3.0/cd/
        mp_sub_renew_resp_pd2cd#”,
        “$schema”: “http://json-schema.org/draft-04/schema#”,
        “title”: “ATSC Media Playback State Subscription Renew
Response from PD to CD”,
        “description”: “Media Playback State Subscription Renew
Response from PD to CD Schema as defined in ATSC 3.0 (c) 2014
atsc.org - All rights reserved.”,
        “type”: “object”,
        “properties”: {
        “required”:
        [“MPlaybackSubscriptionRenewResponsefromPDtoCD”],
        “MPlaybackSubscriptionRenewResPonsefromPDtoCD”: {
          “type”: “object”,
          “properties”: {
            “MPSubscriptionID”: {
              “type”: “string”
            },
            “MPSubscriptionTimeoutDuration”: {
              “type”: “number”
            },
            “PDInfo”: {
              “type”: “object”,
              “properties”: {
                “PDDevID”: {
                  “type”: “string”
                },
                “PDVersion”:{
                  “type”: “number”
                }
              }
            }
          },
          “required”: [“MPSubscriptionID”,
          “MPSubscriptionTimeoutDuration”],
          “additionalProperties”: false },
          “maxProperties”: 1
      }
    }
```

In one embodiment, the format of this JSON payload may be as follows:

```
{
  “MPlaybackSubscriptionRenewResponsefromPDtoCD”: {
            “MPSubscriptionID”: “MPL08754”,
            “MPSubscriptionTimeoutDuration”: 7200,
    “PDInfo”: {
            “PDDevID”: “PDDevId01”,
                                    “PDVersion”: 1.0
          }
  }
}
```

In one embodiment, the XML format may be used to carry the response to subscription renewal request for media playback state information from the primary device to the companion device. The XML schema for the primary device subscription renew response to the companion device may be defined as follows:

```
    <xs:schema xmlns:xs=“http://www.w3.org/2001/XMLSchema” >
      <xs:element name=“MPlaybackSubscriptionRenewResponsefromCDtoPD”
type=“MPlaybackSubscriptionRenewResponseType” />
      <xs:complexType name=“MPlaybackSubscriptionRenewResponseType”>
        <xs:all>
          <xs:element name=“MPSubscriptionID” type=“xs:anyURI” minOccurs=“1”/>
          <xs:element name=“MPSubscriptionTimeoutDuration” type=“xs:float”
minOccurs=“1”/>
          <xs:element name=“PDInfo” type=“PDInfoType” minOccurs=“0”
maxOccurs=“1”/>
        </xs:all>
      </xs:complexType>
      <xs:complexType name=“PDInfoType”>
        <xs:all>
          <xs:element name=“PDDevID” type=“xs:string” minOccurs=“0”
maxOccurs=“1”/>
          <xs:element name=“PDVersion” type=“xs:float” minOccurs=“0”
maxOccurs=“1”/>
        </xs:all>
      </xs:complexType>
    </xs:schema>
```

In one embodiment, the Representational State Transfer (REST) mechanism may be used for media playback state information subscription renewal response from the primary device to the companion device. This may be done in response to HTTP GET or HTTP POST REST subscription for media playback state information renewal request from the companion device to the primary device as described previously.

In one embodiment, this may be done by sending a HTTP response to the companion device.

In another embodiment, a HTTP response may be sent from the primary device to the companion device as follows:

```
HTTP/1.1 200 OK
content-type:application/json
content-length: <content length of response>
{
          “MPSubscriptionID”: “MPL08754”,
          “MPSubscriptionTimeoutDuration”: 7200,
    “PDInfo”: {
          “PDDevID”: “PDDevId01”,
                        “PDVersion”: 1.0
        }
}
```

In this case, the HTTP response body includes JSON data which may conform to the JSON schema defined previously. In another case instead of JSON, JSONP data (JSON with padding) may be used. In another case the HTTP response body may send the same data in another format such as XML or CSV, BNF, or ABNF, or ENBF etc. For example if XML format is used in HTTP response body then the content may conform to the XML schema for the response defined above.

In one embodiment various elements that may be carried in response to cancel subscription request from primary device to companion device and their description may be as shown in the Table: “Elements of the response to cancel subscription” below.

TABLE
Elements of the response to cancel subscription

| Element Name | Description |
|---|---|
| MPCancelStatusCode | A success/failure indication status code indicating |
| | the status of cancel subscription request. |
| MPCancelStatusString | A success/failure indication status string |
| | indicating the status of cancel subscription |
| | request. |
| PDDevID | Device identifier for primary device. |
| PDVersion | Version of the primary device. |

Additionally one or more of the elements MediaURL, MediaID, MPSubscriptionID, MPSubscriptionTimeoutDuration, MPSubscriptionDuration, MPSubscriptionCallbackURL with semantics/description as described previously may be carried in the media playback state information subscription cancel response from PD to CD.

In one embodiment, JavaScript Object Notation (JSON) may be used to carry the media playback state information subscription cancel response from the primary device to the companion device.

In one embodiment, the JSON schema for the primary device subscription cancel response to the companion device may be defined as follows:

```
    {
      “id”:
      “http://atsc.org/version/3.0/cd/mp_sub_cancel_resp_pd2cd#”,
          “$schema”: “http://json-schema.org/draft-04/schema#”,
          “title”: “ATSC Media Playback State Subscription Cancel
Response from PD to CD”,
          “description”: “Media Playback State Subscription Cancel
Response from PD to CD Schema as defined in ATSC 3.0 (c) 2014
atsc.org - All rights reserved.”,
          “type”: “object”,
          “properties”: {
          “required”:
          [“MPlaybackSubscriptionCancelResponsefromPDtoCD”],
          “MPlaybackSubscriptionCancelResponsefromPDtoCD”: {
            “type”: “object”,
            “properties”: {
              “MPCancelStatusCode”: {
                “type”: “number”
              },
              “MPCancelStatusString”: {
                “type”: “string”
              },
              “PDInfo”: {
                “type”: “object”,
                “properties”: {
                  “PDDevID”: {
                    “type”: “string”
                  },
                  “PDVersion”:{
                    “type”: “number”
                  }
                }
              }
            },
            “required”: [“MPCancelStatusCode”,
            “MPCancelStatusString”],
            “additionalProperties”: false },
            “maxProperties”: 1
      }
    }
```

In one embodiment, the format of this JSON payload may be as follows:

```
{
  “MPlaybackSubscriptionCancelResponsefromPDtoCD”: {
              “MPCancelStatusCode”: 200,
              “MPCancelStatusString”: “OK”,
    “PDInfo”: {
              “PDDevID”: “PDDevId01”,
                                      “PDVersion”: 1.0
              }
  }
}
```

In one embodiment, the XML format may be used to carry the response to media playback state information subscription cancel response from the primary device to the companion device. The XML schema for the primary device subscription cancel response to the companion device may be as follows:

```
      <xs:schema xmlns:xs=“http://www.w3.org/2001/XMLSchema” >
        <xs:element name=
        “MPlaybackSubscriptionCancelResponsefromCDtoPD”
type=“MPlaybackSubscriptionCancelResponseType” />
        <xs:complexType
        name=“MPlaybackSubscriptionCancelResponseType”>
          <xs:all>
            <xs:element name=“MPCancelStatusCode” type=
            “xs:int” minOccurs=“1”/>
            <xs:element name=“MPCancelStatusString”
type=“xs:string” minOccurs=“1”/>
            <xs:element name=“PDInfo” type=“PDInfoType”
minOccurs=“0” maxOccurs=“1”/>
          </xs:all>
        </xs:complexType>
        <xs:complexType name=“PDInfoType”>
          <xs:all>
            <xs:element name=“PDDevID” type=“xs:string”
minOccurs=“0” maxOccurs=“1”/>
            <xs:element name=“PDVersion” type=“xs:float”
minOccurs=“0” maxOccurs=“1”/>
          </xs:all>
        </xs:complexType>
      </xs:schema>
```

In another embodiment, the JSON schema for the primary device subscription cancel response to companion device may be as follows:

```
      {
          “id”: “http://atsc.org/version/3.0/cd/
          mp_sub_cancel_resp_pd2cd#”,
          “$schema”: “http://json-schema.org/draft-04/schema#”,
          “title”: “ATSC Media Playback State Subscription Cancel
Response from PD to CD”,
          “description”: “Media Playback State Subscription Cancel
Response from PD to CD Schema as defined in ATSC 3.0 (c) 2014
atsc.org - All rights reserved.”,
            “type”: “object”,
            “properties”: {
            “required”:
            [“MPlaybackSubscriptionCancelResponsefromPDtoCD”],
            “MPlaybackSubscriptionCancelResponsefromPDtoCD”: {
              “type”: “object”,
              “properties”: {
                “MPCancelStatusCode”: {
                  “type”: “number”
                },
                “MPCancelStatusString”: {
                  “type”: “string”
                }
                }
            },
            “required”: [“MPCancelStatusCode”,
            “MPCancelStatusString”],
            “additionalProperties”: false },
            “maxProperties”: 1
        }
      }
```

In another embodiment, the format of this cancel response JSON payload may be as follows:

```
{
  “MPlaybackSubscriptionCancelResponsefromPDtoCD”: {
              “MPCancelStatusCode”: 200,
              “MPCancelStatusString”: “OK”
  }
}
```

In another embodiment, the XML schema for the primary device subscription cancel response to companion device may be defined as follows:

```
      <xs:schema xmlns:xs=“http://www.w3.org/2001/XMLSchema” >
        <xs:element name=
        “MPlaybackSubscriptionCancelResponsefromCDtoPD”
type=“MPlaybackSubscriptionCancelResponseType” />
        <xs:complexType
        name=“MPlaybackSubscriptionCancelResponseType”>
          <xs:all>
            <xs:element name=“MPCancelStatusCode”
            type=“xs:int” minOccurs=“1”/>
            <xs:element name=“MPCancelStatusString”
type=“xs:string” minOccurs=“1”/>
          </xs:all>
        </xs:complexType>
      </xs:schema>
```

In one embodiment, the Representational State Transfer (REST) mechanism may be used for the primary device media playback state information subscription cancel response to the companion device. This may be done in response to HTTP GET or HTTP POST REST media playback state information subscription cancel request from the companion device to the primary device as described previously.

In one embodiment, this may be done by sending a HTTP response to the companion device.

In another embodiment, a HTTP response may be sent from the primary device to the companion device as follows:
HTTP/1.1 200 OK

In this case, in another embodiment the HTTP response body may include some data. For example the response may be sent as follows:

```
HTTP/1.1 200 OK
content-type:application/json
content-length: <content length of response>
{
    “PDInfo”: {
            “PDDevID”: “PDDevId01”,
                          “PDVersion”: 1.0
          }
}
```

In this case the HTTP response body includes JSON data which may conform to the JSON schema defined previously. In another embodiment instead of JSON, JSONP data (JSON with padding) may be used. In another case the HTTP response body may send the same data in another format such as XML or CSV, BNF, or ABNF, or ENBF etc. For example if XML format is used in HTTP response body then the content may conform to the XML schema for the response defined above.

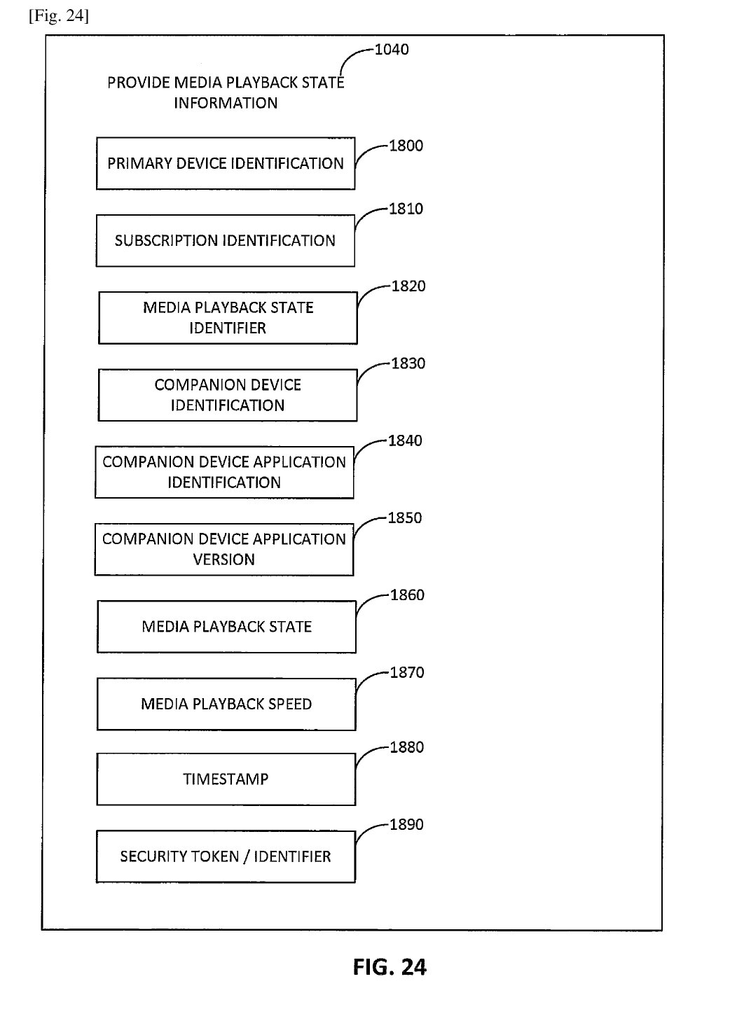

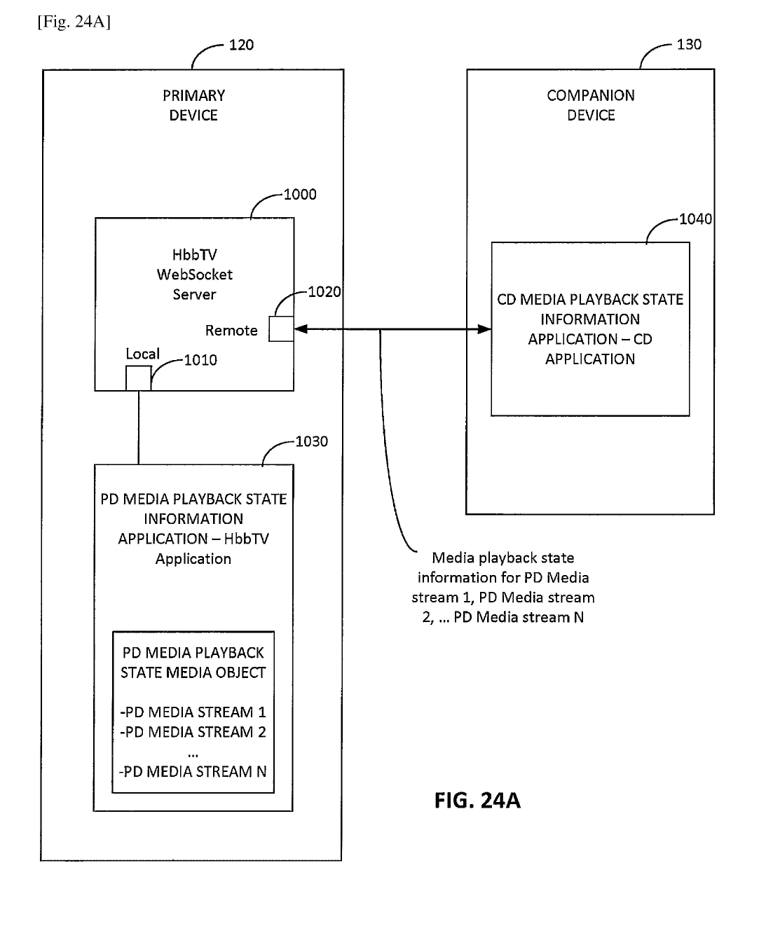

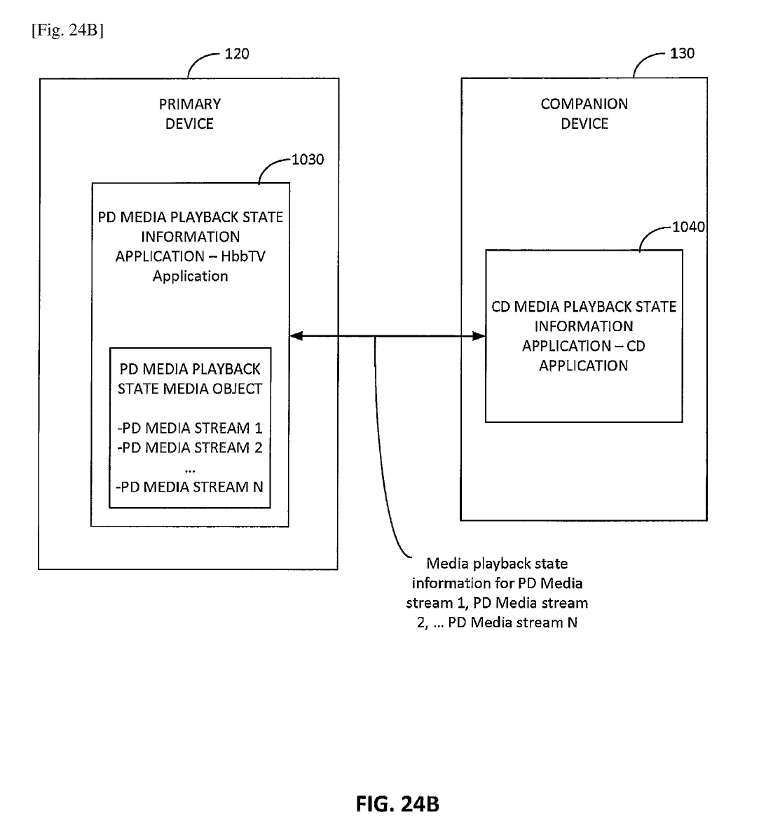

Referring to FIG. 24, the provide media playback state information 1040 from the primary device 120 to the companion device 130 is preferably sent in response to when media playback state information needs to be communicated from primary device 120 to companion device 130. In this manner, the media playback state information may be directed to a particular companion device 130 and/or one or more particular media playback state information applications on the companion device. In some cases, the media playback state information 1040 from the primary device 120 to the companion device 130 may be for all subscriptions of a plurality of current subscriptions of the companion device. In this manner, all of the current subscriptions may be effectively confirmed with a reduced amount of data communications and without the need to expressly identify all the current subscriptions. Referring to FIG. 24A in some case the media playback state information 1040 may be for more than one media stream on the primary device. For example the primary device may have two television tuners and the primary device may be showing a picture in picture for two “channels”/media streams. In this case the media playback state information communicated from PD to CD may correspond to those two channels/media streams. FIG. 24A shows media playback state information communicated from PD to CD for PD Media Stream1, PD Media Stream2, PD Media Stream N. Referring to FIG. 24B in some case the media playback state information 1040 may be for more than one media stream on the primary device. For example the primary device may have two television tuners and the primary device may be showing a picture in picture for two “channels”/media streams. In this case the media playback state information communicated from PD to CD may correspond to those multiple media streams. FIG. 24B shows media playback state information communicated from PD to CD for PD Media Stream1, PD Media Stream2, PD Media Stream N.

The media playback state information 1040 may be based upon the primary device identification 1800 which identifies the primary device. In addition, the primary device version and/or application may be identified, if desired. For example, the primary device identification preferably uses a string identification. In this manner, the companion device may distinguish between a plurality of different primary devices to which it is, or may be, connected to. The media playback state information parameters may include the subscription identification 1810 which identifies a particular subscription to services between the particular primary device and the particular companion device. For example, the subscription identification may be a unique identification to that particular session so that the media playback state information may be tailored for the particular companion device. Moreover, the subscription identification 1810 may be used to distinguish among a plurality of PD media playback state information applications and/or among a plurality of CD media playback state information applications. The input parameters may include media playback state identifier 1820 indicating an identifier for the current media playback state for the media RUL/media identification associated with the media playback state information subscription. In some cases, all or part of the media playback state information 1820 may include textual content, other content, and/or control codes. The control codes may be used to indicate particular standard messages that are known by the companion device and thus do not need to be expressly provided. The input parameters may include companion device identification 1830 which identifies the companion device. For example, the companion device identification preferably uses a string identification. The input parameters may include companion device application identification 1840. For example, the companion device application identification identifies the application, and among a plurality of such applications if present, on the companion device used for exchanging media playback state information messages. The input parameters may include companion device application version 1850. For example, the companion device application version identifies the attributes and/or capabilities of the particular application. In some embodiments the message parameters 1830, 1840 and 1850 related to companion device preferably may not be present in the provided media playback state information 1040. The input parameters may include media playback state 1860 of the media playback state identifier 1820 which indicates the current media playback state for the media URL/media identification associated with the media playback state information subscription. The media playback state 1860 may indicate, for example, playing, paused, stopped, fast forward, fast backward, buffering, unknown, reserved state. For example, playing may indicate that the media is being played at a normal forward speed, and may be indicated by a code such as 01 used for the media playback state identifier 1820. For example, paused may indicate that the media is currently being paused, and may be indicated by a code such as 02 used for the media playback state identifier 1820. For example, stopped may indicate that the media is not currently being played, and may be indicated by a code such as 03 used for the media playback state identifier 1820. For example, fast forward may indicate that the media is being played at a forward speed faster than the normal speed, and may be indicated by a code such as 04 used for the media playback state identifier 1820. For example, fast backward may indicate that the media is being played at a backward speed faster than the normal speed, and may be indicated by a code such as 05 used for the media playback state identifier 1820. For example, buffering may indicate that the media is being buffered or otherwise awaiting to return to its on-going presentation manner when the buffering completes, and may be indicated by a code such as 06 used for the media playback state identifier 1820. For example, unknown may indicate another state, and may be indicated by a code such as 07 used for the media playback state identifier 1820. For example, reserved may indicate a future code, and may be indicated by a code such as 08 used for the media playback state identifier 1820.

The input parameters may include media playback speed 1870 which indicates the current speed of the media state relative to the normal speed for the media URL/media identification associated with the media playback state information subscription. In some cases the media playback speed 1870 is only applicable when the media playback state is fast forward or fast backward or playing. When the media playback state is fast forward or fast backward the media playback speed 1870 indicates the speed at which the media timeline is moving forward or backward relative to the normal speed. When the media playback state is playing, the media playback speed 1870 indicates the speed at which media playback is progressing relative to normal speed. A Timestamp 1880 may be included in the message to identify the timeline location for the media stream corresponding to the media URL/media identification for which the playback status is indicated. A security token/identifier 1890 may be included in output parameters. For example it may establish authentication of security device as a trusted device. The security token 1890 may be same as security token 1560 or 1660. In other embodiments the security token 1890 may be different than the security token 1560 or 1660.

In one embodiment various elements that may be carried in media playback state information from primary device to companion device and their description may be as shown in the Table: “Elements of the media playback state information” below.

TABLE
Elements of the media playback state information

| Element Name | Description |
|---|---|
| MPSubscriptionID | The subscription identifier for this media playback state information |
| | subscription. MPSubscriptionID may be used to uniquely identify |
| | this subscription from companion device to the primary device. |
| MPStateID | Identifier for the current media playback state for the media URL/ |
| | media ID associated with the media playback state information |
| | subscription (identified by the MPSubscriptionID element). |
| MPState | Current media playback state for the media URL/media ID |
| | associated with the media playback state information subscription |
| | (identified by the MPSubscriptionID element). The state can be |
| | one of the following: |
| | “PLAYING”, |
| | “PAUSED”, |
| | “STOPPED”, |
| | “FFORWARD”, |
| | “FBACKWARD”, |
| | “BUFERRING”, |
| | “UNKNOWN”, |
| | “RESERVED” |
| MPSpeed | Current speed of the media state relative to normal speed for the |
| | media URL/media ID associated with the media playback state |
| | information subscription (identified by the MPSubscriptionID |
| | element). The value is applicable only when the MPState is |
| | “FFORWARD” or “FBACKWARD” or “PLAYING”. |
| | When MPState is “FFORWARD” or “FBACKWARD” the MPSpeed |
| | indicates the speed at which media timeline is moving forward or |
| | backward relative to normal speed. |
| | When MPState is “PLAYING” the MPSpeed indicates the speed at |
| | which media playback is progressing relative to normal speed. |
| Timestamp | Timeline location in milliseconds for media stream corresponding |
| | to media URL/media ID for which this playback status is indicated. |
| | The start of the media stream is assumed to have timeline location |
| | of with Timestamp value of 0. |
| PDDevID | Device identifier for the primary device. |
| PDVersion | Version for primary device. |

In one embodiment JavaScript Object Notation (JSON) may be used to carry the media playback state information notification from the primary device to the companion device. The JSON schema for the primary device notification of media playback state information message to the companion device may be as follows:

```
        {
          “id”: “http://atsc.org/version/3.0/cd/mpstate_req_pd2cd#”,
          “$schema”: “http://json-schema.org/draft-04/schema#”,
          “title”: “ATSC Media Playback State Notification from PD to
          CD”,
          “description”: “Media Playback State Notification from PD to
CD Schema as defined in ATSC 3.0 (c) 2014 atsc.org - All rights
reserved.”,
          “type”: “object”,
          “properties”: {
          “required”:
          [“MediaPlaybackStateMessageNotificationfromPDtoCD”],
          “MediaPlaybackStateMessageNotificationfromPDtoCD”: {
            “type”: “object”,
            “properties”: {
              “MPSubscriptionID”: {
                “type”: “string”
              },
              “MPStateID”: {
                “type”: “string”
              },
              “MPState”: {
                “type”: “string”
              },
              “MPSpeed”: {
                “type”: “number”
                },
              “Timestamp”: {
                “type”: “number”,
              },
              “PDInfo”: {
                “type”: “object”,
                “properties”: {
                  “PDDevID”: {
                    “type”: “string”
                  },
                  “PDVersion”:{
                    “type”: “number”
                  }
                }
              }
            },
            “required”: [“MPSubscriptionID”, “MPState”,
            “Timestamp”],
            “additionalProperties”: false },
            “maxProperties”: 1
        }
      }
```

In one embodiment, the format of this JSON payload may be as follows:

```
{
  “MediaPlaybackStateMessageNotificationfromPDtoCD”: {
            “MPSubscriptionID”: “MPL08754”,
    “MPStateID”: “01”,
“MPState”: “PLAYING”,
    “MPSpeed”: 1,
“Timestamp”: 100
  }
}
```

The Timestamp may conform to the semantics as defined in RFC 3339 “Date and Time on the Internet: Timestamps” as defined in http://http://tools.ietf.org/html/rfc3339 which is incorporated here by reference in its entirety.

In one embodiment, the XML format may be used to carry the media playback state information notification from the primary device to the companion device.

In one embodiment, the XML schema for the primary device notification of media playback state information message to the companion device may be defined as follows:

```
      <xs:schema xmlns:xs=“http://www.w3.org/2001/XMLSchema” >
        <xs:element
        name=“MediaPlaybackStateNotificationfromPDtoCD”
type=“MediaPlaybackStateMessageType” />
        <xs:complexType name=“MediaPlaybackStateMessageType”>
          <xs:all>
            <xs:element name=“MPSubscriptionID”
            type=“xs:string” minOccurs=“1”/>
            <xs:element name=“MPStateID”
            type=“xs:string” minOccurs=“1”/>
            <xs:element name=“MPState”
            type=“xs:string” minOccurs=“1”/>
            <xs:element name=“MPSpeed”
            type=“xs:string” minOccurs=“1”/>
            <xs:element name=“Timestamp”
            type=“xs:float” minOccurs=“1”/>
            <xs:element name=“PDInfo”
type=“PDInfoType” minOccurs=“0” maxOccurs=“1”/>
          </xs:all>
        </xs:complexType>
        <xs:complexType name=“PDInfoType”>
          <xs:all>
            <xs:element name=“PDDevID” type=“xs:string”
minOccurs=“0” maxOccurs=“1”/>
            <xs:element name=“PDVersion” type=“xs:float”
minOccurs=“0” maxOccurs=“1”/>
          </xs:all>
        </xs:complexType>
      </xs:schema>
```

In one embodiment, JavaScript Object Notation (JSON) may be used to carry the media playback state information notification message from the primary device to the companion device.

In one embodiment, the JSON schema for the primary device notification of media playback state information to the companion device is defined as follows:

```
      {
          “id”: “http://atsc.org/version/3.0/cd/mpstate_notify_pd2cd#”,
          “$schema”: “http://json-schema.org/draft-04/schema#”,
          “title”: “ATSC Media Playback State Notification from PD to
          CD”,
          “description”: “Media Playback State Notification from PD
to CD Schema as defined in ATSC 3.0 (c) 2014 atsc.org - All rights
reserved.”,
          “type”: “object”,
          “properties”: {
          “required”:
          [“MediaPlaybackStateMessageNotificationfromPDtoCD”],
          “MediaPlaybackStateMessageNotificationfromPDtoCD”: {
            “type”: “object”,
            “properties”: {
              “MPSubscriptionID”: {
                “type”: “string”
              },
                “MPStateID”: {
                “type”: “string”
              },
              “MPState”: {
              “enum”: [
              “PLAYING”,
              “PAUSED”,
              “STOPPED”,
              “FFORWARD”,
              “FBACKWARD”,
              “BUFERRING”,
              “UNKNOWN”,
              “RESERVED”
              ] },
              “MPSpeed”: {
                “type”: “number”
                },
              “PDInfo”: {
                “type”: “object”,
                “properties”: {
                  “PDDevID”: {
                    “type”: “string”
                  },
                  “PDVersion”:{
                    “type”: “number”
                  }
                }
              }
            },
            “required”: [“MPSubscriptionID”,“MPState”],
            “additionalProperties”: false },
            “maxProperties”: 1
        }
      }
```

In one embodiment, the format of this JSON payload may be as shown below:

```
{
  “MediaPlaybackStateMessageNotificationfromPDtoCD”: {
            “MPSubscriptionID”: “MPL08754”,
    “MPStateID”: “01”,
            “MPState”: “PLAYING”,
    “MPSpeed”: 1
}
}
```

In one embodiment, the XML format may be used to carry the notification of media playback state information from the primary device to the companion device. The XML schema for the primary device notification of media playback state information to the companion device may be defined as follows:

```
      <xs:schema xmlns:xs=“http://www.w3.org/2001/XMLSchema” >
        <xs:element
name=“MediaPlaybackStateNotificationfromPDtoCD”
type=“MediaPlaybackStateMessageType” />
        <xs:complexType name=“MediaPlaybackStateMessageType”>
          <xs:all>
            <xs:element name=“MPSubscriptionID” type=“xs:string”
            minOccurs=“1”/>
            <xs:element name=“MPStateID” type=“xs:string”
            minOccurs=“1”/>
            <xs:element name=“MPState” type=“MPStateType”
            minOccurs=“1”/>
            <xs:element name=“MPSpeed” type=“xs:string”
            minOccurs=“1”/>
            <xs:element name=“PDInfo” type=“PDInfoType”
minOccurs=“0” maxOccurs=“1”/>
          </xs:all>
        </xs:complexType>
        <xs:complexType name=“PDInfoType”>
          <xs:all>
            <xs:element name=“PDDevID” type=“xs:string”
minOccurs=“0” maxOccurs=“1”/>
            <xs:element name=“PDVersion” type=“xs:float”
minOccurs=“0” maxOccurs=“1”/>
          </xs:all>
        </xs:complexType>
        <xs:simpleType name=“MPStateType”>
          <xs:restriction base=“xs:string”>
            <xs:enumeration value=“PLAYING”/>
            <xs:enumeration value=“PAUSED”/>
            <xs:enumeration value=“STOPPED”/>
            <xs:enumeration value=“FFORWARD”/>
            <xs:enumeration value=“FBACKWARD”/>
            <xs:enumeration value=“BUFFERING”/>
            <xs:enumeration value=“UNKNOWN”/>
            <xs:enumeration value=“RESERVED”/>
          </xs:restriction>
        </xs:simpleType>
      </xs:schema>
```

In one embodiment, the Representational State Transfer (REST) mechanism may be used for the primary device notification of media playback state information to the companion device.

In one embodiment, this may be done by sending a request to a defined end-point on the companion device from the primary device.

In another embodiment a HTTP POST request may be sent from the companion device to the primary device as follows:

```
POST /PD/MPL/mplstate_PD2CD HTTP/1.1
host: http://192.168.0.100
content-type:application/x-www-form-urlencoded;charset=utf-8
content-length: <content length of request>
{
              “MPSubscriptionID”: “MPL08754”,
    “MPStateID”: “01”,
              “MPState” : “PLAYING”,
    “MPSpeed”: 1
}
```

In one embodiment a HTTP GET request may be sent from the companion device to the primary device as follows:

http://192.168.0.100/PD/MPL/
mplstate_PD2CD?MPSubscriptionID=
MPL08754&MPStateID=01&MPState=PLAYING&MPSpeed=1

which can also be represented as

```
    GET /PD/
MPL/mplstate_PD2CD?MPSubscriptionID=MPL08754&MPStateID=
01&MPState=PLAYING&MPSpeed=1 HTTP/1.1
    host: http://192.168.0.100
```

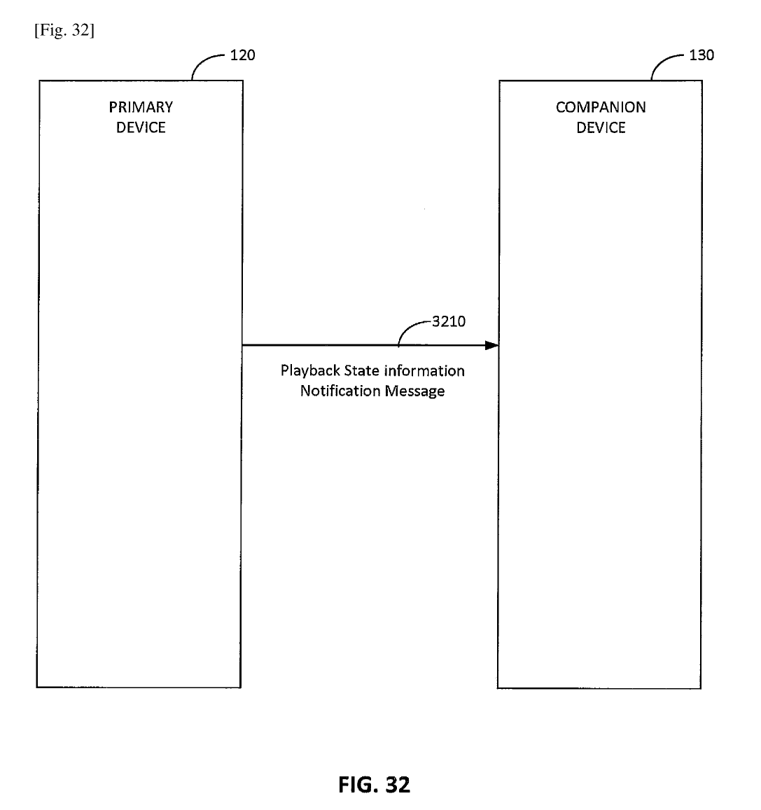

In one embodiment the current media playback state may be communicated from PD to CD when the playback state changes as shown in FIG. 32. In this case the media playback state information message 3210 may be a notification message from primary device 120 to companion device 130.

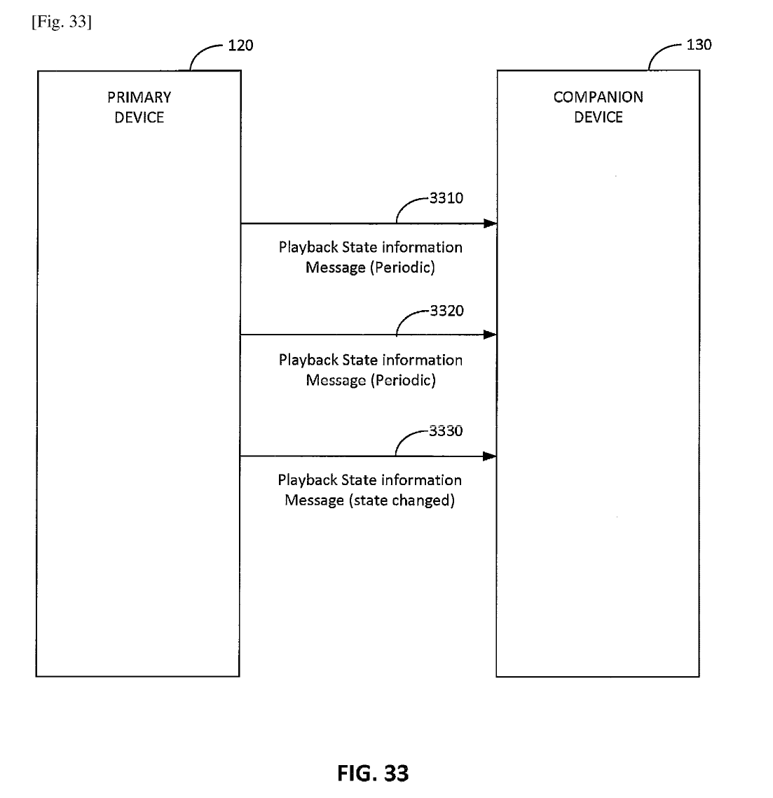

In another embodiment the current media playback state may be communicated from PD to CD periodically (e.g. message 3310, message 3320) and/or when the playback state changes (e.g. message 3330) as shown in FIG. 33. In this case the media playback state information message may be an information communication message from primary device 120 to companion device 130.

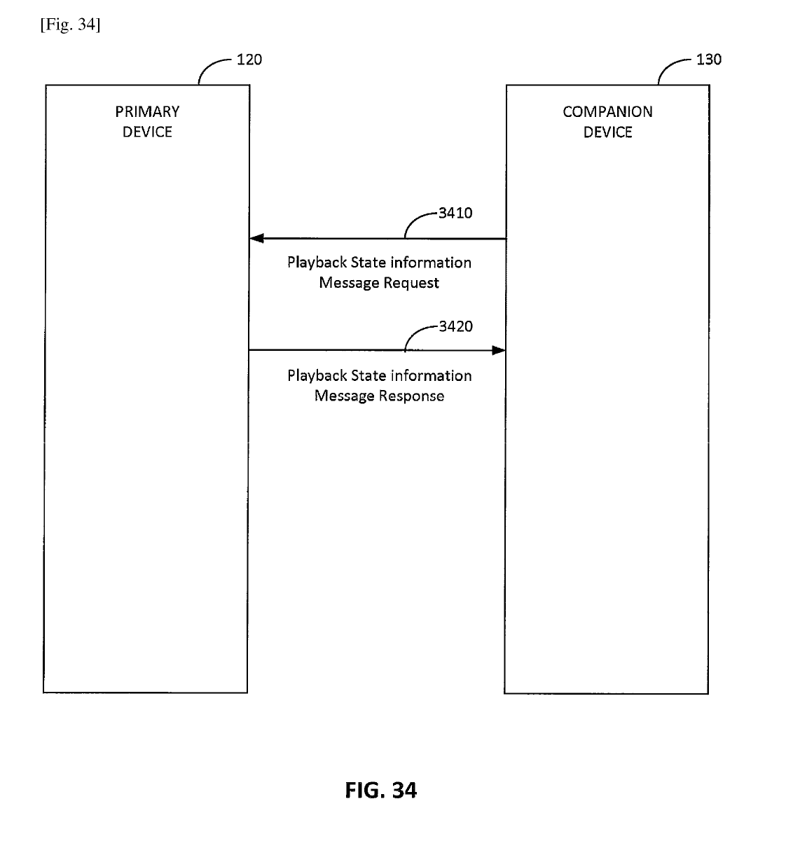

In yet another embodiment the current media playback state may be communicated from PD to CD when CD requests it. The request may be sent as shown in FIG. 34 as a playback state information message request 3410. In this case the media playback state information message may be a response message such as 3420 from primary device 120 to companion device 130.

In another embodiment the combination of one or more of the above methods of communication may be used. For example a combined request-response and notification architecture may be supported. In such an embodiment the current media playback state may be communicated from PD to CD when CD has requested it and/or when the state changes. In this case the media playback state information message may be a response message.

In the above description the “state changes” is used to refer to the playback state on PD being different than the last communicated playback state from PD to CD.

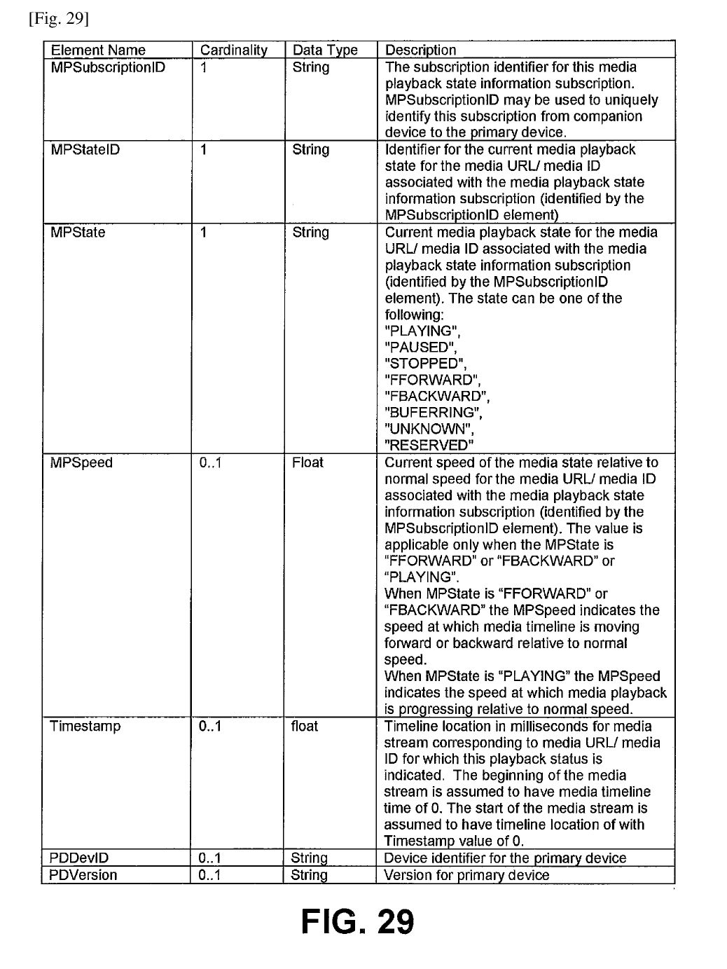

In one embodiment various elements that may be carried in media playback state information message from primary device to companion device and their description may be as shown in the FIG. 29—which provides a table which describes Elements of the media playback state information.

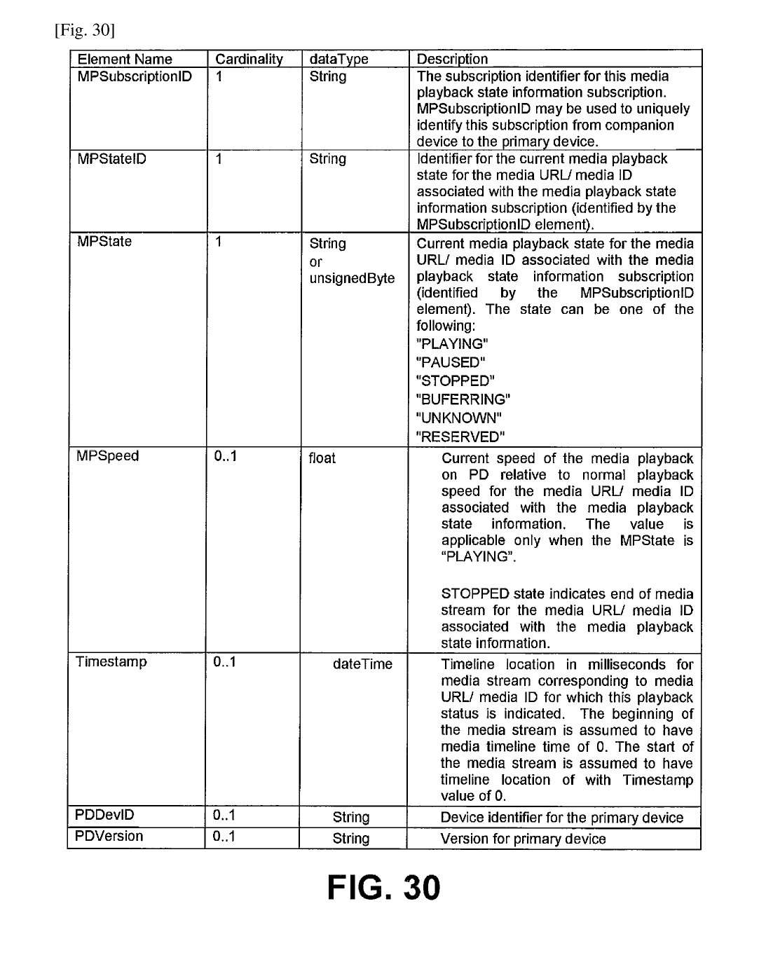

In another embodiment various elements that may be carried in media playback state information message from primary device to companion device and their description may be as shown in the FIG. 30—which provides a table which describes Elements of the media playback state information.

With repsect to FIG. 30, and in particular with respect to MPState and MPSpeed elements one or more of the following rules may be required to be obeyed. This may be a requirement on the primary device and/or on the companion device.
MPSpeed shall only be present when MPState is equal to “PLAYING”.
MPSpeed element is represented by a float data type.
Positive MPSpeed values indicate forward playback. Forward playback means media timeline position increases as wall-clock time increases.
Negative MPSpeed values indicate backward playback. Backward playback means media timeline position decreases as wall-clock time decreases.
MPSpeed value of 1 indicates forward playback at normal speed. In case of forward playback at normal speed the media timeline increases by the same amount of time as the wall-clock time.
MPSpeed value of −1 indicates backward playback at normal speed. In case of backward playback at normal speed the media timeline decreases by the same amount of time as the wall-clock time.
MPSpeed values of X with X not equal to 0 or 1 indicates playback at X times the normal speed. In case of playback at X times the normal speed the media timeline increases (for positive X values) or decreases (for negative X values) by the X times the amount of time as the wall-clock time.
MPSpeed value of 0 is reserved to indicate an UNKNOWN playback speed when the current MPState is “PLAYING”.
When MPState is any state other than “PLAYING” MPSpeed shall be equal to value of 0.
When not present MPSpeed is equal to 1 when MPState is equal to “PLAYING”.
When not present MPSpeed is equal to 0 when MPState is equal to any state other than “PLAYING”.

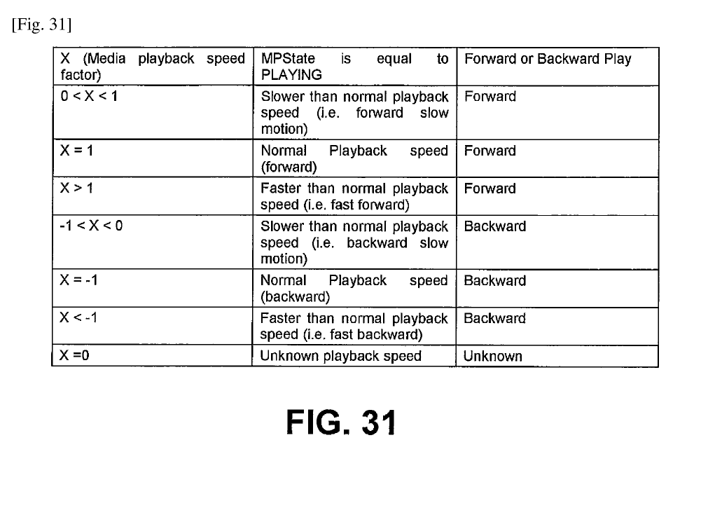

One or more of the above rules may be as further described in FIG. 31.

In one embodiment intepretation of various elements that may be carried in media playback state information from primary device to companion device may be as shown in the FIG. 31—which provides a table which describes media playback state in-formation.

In an embodiment the MPSTATE element may be represented by and unsignedByte data type with values mapped to the various states (e.g. “PLAYING”, “PAUSED”, “STOPPED”, “FFORWARD”, “FBACKWARD”, “BUFERRING”, “UNKNOWN”, “RESERVED”). As an example the
MPSTATE equal to 0 means the media playback state is “PLAYING”,
MPSTATE equal to 1 means the media playback state is “PAUSED”,
MPSTATE equal to 2 means the media playback state is “STOPPED”,
MPSTATE equal to 3 means the media playback state is “FFORWARD”,
MPSTATE equal to 4 means the media playback state is “FBACKWARD”,
MPSTATE equal to 5 means the media playback state is “BUFERRING”,
MPSTATE equal to 6 means the media playback state is “UNKNOWN”,
MPSTATE equal to 7 means the media playback state is “RESERVED”.

In one embodiment the MPSTATE element described above using unsignedByte data type may be the MPStateID element. In this case the MPStateID element may be represented by a data type of unsignedByte.

In yet another embodiment: the MPSTATE may be restricted to only “PLAYING” and “PAUSED” state. In this case a Boolean data type may be used to represent the MPSTATE element.

In some embodiments instead of a float value data type for MPSpeed element it may be expressed as a ratio of two numbers (i.e. as a fraction). For example instead of value of X=1.2, X may be represented as 6/5. As another example instead of X=1.333, X may be represented as 4/3.

In some embodiments one or more of the elements in the Table: Elements of the media playback state information message may not be included in the media playback state information message from PD to CD.

In one embodiment only the elements MPState and MPSpeed may be included on the media playback state information message from PD to CD. In this case these elements indicate the playback state information for the currently playing media on PD.

In one embodiment it shall be required that the playback state notification response be sent from PD to CD within 30 seconds from the time playback state of the media changes on PD. It is understood that the value of 30 is an example and other values e.g. 15 seconds or 59 seconds or any other value may be used.

In some embodiments the term “reverse” may be used instead of the term “backward”. Thus the “backward” playback may instead be called “reverse” playback.

In one embodiment JavaScript Object Notation (JSON) will be used to carry the media playback state information message from PD to CD.

In one embodiment the JSON schema for the PD of media playback state information message to CD is defined as follows:

```
        {
            “id”: “http://atsc.org/version/3.0/cd/mpstate_req_pd2cd#”,
            “$schema”: “http://json-schema.org/draft-04/schema#”,
            “title”: “ATSC Media Playback State Message from PD to
            CD”,
            “description”: “Media Playback State Message from PD to
CD Schema as defined in ATSC 3.0 (c) 2014 atsc.org - All rights
reserved.”,
            “type”: “object”,
            “properties”: {
            “required”: [“MediaPlaybackStateMessagefromPDtoCD”],
            “MediaPlaybackStateMessagefromPDtoCD”: {
              “type”: “object”,
              “properties”: {
                “MPSubscriptionID”: {
                  “type”: “string”
                },
                “MPStateID”: {
                  “type”: “string”
                },
                “MPState”: {
                  “type”: “string”
                },
                “MPSpeed”: {
                  “type”: “number”
                  },
                “Timestamp”: {
                    “type”: “number”
                },
                “PDInfo”: {
                  “type”: “object”,
                  “properties”: {
                    “PDDevID”: {
                      “type”: “string”
                    },
                    “PDVersion”:{
                      “type”: “number”
                    }
                  }
                }
              },
              “required”: [“MPSubscriptionID”,“MPState”,
              “MPSPeed”,“Timestamp”],
              “additionalProperties”: false },
              “maxProperties”: 1
            }
          }
```

In one embodiment example format of this JSON payload be as shown below:

```
{
  “MediaPlaybackStateMessagefromPDtoCD”: {
            “MPSubscriptionID”: “MPL08754”,
              “MPStateID”: “187”,
            “MPState” : “PLAYING”,
            “MPSpeed”: 1,
            “Timestamp”: 100
  }
}
```

The Timestamp may conform to the semantics as defined in RFC 3339 “Date and Time on the Internet: Timestamps” as defined in http://tools.ietf.org/html/rfc3339 which is incorporated here by reference.

In one embodiment XML format will be used to carry the media playback state information message from PD to CD.

In one embodiment the XML schema for the media playback state information message to CD is defined as follows:

```
<xs:schema xmlns:xs=“http://www.w3.org/2001/XMLSchema” >
  <xs:element name=“MediaPlaybackStateMessagefromPDtoCD”
type=“MediaPlaybackStateMessageType” />
  <xs:complexType name=“MediaPlaybackStateMessageType”>
    <xs:all>
      <xs:element name=“MPSubscriptionID” type=“xs:string”
      minOccurs=“1”/>
      <xs:element name=“MPStateID” type=“xs:string”
      minOccurs=“1”/>
      <xs:element name=“MPState” type=“xs:string” minOccurs=“1”/>
      <xs:element name=“MPSpeed” type=“xs:string” minOccurs=“1”/>
      <xs:element name=“Timestamp” type=“xs:float” minOccurs=“1”/>
      <xs:element name=“PDInfo” type=“PDInfoType” minOccurs=“0”
      maxOccurs=“1”/>
    </xs:all>
  </xs:complexType>
  <xs:complexType name=“PDInfoType”>
    <xs:all>
      <xs:element name=“PDDevID” type=“xs:string” minOccurs=“0”
      maxOccurs=“1”/>
      <xs:element name=“PDVersion” type=“xs:float” minOccurs=“0”
      maxOccurs=“1”/>
    </xs:all>
  </xs:complexType>
</xs:schema>
```

In an alternative embodiment
<xs:element name=“MPState” type=“xs:unsignedByte” minOccurs=“1”/>
   may be used for the MPState element.

In one embodiment JavaScript Object Notation (JSON) will be used to carry the media playback state information message from PD to CD.

In one embodiment the JSON schema for media playback state information message to CD is defined as follows:

```
      {
          “id”: “http://atsc.org/version/3.0/cd/mpstate_notify_pd2cd#”,
          “$schema”: “http://json-schema.org/draft-04/schema#”,
          “title”: “ATSC Media Playback State Message from PD to
          CD”,
          “description”: “Media Playback State Message from PD to CD
Schema as defined in ATSC 3.0 (c) 2014 atsc.org - All rights reserved.”,
          “type”: “object”,
          “properties”: {
          “required”: [“MediaPlaybackStateMessagefromPDtoCD”],
          “MediaPlaybackStateMessagefromPDtoCD”: {
            “type”: “object”,
            “properties”: {
              “MPSubscriptionID”: {
                “type”: “string”
              },
              “MPStateID”: {
                “type”: “string”
              },
                “MPState”: {
              “enum”: [
              “PLAYING”,
              “PAUSED”,
              “STOPPED”,
              “FFORWARD”,
              “FBACKWARD”,
              “BUFERRING”,
              “UNKNOWN”,
              “RESERVED”
              ]},
              “MPSpeed”: {
                “type”: “number”
                },
              “PDInfo”: {
                “type”: “object”,
                “properties”: {
                  “PDDevID”: {
                    “type”: “string”
                  },
                  “PDVersion”:{
                    “type”: “number”
                  }
                }
              }
            },
            “required”: [“MPSubscriptionID”,“MPState”],
            “additionalProperties”: false },
            “maxProperties”: 1
        }
      }
```

In one embodiment example format of this JSON payload may be as shown below:

```
{
  “MediaPlaybackStateMessagefromPDtoCD”: {
            “MPSubscriptionID”: “MPL08754”,
              “MPStateID”: “187”,
            “MPState”: “PLAYING”,
            “MPSpeed”: 1
}
}
```

In one embodiment XML format will be used to carry the media playback state information message from PD to CD.

In one embodiment the XML schema for the media playback state information to CD is defined as follows:

```
      <xs:schema xmlns:xs=“http://www.w3.org/2001/XMLSchema” >
  <xs:element name=“MediaPlaybackStateMessagefromPDtoCD”
type=“MediaPlaybackStateMessageType” />
  <xs:complexType name=“MediaPlaybackStateMessageType”>
    <xs:all>
      <xs:element name=“MPSubscriptionID” type=“xs:string”
      minOccurs=“1”/>
      <xs:element name=“MPStateID” type=“xs:string”
      minOccurs=“1”/>
      <xs:element name=“MPState” type=“MPStateType”
      minOccurs=“1”/>
      <xs:element name=“MPSpeed” type=“xs:string”
      minOccurs=“1”/>
      <xs:element name=“Timestamp” type=“xs:float” minOccurs=“1”/>
      <xs:element name=“PDInfo” type=“PDInfoType” minOccurs=“0”
      maxOccurs=“1”/>
    </xs:all>
  </xs:complexType>
  <xs:complexType name=“PDInfoType”>
    <xs:all>
      <xs:element name=“PDDevID” type=“xs:string” minOccurs=“0”
      maxOccurs=“1”/>
      <xs:element name=“PDVersion” type=“xs:float” minOccurs=“0”
      maxOccurs=“1”/>
    </xs:all>
  </xs:complexType>
  <xs:simpleType name=“MPStateType”>
    <xs:restriction base=“xs:string”>
      <xs:enumeration value=“PLAYING”/>
      <xs:enumeration value=“PAUSED”/>
      <xs:enumeration value=“STOPPED”/>
      <xs:enumeration value=“FFORWARD”/>
      <xs:enumeration value=“FBACKWARD”/>
      <xs:enumeration value=“BUFFERING”/>
      <xs:enumeration value=“UNKNOWN”/>
      <xs:enumeration value=“RESERVED”/>
    </xs:restriction>
  </xs:simpleType>
</xs:schema>
```

In an alternate embodiment MPStateType may be restricted to following enumerated states:

```
      <xs:simpleType name=“MPStateType”>
  <xs:restriction base=“xs:string”>
    <xs:enumeration value=“PLAYING”/>
    <xs:enumeration value=“PAUSED”/>
    <xs:enumeration value=“STOPPED”/>
    <xs:enumeration value=“BUFFERING”/>
    <xs:enumeration value=“UNKNOWN”/>
    <xs:enumeration value=“RESERVED”/>
  </xs:restriction>
</xs:simpleType>
```

In an alternative embodiment
<xs:element name=“MPState” type=“xs:unsignedByte” minOccurs=“1”/>
   may be used for the MPState element.

In one embodiment Representational State Transfer (REST) mechanism may be used for the media playback state information message from PD to CD.

In one embodiment this may be done by sending a request to a defined end-point on CD from PD.

In another embodiment a HTTP POST request may be sent from CD to PD as follows:

```
POST /PD/MPL/mplstate_PD2CD HTTP/1.1
host:http://192.168.0.100
content-type:application/x-www-form-urlencoded;charset=utf-8
content-length: <content length of request>
{
              “MPSubscriptionID”: “MPL08754”,
                “MPStateID”: “187”,
              “MPState”: “PLAYING”,
                “MPSpeed”: 1
  }
```

In one embodiment a HTTP GET request may be sent from CD to PD as follows:

http://192.168.0.100/PD/MPL/mplstate_PD2CD?MPSubscriptionID=
MPL08754&MPStateID=187&MPState=PLAYING&MPSpeed=1

which can also be represented as

```
      GET /PD/
MPL/mplstate_PD2CD?MPSubscriptionID=MPL08754&MPStateID=
187&MPState=PLAYING&MPSpeed=1 HTTP/1.1
      host: http://192.168.0.100
```

In one embodiment the CD Response to media playback state message may carry elements as shown below in the “Table: Elements of response to the media playback state information”

| Element Name | Cardinality | Data type | Description |
|---|---|---|---|
| MPSubscriptionID | 1 | String | The subscription identifier for this |
| | | | media playback state information |
| | | | subscription. MPSubscriptionID may |
| | | | be used to uniquely identify this |
| | | | subscription from companion device to |
| | | | the primary device. |
| MPStateID | 0 . . . 1 | String | Identifier for the current media |
| | | | playback state for the media URL/ |
| | | | media ID associated with the media |
| | | | playback state information subscription |
| | | | (identified by the MPSubscriptionID |
| | | | element). |
| Timestamp | 0 . . . 1 | float | Timeline location in milliseconds for |
| | | | media stream corresponding to media |
| | | | URL/media ID for which this |
| | | | playback status is indicated. The start |
| | | | of the media stream is assumed to have |
| | | | timeline location of with Timestamp |
| | | | value of 0. |
| CDDevID | 0 . . . 1 | String | Device identifier for companion |
| | | | device. |
| CDAppID | 0 . . . 1 | String | Application identifier of the companion |
| | | | device. |
| CDAppVersion | 0 . . . 1 | Number | Version of the companion device. |

In one embodiment the response to the media playback state information may be optional.

In one embodiment JavaScript Object Notation (JSON) will be used to carry the response message from CD to PD in response to the media playback state information message. In one embodiment the JSON schema for the CD response to media playback state information message is defined as follows:

```
      {
          “id”: “http://atsc.org/version/3.0/cd/mpstate_resp_cd2pd#”,
          “$schema”: “http://json-schema.org/draft-04/schema#”,
          “title”: “ATSC Media Playback State Message Response from
          CD to PD”,
      “description”: “Media Playback State Message Response from
CD to PD Schema as defined in ATSC 3.0 (c) 2014 atsc.org - All rights
reserved.”,
          “type”: “object”,
          “properties”: {
          “required”:
          [“MediaPlaybackStateMessageResponsefromCDtoPD”],
          “MediaPlaybackStateMessageResponsefromCDtoPD”: {
            “type”: “object”,
            “properties”: {
              “MPSubscriptionID”: {
                “type”: “string”
              },
              “MPStateID”: {
                “type”: “string”
              },
      “Timestamp”: {
      “type”: “number”,
      },
              “CDInfo”: {
                “type”: “object”,
                “properties”: {
                  “CDDevID”: {
                    “type”: “string”
                  },
                  “CDAppID”: {
                    “type”: “string”
                  },
                  “CDAppVersion”:{
                    “type”: “number”
                  }
                }
              }
          },
          “required”: [“MPSubscriptionID”],
          “additionalProperties”: false },
          “maxProperties”: 1
        }
      }
```

In one embodiment example format of this JSON payload may be as shown below:

```
{
  “MediaPlaybackStateMessageResponsefromCDtoPD”: {
            “MPSubscriptionID”: “MPL08754”,
            “MPStateID”: “187”,
            “CDInfo”: {
                “CDDevID”: “CDDevId01”,
                “CDAppID”: “ID01”,
                “CDAppVersion”: 0.9
              }
  }
}
```

In one embodiment XML format will be used to carry the response message from CD to PD in response to the media playback state information message.

In one embodiment the XML schema for the CD response to media playback state information message is defined as follows:

```
<xs:schema xmlns:xs=“http://www.w3.org/2001/XMLSchema” >
  <xs:element
  name=“MediaPlaybackStateMessageResponsefromCDtoPD”
type=“MediaPlaybackResponseMessageType” />
  <xs:complexType name=“MediaPlaybackResponseMessageType”>
    <xs:all>
      <xs:element name=“MPSubscriptionID” type=“xs:string”
      minOccurs=“1”/>
      <xs:element name=“MPStateID” type=“xs:string”
      minOccurs=“1”/>
      <xs:element name=“Timestamp” type=“xs:float” minOccurs=“1”/>
      <xs:element name=“CDInfo” type=“CDInfoType”
      minOccurs=“0” maxOccurs=“1”/>
  </xs:all>
  </xs:complexType>
  <xs:complexType name=“CDInfoType”>
    <xs:all>
      <xs:element name=“CDDevID” type=“xs:string”
      minOccurs=“0” maxOccurs=“1”/>
      <xs:element name=“CDAppID” type=“xs:string”
      minOccurs=“0” maxOccurs=“1”/>
      <xs:element name=“CDAppVersion” type=“xs:float”
      minOccurs=“0” maxOccurs=“1”/>
    </xs:all>
  </xs:complexType>
</xs:schema>
```

In one embodiment Representational State Transfer (REST) mechanism may be used for CD response for media playback state information from PD. This may be done in response to HTTP GET or HTTP POST REST media playback state information message from PD to CD as described previously.

In one embodiment this may be done by sending a HTTP response to PD.

In another embodiment a HTTP response may be sent from CD to PD as follows:
HTTP/1.1 200 OK

In this case in another embodiment the HTTP response body may include some data. For example the response may be sent as follows:

```
HTTP/1.1 200 OK
content-type:application/json
content-length: <content length of response>
{
            “MPSubscriptionID”: “MPL08754”,
            “MPState”: “187”,
      “CDInfo”: {
                  “CDDevID”: “CDDevId01”,
                  “CDAppID”: “ID01”,
                  “CDAppVersion”: 0.9
                }
}
```

In this case the HTTP response body includes JSON data which shall conform to the JSON schema defined previously. In another embodiment instead of JSON, JSONP data (JSON with padding) may be used. In another case the HTTP response body may send the same data in another format such as XML or CSV, BNF, or ABNF, or ENBF etc. For example if XML format is used in HTTP response body then the content may conform to the XML schema for the response defined above.

With respect to FIG. 29 and FIG. 30 it is understood that some of the elements could instead be represented as attributes. Similalry some of the attributes may be instead represented as elements.

In other embodiments the cardinality of some of the elements may be changed. For example cardinality may be changed from “1” to “1 . . . N” or cardinality may be changed from “1” to “0 . . . N” or cardinality may be changed from “1” to “0 . . . 1”.

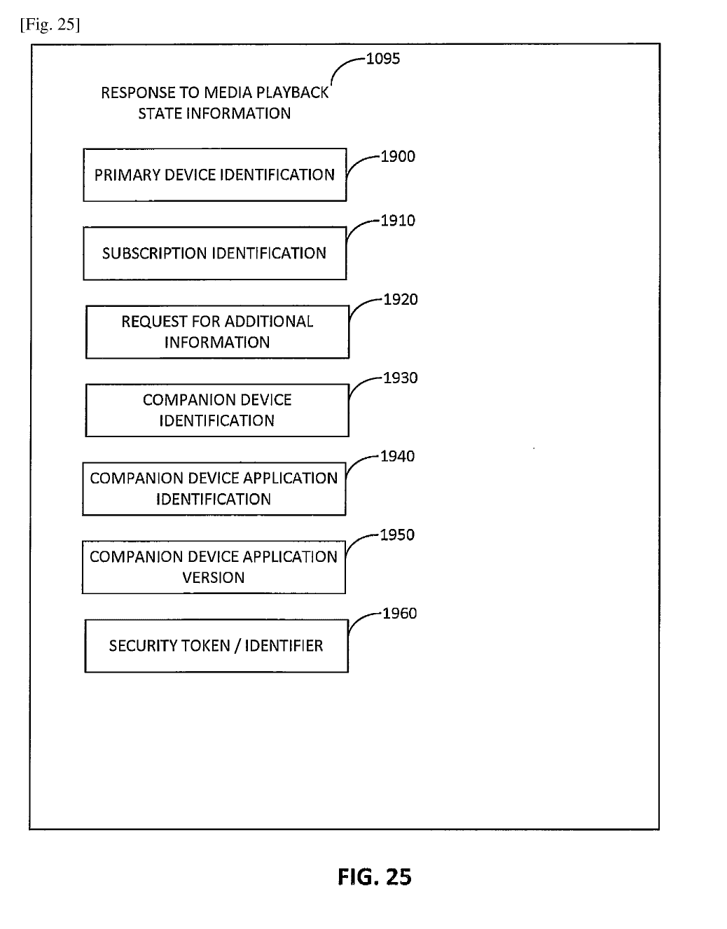

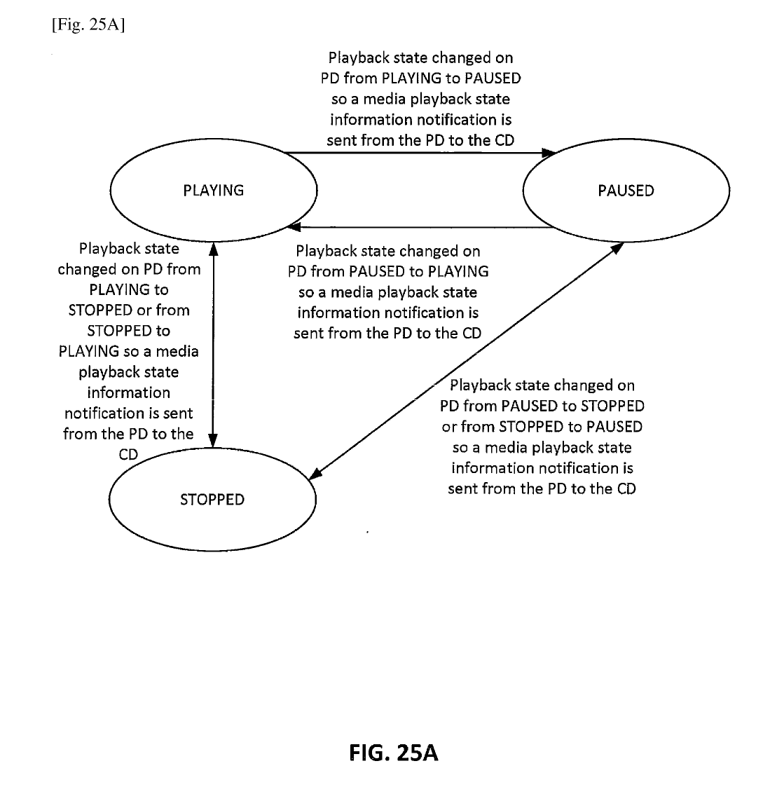

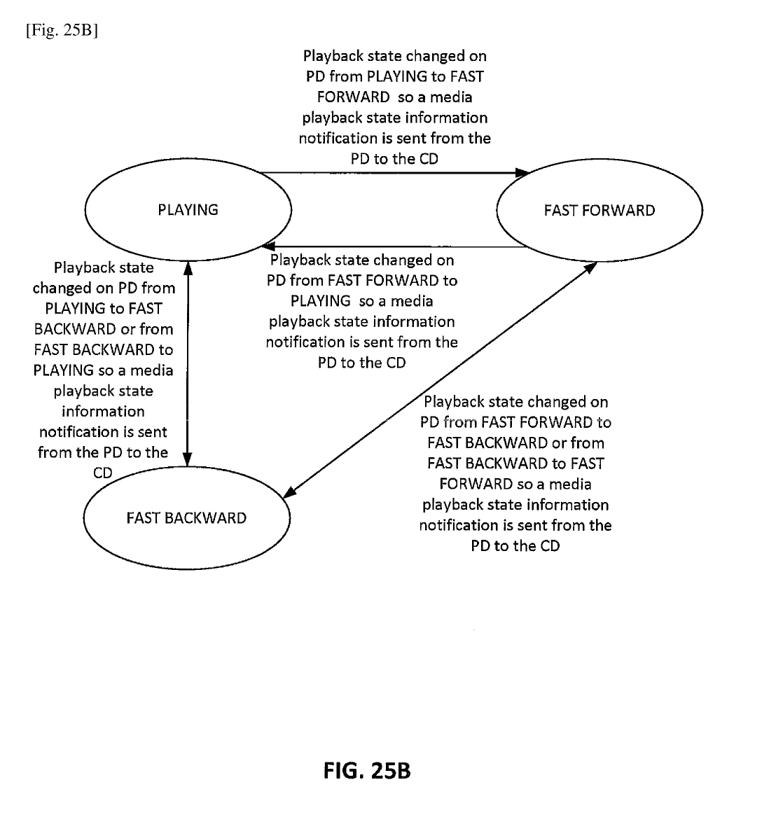

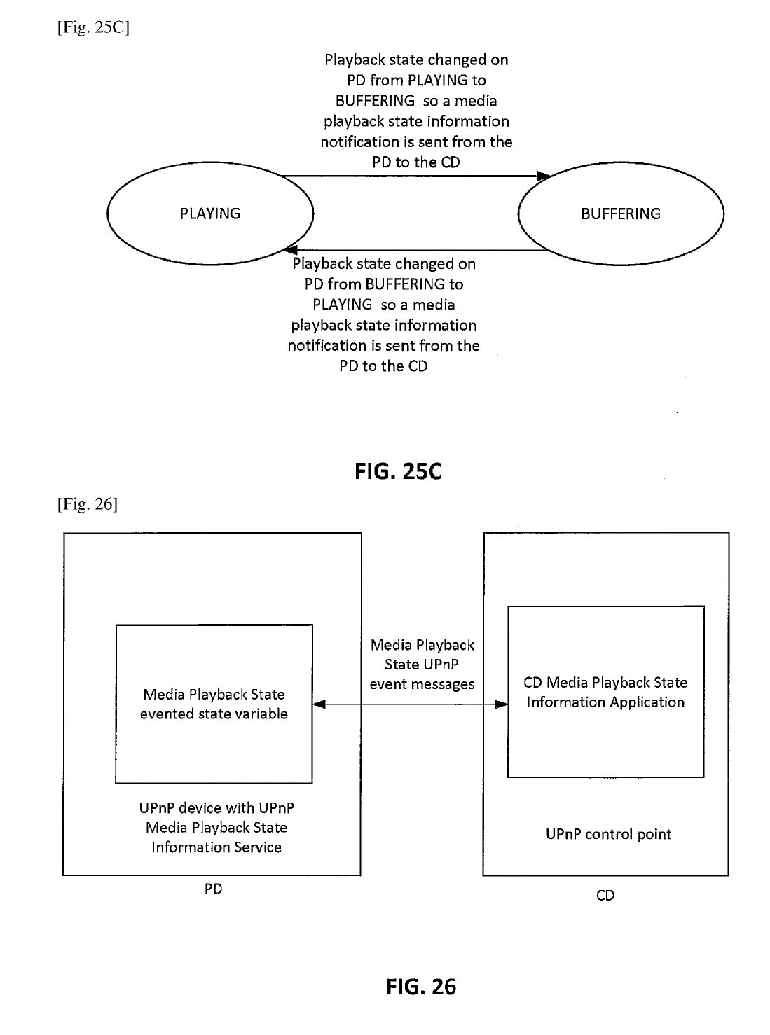

Referring to FIG. 25, a response to media playback state information 1095 from the companion device 130 to the primary device 120 is preferably sent in response to receiving the media playback state information 1040. In this manner, the response to media playback state information may be directed to a particular primary device 120 and/or one or more particular media playback state information applications on the primary device. In some cases, the response to media playback state information 1040 from the companion device 130 to the primary device 120 may be for all subscriptions of a plurality of current subscriptions of the companion device. In this manner, all of the current subscriptions may be effectively confirmed with a reduced amount of data communications and without the need to expressly identify all the current subscriptions.

The response to media playback state information 1095 may be based upon the primary device identification 1900 which identifies the primary device. For example, the primary device identification preferably uses a string identification. In this manner, the companion device may distinguish between a plurality of different primary devices to which it is, or may be, connected to. In some embodiment the primary device identification 1900 may not preferably be included in the media playback state information 1095. The input parameters may include the subscription identification 1910 which identifies a particular subscription to services between the particular primary device and the particular companion device. For example, the subscription identification may be a unique identification to that particular session so that the media playback state information may be tailored for the particular companion device. Moreover, the subscription identification 1910 may be used to distinguish among a plurality of PD media playback state information applications and/or among a plurality of CD media playback state information applications. The input parameters may include a request for additional information 1920 indicating the desire for additional information which the primary device may respond to with an additional message. The input parameters may include companion device identification 1930 which identifies the companion device. For example, the companion device identification preferably uses a string identification. The input parameters may include companion device application identification 1940. For example, the companion device application identification identifies the application, and among a plurality of such applications if present, on the companion device used for exchanging media playback state information. The input parameters may include companion device application version 1950. For example, the companion device application version identifies the attributes and/or capabilities of the particular application. In some embodiments, no callback information is necessary, since this information is already available to the primary device because it may be liked with the subscription information. A security token/identifier 1960 may be included in input parameters. The security token may have been obtained by the companion device by some external means and may help to identify the companion device. For example it may establish authentication of security device as a trusted device. The security token 1960 may be same as security token 1360. In other embodiments the security token 1960 may be different than the security token 1360.

In one embodiment various elements that may be carried in response to media playback state information from companion device to primary device and their description may be as shown in the Table: “Elements of response to the media playback state information” below.

TABLE
Elements of response to the media playback state information

| Element Name | Description |
|---|---|
| MPSubscriptionID | The subscription identifier for this media playback |
| | state information subscription. MPSubscriptionID |
| | may be used to uniquely identify this subscription |
| | from companion device to the primary device. |
| MPStateID | Identifier for the current media playback state for |
| | the media URL/media ID associated with the |
| | media playback state information subscription |
| | (identified by the MPSubscriptionID element). |
| Timestamp | Timeline location in milliseconds for media |
| | stream corresponding to media URL/media ID |
| | for which this playback status is indicated. The |
| | start of the media stream is assumed to have |
| | timeline location of with Timestamp value of 0. |
| CDDevID | Device identifier for companion device. |
| CDAppID | Application identifier of the companion device. |
| CDAppVersion | Version of the companion device. |

In one embodiment, JavaScript Object Notation (JSON) may be used to carry the response message from the companion device to the primary device in response to the media playback state information device message notification. The JSON schema for the companion device response to media playback state information message may be as follows:

```
    {
        “id”: “http://atsc.org/version/3.0/cd/mpstate_resp_cd2pd#”,
        “$schema”: “http://json-schema.org/draft-04/schema#”,
        “title”: “ATSC Media Playback State Notification Response from CD to PD”,
    “description”: “Media Playback State Notification Response from CD to PD Schema
as defined in ATSC 3.0 (c) 2014 atsc.org - All rights reserved.”,
        “type”: “object”,
        “properties”: {
        “required”: [“MediaPlaybackStateMessageNotificationResponsefromCDtoPD”],
        “MediaPlaybackStateMessageNotificationResponsefromCDtoPD”: {
          “type”: “object”,
          “properties”: {
            “MPSubscriptionID”: {
              “type”: “string”
            },
            “MPStateID”: {
              “type”: “string”
            },
    “Timestamp”: {
              “type”: “number”,
            },
            “CDInfo”: {
              “type”: “object”,
              “properties”: {
                “CDDevID”: {
                  “type”: “string”
                },
                  “CDAppID”: {
                “type”: “string”
                },
                “CDAppVersion”:{
                  “type”: “number”
                }
              }
            }
          },
          “required”: [“MPSubscriptionID”,“MPStateID”],
          “additionalProperties”: false },
          “maxProperties”: 1
      }
    }
```

In one embodiment, the format of this JSON payload may be as shown below:

```
{
  “MediaPlaybackStateMessageNotificationResponsefromCDtoPD”: {
            “MPSubscriptionID”: “MPL08754”,
            “MPStateID”: “01”,
            “CDInfo”: {
                  “CDDevID”: “CDDevId01”,
                        “CDAppID”: “ID01”,
                                          “CDAppVersion”: 0.9
                }
  }
}
```

In one embodiment, the XML format may be used to carry the response message from the companion device to the primary device in response to the media playback state information message notification.

In one embodiment, the XML schema for the companion device response to media playback state information notification message may be as follows:

```
    <xs:schema xmlns:xs=“http://www.w3.org/2001/XMLSchema” >
      <xs:element name=“MediaPlaybackStateNotificationResponsefromCDtoPD”
type=“MediaPlaybackResponseMessageType” />
      <xs:complexType name=“MediaPlaybackResponseMessageType”>
        <xs:all>
          <xs:element name=“MPSubscriptionID” type=“xs:string” minOccurs=“1”/>
          <xs:element name=“MPStateID” type=“xs:string” minOccurs=“1”/>
          <xs:element name=“Timestamp” type=“xs:float” minOccurs=“1”/>
          <xs:element name=“CDInfo” type=“CDInfoType” minOccurs=“0”
maxOccurs=“1”/>
        </xs:all>
      </xs:complexType>
      <xs:complexType name=“CDInfoType”>
        <xs:all>
          <xs:element name=“CDDevID” type=“xs:string” minOccurs=“0”
maxOccurs=“1”/>
          <xs:element name=“CDAppID” type=“xs:string” minOccurs=“0”
maxOccurs=“1”/>
          <xs:element name=“CDAppVersion” type=“xs:float” minOccurs=“0”
maxOccurs=“1”/>
        </xs:all>
      </xs:complexType>
    </xs:schema>
```

In one embodiment, the Representational State Transfer (REST) mechanism may be used for the companion device response for media playback state information from the primary device. This may be done in response to HTTP GET or HTTP POST REST media playback state information notification from the primary device to the companion device as described previously.

In one embodiment this may be done by sending a HTTP response to the primary device.

In another embodiment a HTTP response may be sent from the companion device to the primary device as follows:
HTTP/1.1 200 OK

In this case, in another embodiment the HTTP response body may include some data. For example the response may be sent as follows:

```
HTTP/1.1 200 OK
content-type:application/json
content-length: <content length of response>
{
        “MPSubscriptionID”: “MPL08754”,
        “MPState”: “01”,
    “CDInfo”: {
            “CDDevID”: “CDDevId01”,
            “CDAppID”: “ID01”,
                  “CDAppVersion”: 0.9
            }
}
```

In this case the HTTP response body includes JSON data which shall conform to the JSON schema defined previously. In another embodiment instead of JSON, JSONP data (JSON with padding) may be used. In another case the HTTP response body may send the same data in another format such as XML or CSV, BNF, or ABNF, or ENBF etc. For example if XML format is used in HTTP response body then the content may conform to the XML schema for the response defined above.

The response message in addition to the input parameters indicated may indicate a success/failure, if desired. In addition, a subset of the input parameters, additional input parameters, and/or a subset of the input parameters together with additional input parameters may be used.

Additionally for all or some of the Tables described above with element names and their descriptions, a “security token/identifier” element may be added to each of the messages. This may be done as shown in the Table: “Security element for messages” below

TABLE
Security element for messages

| Element Name | Description |
|---|---|
| SecurityToken | The security token or identifier which is used |
| | for securing and/or authenticating this session. |

In an embodiment the security token/identifier may be represented as “SecurityToken” code field which may be done in JSON schema as follows:

```
“SecurityToken”: {
        “type”: “string”
    },
```

In an embodiment the security token/identifier may be represented as “SecurityToken” XML element which may be done in XML schema as follows:

<xs:element name=“SecurityToken” type=“xs:string” minOccurs=“0”
maxOccurs=“1”/>

Referring to FIG. 25A, as it may be observed the system may indicate a multitude of different changed states from the primary device to the companion device. For example, the state may change from PLAYING to PAUSED, from PAUSED to PLAYING, from PLAYING to STOPPED, from STOPPED to PLAYING, from PAUSED to STOPPED, and from STOPPED to PAUSED. Referring to FIG. 25B, as it may be observed the system may indicate a multitude of different changed states from the primary device to the companion device. For example, the state may change from PLAYING to FAST FORWARD, from FAST FORWARD to PLAYING, from PLAYING to FAST BACKWARD, from FAST BACKWARD to PLAYING, from FAST FORWARD to FAST BACKWARD, and from FAST BACKWARD to FAST FORWARD. Referring to FIG. 25C, as it may be observed the system may indicate a multitude of different changed states from the primary device to the companion device. For example, the state may change from PLAYING to BUFFERING and from BUFFERING to PLAYING. In addition, the system may indicate a change state between any of the available states, such as for example, playing, paused, stopped, fast forward, fast backward, buffering, unknown, and reserved. In addition, for fast forward and fast backward, the system may indicate the degree of such fast forward and fast backward. In addition for playing state the system may indicate the speed of playback compared to normal speed.

The system as described enables the primary device and the companion device to provide an improved experience for the viewer of content. For example, a primary device (e.g., television) may be playing back a video while the companion device (e.g., phone and/or tablet) may be playing the same video which may be carried around. In some cases, the companion device may view an alternative view of the video from that being presented on the primary device in a synchronized manner. In some cases, the companion device may receive an alternative (e.g., secondary) audio stream from that being presented on the primary device in a synchronized manner. This facilitates the viewer of the companion device to listen to a different audio stream, such as one in a different language (e.g., Spanish on the companion device while English is being presented on the primary device). In some cases, the companion device may receive and present closed captions on the companion device while the primary device is not presenting closed captioning.

In one embodiment, the WebSocket mechanism may be used for carrying some or all the messages between the primary device(s) and the companion device(s). Additionally HbbTV defined mechanisms (e.g. HbbTV 2.0 companion screen mechanisms) may be used for communication. In this case in one embodiment the communication between the primary device and the companion device may be carried out as “application to application communication” as defined in HbbTV.

In this case one or more of the following may apply:

(1) An app-endpoint is defined for PD to CD communication. This is used in the process of matching the CD to PD connection when exchanging media playback state information communication related messages which will be relayed over the WebSocket protocol.

(2) In one embodiment the app-endpoint may be selected as “org.atsc.pdcdmediaplayback” for PD to CD communication of media playback state information. In other embodiments a common app-endpoint “org.atsc.pdcd” may be selected for all the communication between PD and CD including the media playback state information communication between PD and CD.

(3) It should be understood that the exact string value used for app-endpoint may be different than the one described. E.g. alternative values of app-endpoint strings include but are not limited to “org.atsc.PDCDMEDIAPLAYBACK”, “org.atsc.mp1”, “org.atsc3.pdcd”, “org.atsc3.pdcdmpl”, “org.atsc.mpl”, “pdapptocdapp06” etc. In general any alphanumeric or special character string which uniquely identifies the communication between PD and CD for media playback state information or for any communication between PD and CD may be used.

In one embodiment the following series of steps may be taken by the primary device and/or the companion device to establish the media playback state information message communication:

(1) PD media playback state information message communication side/app acting as a client makes a connection to the local service end-point with a base url resource /hbbtv/ and with app-endpoint “org.atsc.pdcdmpl”.

(2) CD media playback state information message communication side/app acting as a client makes a connection to the remote service end-point with a base url resource /hbbtv/ and with the same app end-point “org.atsc.pdcdmpl”

(3) The WebSocket server on PD pairs these two PD (local) and CD (remote) connections as they are both waiting connections and their app-end points (“org.atsc.pdcdmpl”) as well as base url resource (/hbbtv/) match

(4) From this point onwards PD and CD can communicate with each other using media playback state information message protocol described.

(5) Either PD or CD can initiate to close the connection with the other entity (CD or PD respectively) by sending WebSocket protocol's Close frame. Alternatively PD and/or CD can disconnect without sending WebSocket protocol's Close frame. In this case WebSocket Server on PD will initiate the process of disconnection by sending WebSocket protocol's Close frame to the other entity.

In one embodiment, the security for the communication between PD and CD will be achieved using one or more of the following:

(1) For security purposes it may be required that PD and CD communicate with each other by using port 443 for WebSocket connections tunneled over Transport Layer Security (TLS).

(2) In one embodiment this may be achieved by requiring the use of wss-URI scheme for WebSocket URIs as defined in section 3 of RFC 6455.

(3) The WebSocket server (e.g. HbbTV WebSocket Server) can use a client authentication mechanism available to a generic HTTP server. For example this can be one ore more of:
(a) Cookies,
(b) HTTP authentication, or
(c) TLS authentication.

In one embodiment, the client authentication may be done for both the PD media playback state information message Application (HbbTV app) running on PD and CD media playback state information message Application (CD App) running on CD.

In one embodiment, a new protocol may be defined for PD-CD media playback state information message communication using Sec-WebSocket-Protocol header of WebSocket Protocol. In this case HbbTV mechanism will be modified by requiring that the terminal (e.g. PD and/or CD) shall support Sec-WebSocket-Protocol header as defined in clause 11.3.4 of WebSocket protocol RFC 6455.

In this case an application protocol (or subprotocol) between PD and CD for media playback state information message communication when using WebSocket may be indicated with a string. For example the string ‘PDCDMPL” may be used for the sub-protocol signaled via Sec-WebSocket-Protocol. E.g. this may be signaled as follows:

(1) Sec-WebSocket-Protocol: PDCDMPL

In this case when PD and CD both understand the designated subprotocol then they can communicate and exchange media playback state information messages.

In one embodiment, an UPnP Service may be defined for some or all of the message exchanges between the primary device and the companion device. This facilitates any UPnP control point to discover the UPnP media playback state information service. Referring to FIG. 26 primary device may include an UPnP device with UPnP media playback state information service. The UPnP service on primary device may include an media playback state information evented state variable. Companion device may include an UPnP control point. The UPnP control point functionality may be part of CD media playback state information application or it may be separate from the CD media playback state information application. The UPnP control point functionality on companion device may be used for receiving media playback state information sent as UPnP event messages.

The UPnP service may provide the following UPnP actions:
Set media URL
Get current media playback state

The UPnP service also may define an evented state variable for receiving media playback state information, such as MediaPlaybackState.

A description of an exemplary UPnP action is provided as follows:

(1) SetMediaURL. This action takes a media URL string as input argument. In one embodiment the filter string may be a URL pointing to a media stream on the primary device. In another embodiment it may be a unique identifier for a media stream on PD. In some cases this media or media stream on PD may be the media currently playing on the PD. A special value may be indicated to indicate requesting information about the current media being played back on CD. For example and input argument of null may indicate that the information about the media currently being played back on PD is requested. In this case the media playback state information is requested for the media URL supplied as input argument. The return string can return a success/error code (e.g. fixed 3 digit codes) followed by an error or success string. Additional input argument can be taken by this action to make it more secure.

(2) GetCurrentMediaPlaybackState. This action takes as an input argument a media URL for the stream for which media playback state information is requested. A special value may be indicated to indicate requesting information about the current media being played back on CD. For example and input argument of null may indicate that the information about the media currently being played back on PD is requested. Alternatively in some embodiments an additional input argument can be taken by this action to make it more secure. The return string can return a success indication (e.g. a fixed 3 digit code) followed by the current media playback state information message. If there is no current media playback state information for the requested media URL, a “null” value may be returned. If there is an error the return string can return an error code (e.g. fixed 3 digit codes) followed by an error reason string.

In one embodiment, one or both of the above actions may not be supported by the UPnP service. An evented state variable described below, namely MediaPlaybackState, may be provided for obtaining media playback state information.

The UPnP service may also define an evented state variable MediaPlaybackState. In one embodiment the CD acts as a control point and PD acts as a UPnP device and provides an UPnP media playback state information (MPL) UPnP service. In this case the PD's UPnP MPL service provides a state variable MediaPlaybackState. In one embodiment the state variable MediaPlaybackState is evented. In one embodiment the state variable MediaPlaybackState is not evented. This may be the case if media playback state information messages are expected to be large in size. In this case the state variable MediaPlaybackState's value can be polled by CD by querying it as a state variable. In one case this may be done using QueryStatevariable UPnP action. The PD publishes an update when the state variable MediaPlaybackState changes. For example this happens when there is a media playback state change for the media URL. The CD is subscribed to receive this information. In one case MediaPlaybackState state variable may be a required element. On another case MediaPlaybackState state variable may be an optional element.

In one embodiment the companion device acts as a control point and the primary device acts as a UPnP device and provides an UPnP media playback state information UPnP service. In this case the primary device's UPnP media playback state information service provides a state variable MediaPlaybackState. In one embodiment the state variable MediaPlaybackState is evented. In one embodiment the state variable MediaPlaybackState is not evented. This may be the case if media playback state information are expected to be large in size. In this case the state variable MediaPlaybackState's value can be polled by the companion device by querying it as a state variable. In one case this may be done using QueryStatevariable UPnP action.

The primary device publishes an update when the state variable MediaPlaybackState changes. For example this happens when there is a new media playback state information alert message. Or this may happen when a previous media playback state information message is to be repeated. The companion device (CD) is subscribed to receive this information.

In one case, MediaPlaybackState state variable may be a required element. In another case MediaPlaybackState state variable may be an optional element.

Additionally, for the subscription of media playback state information messages the companion device and the primary device may exchange messages using UPnP eventing architecture. The UPnP eventing architecture may be as described in UPnP device architecture 1.0 document, which is incorporated, herein by reference. This may include one or more of following message exchanges:

(1) The companion device obtains information about eventing URL for primary device media playback state information messages by obtaining the UPnP device description.

(2) The companion device subscribes to eventing for UPnP media playback state information message service by sending a request with method SUBSCRIBE with NT and CALLBACK headers. This subscription request may include the following:

Subscription callback URL on the CD in the CALLBACK header.
Requested subscription duration in seconds in the TIMEOUT header.
An example subscription request is shown as follows:
SUBSCRIBE <eventSubURL path> HTTP/1.1
HOST: <PD Host:PD port>
CALLBACK: <Subscription callback URL>
NT: upnp:event
TIMEOUT: <requested subscription duration in Second>

A special value of “Infinite” can be indicated in the TIMEOUT header to request an indefinite subscription (until it is cancelled). In other embodiments other special values (e.g. −1 or 0) could be signaled in TIMEOUT header to request indefinite subscription.

(3) The primary device may accept the subscription from the companion device for media playback state information messages. In this case, it may assign a unique ID for this subscription (e.g., Subscription ID), and duration for the subscription (e.g., Confirmed Subscription duration) and may send a response to the companion device.

This subscription response from PD to CD may include the following:
(a) Subscription ID for uniquely identifying the subscription in SID header.
(b) Confirmed actual subscription duration in seconds in the TIMEOUT header.

An example subscription response may be as follows:

HTTP/1.1 200 OK
DATE: <response generation date>
SERVER: <PD Host ID, PD port>
SID: uuid:<Subscription ID>
TIMEOUT: <confirmed subscription duration in Second>

It may be a requirement that the subscription response be sent from PD to the companion device within a specified time limit. For example it may be required that the subscription response be sent from the primary device to the companion device within 30 seconds from the time it receives the subscription request from the companion device.

Additionally PD may send a first or initial event message containing the media playback state information message to CD. This may be done similar to how media playback state information messages are sent via evented state variables.

(4) The companion device may send a renew subscription message to the primary device to renew subscription to media playback state information messages. This subscription renewal request may include the following:
(a) Subscription ID which uniquely identifies this subscription in the SID header
(b) Requested subscription duration in seconds in the TIMEOUT header

An example subscription request may be as follows:

```
    SUBSCRIBE <eventSubURL path> HTTP/1.1
    HOST: <PD Host:PD port>
    SID: uuid:<Subscription ID>
    TIMEOUT: <requested subscription duration for renewal of
subscription in Second>
```

(5) The primary device may accept the subscription renewal request from the companion device for media playback state information messages. In this case it may assign a duration for the subscription (e.g., Confirmed Subscription duration) and may send a response to the companion device.

This subscription response from the primary device to the companion device may include the following:
(a) Subscription ID for uniquely identifying the subscription in SID header.
(b) Confirmed actual subscription duration in seconds in the TIMEOUT header.

An example subscription renewal response is shown below:

HTTP/1.1 200 OK
DATE: <response generation date>
SERVER: <PD Host ID, PD port>
SID: uuid:<Subscription ID>
TIMEOUT: <confirmed subscription duration in Second>

It may be a requirement that the subscription renewal response be sent from the primary device to the companion device within a specified time limit. For example it may be required that the subscription renewal response be sent from the primary device to the companion device within 30 seconds from the time it receives the subscription request from companion device.

Also the primary device may not send a new “initial” or first media playback state information message at this time similar to the one that is sent when sending the response from the primary device to the companion device when subscription request is received from companion device for the first time.

(6) The companion device may send a cancel subscription message by sending a request with method UNSUBSCRIBE to the primary device to cancel subscription to media playback state information messages. This subscription cancel request may include the following:
Subscription ID which uniquely identifies this subscription in the SID header.
Requested subscription duration in seconds will not be needed in the TIMEOUT header. However in some embodiment a value of 0 may be signaled in the TIMEOUT header. Alternatively a special value (e.g. −1) or any other value may be signaled in TIMEOUT header. This value may be ignored by the primary device.

An example subscription cancel request is as follows:

UN-SUBSCRIBE <eventSubURL path> HTTP/1.1
HOST: <PD Host:PD port>
SID: uuid:<Subscription ID>

(7) The primary device may accept the subscription cancellation request from the companion device for media playback state information messages. In this case it may send a response with success/failure code.

An example subscription cancel request is as follows:
HTTP/1.1 200 OK

It may be a requirement that the subscription cancel response be sent from the primary device to the companion device within a specified time limit. For example it may be required that the subscription cancel response be sent from the primary device to the companion device within 30 seconds from the time it receives the subscription request from companion device.

(8) The primary device may send media playback state information messages to a subscribed companion device as event messages. This may be sent in response to the changes to the state variable. This state variable may be MediaPlaybackState state variable previously described.

An example subscription renewal response where the media playback state information message is sent as JSON formatted data is shown as follows. Where the value signaled in the MediaPlaybackState state variable conforms to the JSON schema defined above with respect to the primary device notification of media playback state information messages.

```
      NOTIFY <Subscription callback URL> HTTP/1.1
      HOST: <PD Host:PD port>
      CONTENT-TYPE: text/xml
      CONTENT-LENGTH: <Body length in bytes>
      NT: upnp:event
      NTS: upnp:propchange
      SID: uuid:<subscription ID>
      SEQ: <event key>
      <?xml version=“1.0”?>
      <e:propertyset xmlns:e=“urn:schemas-upnp-org:event-1-0”>
      <e:property>
      <MediaPlaybackState >{
        “MediaPlaybackStateMessageNotificationfromPDtoCD”: {
                  “MPSubscriptionID”: “MPL08754”,
            “MPStateID” : “01”,
                  “MPState” : “PLAYING”,
            “MPSpeed” : 1,
                  “Timestamp” : 100
    }
</ MediaPlaybackState >
</e:property>
</e:propertyset>
```

An example notification message where the media playback state information message is sent as XML formatted data is shown below:

```
NOTIFY <Media Playback Subscription callback URL> HTTP/1.1
HOST: <PD Host:PD port>
CONTENT-TYPE: text/xml
CONTENT-LENGTH: <Body length in bytes>
NT: upnp:event
NTS: upnp:propchange
SID: uuid:<subscription ID>
SEQ: <event key>
<?xml version=“1.0”?>
<e:propertyset xmlns:e=“urn:schemas-upnp-org:event-1-0”>
<e:property>
<MediaPlaybackState>
            <MPSubscriptionID> MPL08754</MPSubscriptionID>
            <MPStateID>01</MPStateID>
    <MPState>PLAYING</MPState>
    <MPSpeed>1</MPSpeed>
            <Timestamp>100</Timestamp>
            </MediaPlaybackState>
</e:property>
</e:propertyset>
```

In some embodiments <event key> sent in SEQ header may be initialized to 0 in the first event notification message may be incremented for subsequent event notification messages.

The contents of media playback state information messages (inside <MediaPlaybackState> . . . </MediaPlaybackState> field) may be encoded in UTF-8.

In one embodiment the proposed UPnP Media Playback Status Information Service XML description is given below:

```
<?xml version=“1.0” ?>
- <scpd xmlns=“urn:schemas-upnp-org:service-1-0”>
- <specVersion>
  <major>1</major>
  <minor>0</minor>
  </specVersion>
- <actionList>
- <action>
  <name>SetMediaURL</name>
- <argumentList>
- <argument>
  <name>setMStatus</name>
  <relatedStateVariable>SetMStatus</relatedStateVariable>
  <direction>out</direction>
  </argument>
- <argument>
  <name>mURL</name>
  <relatedStateVariable>MediaURL</relatedStateVariable>
  <direction>in</direction>
  </argument>
  </argumentList>
  </action>
- <action>
  <name>GetCurrentMediaPlaybackState</name>
- <argumentList>
- <argument>
  <name>mplState</name>
  <relatedStateVariable>MPLState</relatedStateVariable>
  <direction>out</direction>
  </argument>
- <argument>
  <name>mURL</name>
  <relatedStateVariable>MediaURL</relatedStateVariable>
  <direction>in</direction>
  </argument>
  </argumentList>
  </action>
  </actionList>
- <serviceStateTable>
- <stateVariable sendEvents=“no”>
  <name>MediaURL</name>
  <dataType>string</dataType>
  <defaultValue>null</defaultValue>
  </stateVariable>
- <stateVariable sendEvents=“no”>
  <name>SetMStatus</name>
  <dataType>string</dataType>
  <defaultValue>null</defaultValue>
  </stateVariable>
- <stateVariable sendEvents=“no”>
  <name>MPLState </name>
  <dataType>string</dataType>
  <defaultValue>null</defaultValue>
  </stateVariable>
- <stateVariable sendEvents=“yes”>
  <name>MediaPlaybackState</name>
  <dataType>string</dataType>
  <defaultValue>null</defaultValue>
  </stateVariable>
  </serviceStateTable>
  </scpd>
```

In one embodiment the proposed device description for the device (primary device) providing UPnP Media Playback State Information Service is given below:

```
UPnP Media Playback State Information Service
Device Description XML:
<?xml version=“1.0” ?>
- <root xmlns=“urn:schemas-upnp-org:device-1-0”>
- <specVersion>
  <major>1</major>
  <minor>0</minor>
  </specVersion>
  <URLBase>http://192.168.0.100:5003/MPLservicedevice</URLBase>
- <device>
  <deviceType>urn:schemas-upnp-org:device:MPLservicedevice:1</
  deviceType>
  <friendlyName>ATSC Media Playback State Information Service
  Device</friendlyName>
  <manufacturer>Sharp Inc.</manufacturer>
  <manufacturerURL>/manufacturer.html</manufacturerURL>
  <modelDescription>An Media Playback State Information
  Service Device</modelDescription>
  <modelName>MPLSVC V1</modelName>
  <model Number>0.1</modelNumber>
  <modelURL>/model.html</modelURL>
  <serialNumber>12172014</serialNumber>
  <UDN>uuid: MPLservicedevice </UDN>
  <UPC>12172014</UPC>
- <iconList>
- <icon>
  <mimetype>image/gif</mimetype>
  <width>30</width>
  <height>30</height>
  <depth>8</depth>
  <url>icon.gif</url>
  </icon>
  </iconList>
- <serviceList>
- <service>
  <serviceType>urn:schemas-upnp-org:service:MPLSvc:1</serviceType>
  <serviceId>urn:schemas-upnp-org:serviceId: MPLSvc:1</serviceId>
  <SCPDURL>/MPLservicedevice/
  urn_schemas-upnp-org_serviceId_MPLSvc_1/
  description.xml</SCPDURL>
  <controlURL>/MPLservicedevice/
  urn_schemas-upnp-org_serviceId_MPLSvc_1/control</controlURL>
  <eventSubURL>/MPLservicedevice/
  urn_schemas-upnp-org_serviceId_MPLSvc_1/
  eventSub</eventSubURL>
  </service>
  </serviceList>
  <presentationURL>http://192.168.0.100:5003/MPLservicedevice/
  presentation.html</presentationURL>
  </device>
  </root>
```

In some embodiments instead of JSON, JSONP data (JSON with padding) may be used.

In another embodiments, the HTTP response body may send the same data in another format such as XML or CSV, BNF, or ABNF, or ENBF etc.

Additionally when a failure occurs an error code and possibly a descriptive error string is communicated, if desired. For example if CD sends a message which does not conform to the schema defined by the protocol an error may be indicated by PD with an error code and error string. Similarly if PD sends a message which does not conform to the schema defined by the protocol and error may be indicated by CD with an error code and error string. Other error codes and/or error strings may be exchanged when server is unavailable or unreachable of if there is network error. All these are intended to be within the scope of this invention.

In another embodiment, the Representational State Transfer (REST) mechanism may be used for exchanging messages between PD and CD. Example embodiments for this have been described above for each of the messages that are exchanged between the primary device and the companion device.

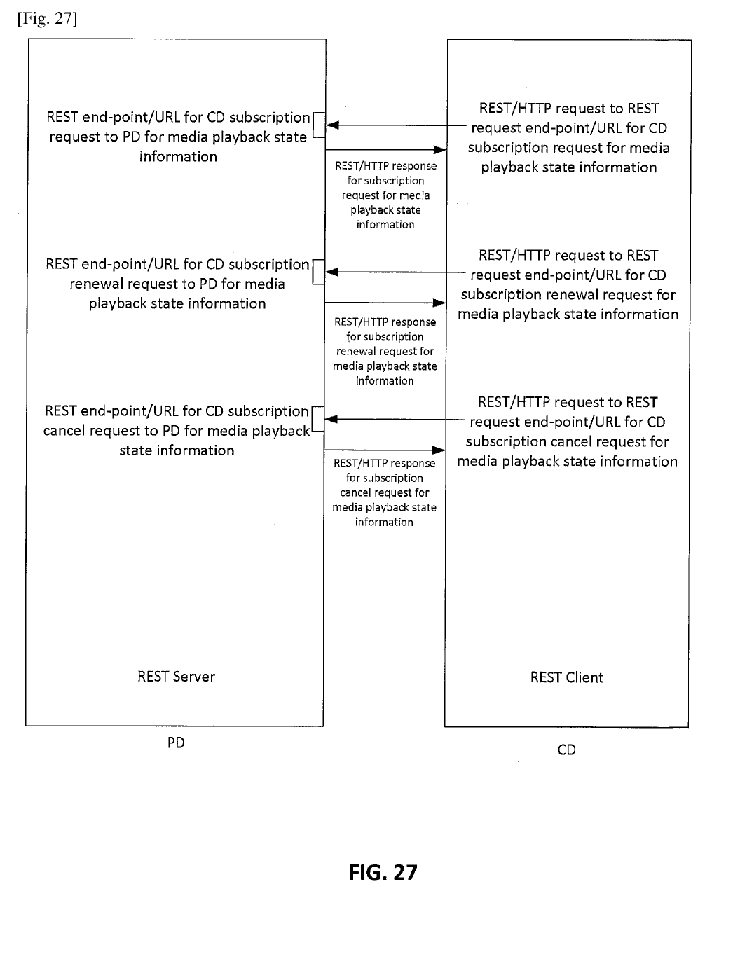

Referring to FIG. 27 primary device may include REST server with various REST URLs/end-points that can receive REST requests. The companion device may include REST client which can send REST/HTTP requests to various REST URLs/end-points. In particular following REST request, responses are shown in FIG. 27.
REST server on primary device may include a REST end-point/URL for companion device subscription request to primary device. When REST client on companion device sends a REST/HTTP subscription request to this end-point, the primary device may send a REST/HTTP response for this subscription request.
REST server on primary device may include a REST end-point/URL for companion device subscription renewal request to primary device. When REST client on companion device sends a REST/HTTP subscription renewal request to this end-point, the primary device may send a REST/HTTP response for this subscription renewal request.
REST server on primary device may include a REST end-point/URL for companion device subscription cancel request to primary device. When REST client on companion device sends a REST/HTTP subscription renewal request to this end-point, the primary device may send a REST/HTTP response for this subscription cancel request.

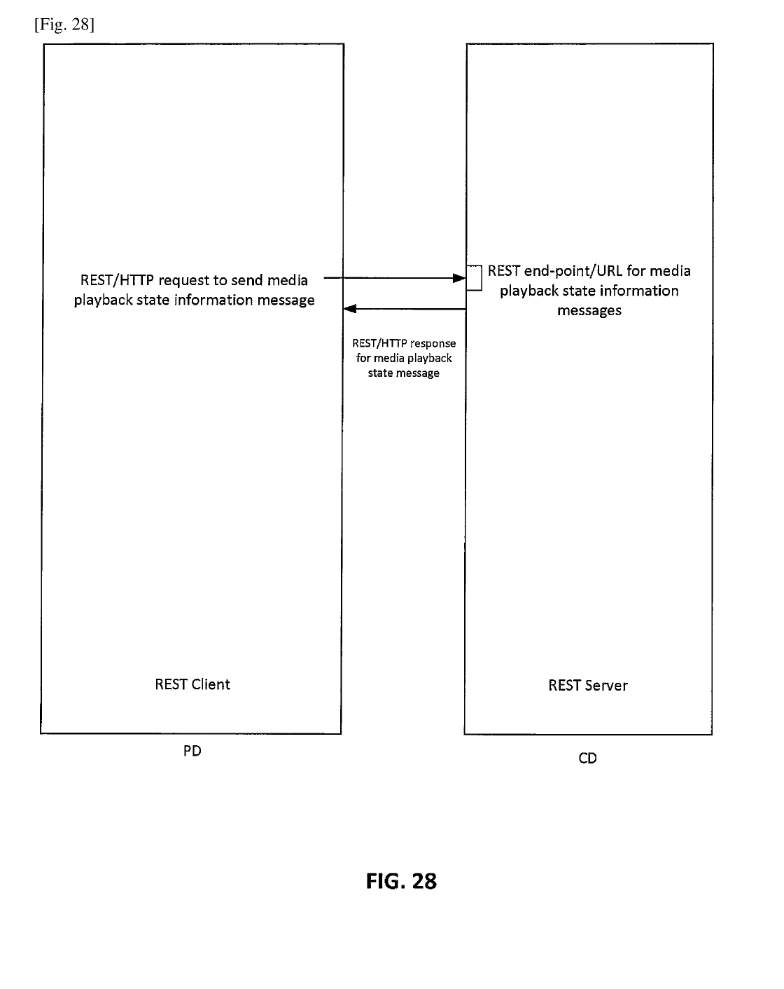

Referring to FIG. 28 companion device may include REST server with REST URLs/end-points that can receive REST requests. The primary device may include REST client which can send REST/HTTP requests to various REST URLs/end-points. In particular following REST request, responses are shown in FIG. 27.
REST server on companion device may include a REST end-point/URL for media playback state information messages from primary device. When REST client on PD sends a REST/HTTP subscription request to this end-point including media playback state information messages, the primary device may send a REST/HTTP response for this media playback state information message.

In yet another embodiment, a Simple Object Access Protocol (SOAP) may be used for exchanging messages between PD and CD.

It is to be understood that the claims are not limited to the precise configuration and components illustrated above. Various modifications, changes and variations may be made in the arrangement, operation and details of the systems, methods, and apparatus described herein without departing from the scope of the claims.

1. A primary device that provides information, the primary device comprising:
(a) said primary device configured to provide said information including at least one of:
(i) a media playback state for a media identification associated with a media playback state information subscription including at least one of:
(1) playing;
(2) paused;
(3) stopped;
(4) buffering;
(5) unknown; and
(ii) a media playback speed relative to normal speed including at least one of:
(1) a positive speed value indicating forward playback, wherein said forward playback means a media timeline position increases as wall-clock time increases; and (2) a negative speed value indicating backward playback, wherein said backward playback means a media timeline position decreases as wall-clock time decreases.

2. The primary device of claim 1 wherein media playback speed value of 1 indicates forward playback at said normal speed, wherein media timeline increases by the same amount of time as wall-clock time, in a case of said forward playback at said normal speed.

3. The primary device of claim 1 wherein media playback speed value of −1 indicates backward playback at said normal speed, wherein media timeline decreases by the same amount of time as wall-clock time, in a case of said backward playback at said normal speed.

4. The primary device of claim 1 wherein media playback speed value of 1 with X not equal to 0 or 1 indicates a playback speed at X times said normal speed.

5. The primary device of claim 4 wherein media timeline increases by X times the amount of time as said wall-clock time, in a case of playback at X times said normal speed.

6. The primary device of claim 4 wherein media timeline decreases by X times the amount of time as said wall-clock time, in a case of playback at X times said normal speed.

7. The primary device of claim 1 wherein media playback speed value 0 is reserved to indicate an unknown playback speed, in a case that said media playback state is said playing.

8. The primary device of claim 1 wherein said media playback speed is equal to a value of 0, in a case that said media playback state is any state other than said playing.

9. The primary device of claim 1 wherein said media playback speed is equal to 1, in a case that said media playback state is equal to said playing.

10. The primary device of claim 1 wherein said media playback speed is equal to 0, in a case that said media playback state is equal to any state other than said playing.

11. The primary device of claim 1 wherein said information includes said media playback state including said playing.

12. The primary device of claim 1 wherein said information includes said media playback state including said paused.

13. The primary device of claim 1 wherein said information includes said media playback state including said stopped.

14. The primary device of claim 1 wherein said information includes said media playback state including said buffering.

15. The primary device of claim 1 wherein said information includes said media playback state including said unknown.

16. The primary device of claim 1 wherein said information including an identifier for the media for which said subscription is requested.

17. A companion device that receives information, the primary device comprising:
(a) said companion device configured to receive said information including at least one of:
(i) a media playback state for a media identification associated with a media playback state information subscription including at least one of:
(1) playing;
(2) paused;
(3) stopped;
(4) buffering;
(5) unknown; and
(ii) a media playback speed relative to normal speed including at least one of: (1) a positive speed value indicating forward playback, wherein said forward playback means a media timeline position increases as wall-clock time increases; and (2) a negative speed value indicating backward playback, wherein said backward playback means a media timeline position decreases as wall-clock time decreases.

18. A method for a primary device to provide information, the method comprising:
(a) providing said information including at least one of:
(i) a media playback state for a media identification associated with a media playback state information subscription including at least one of:
(1) playing;
(2) paused;
(3) stopped;
(4) buffering;
(5) unknown; and
(ii) a media playback speed relative to normal speed including at least one of: (1) a positive speed value indicating forward playback, wherein said forward playback means a media timeline position increases as wall-clock time increases; and (2) a negative speed value indicating backward playback, wherein said backward playback means a media timeline position decreases as wall-clock time decreases.
